(19) United States
(12) Patent Application Publication
(10) Pub. No.: US 2026/0203337 A1
(43) Pub. Date: Jul. 16, 2026

(54) ELECTRONIC DEVICE, METHOD, AND NON-TRANSITORY COMPUTER READABLE STORAGE MEDIUM TO PROVIDE SUMMARY WITH RESPECT TO CONTENT

(71) Applicant: Samsung Electronics Co., Ltd., Suwon-si (KR)

(72) Inventors: Giyong PARK, Suwon-si (KR); Seunggyu KONG, Suwon-si (KR); Doowook KIM, Suwon-si (KR); Sangheon KIM, Suwon-si (KR); Jeongseob KIM, Suwon-si (KR); Junsung KIM, Suwon-si (KR); Inah SON, Suwon-si (KR); Munwon CHOI, Suwon-si (KR); Jin CHOI, Suwon-si (KR)

(21) Appl. No.: 19/361,500

(22) Filed: Oct. 17, 2025

Related U.S. Application Data
(63) Continuation of application No. PCT/KR2025/015378, filed on Sep. 29, 2025.

(30) Foreign Application Priority Data
Jan. 14, 2025 (KR) 10-2025-0005720
Mar. 10, 2025 (KR) 10-2025-0030933

(51) Int. Cl. G06F 16/35; G06F 3/041; G06F 3/04842; G06F 16/335; G06F 16/34; H04W 4/029

(52) U.S. Cl. CPC G06F 16/35; G06F 3/0412; G06F 3/04842; G06F 16/335; G06F 16/345; H04W 4/029

(57) ABSTRACT

An electronic device identifies first information of a first application and second information of a second application among a plurality of applications, based at least on determining that time information of the electronic device corresponds to a predetermined time. Each of the first information and the second information is respectively obtained during a specified period corresponding to the time information. The electronic device generates a first content including a first image and a first text using the first information and a second content including a second image and a second text using the second information, through a machine learning model. The electronic device determines ranks of the first content and the second content based on the time information. The electronic device concurrently displays the first content and the second content through a touchscreen display, based on the ranks.

### CROSS-REFERENCE TO RELATED APPLICATIONS

This application is a continuation of International Application No. PCT/KR2025/015378 designating the United States, filed on Sep. 29, 2025, in the Korean Intellectual Property Receiving Office and claiming priority to Korean Patent Application Nos. 10-2025-0005720, filed on Jan. 14, 2025, and 10-2025-0030933, filed on Mar. 10, 2025, in the Korean Intellectual Property Office, the disclosures of each of which are incorporated by reference herein in their entireties.

### BACKGROUND

### Field

The disclosure relates to an electronic device, a method, and a non-transitory computer-readable storage medium for providing summary of content.

### Description of Related Art

Based on a natural language processing (NLP) technology, an electronic device that understands and/or responds to human language activities using artificial intelligence is being developed. The electronic device based on the NLP technology may output a natural language sentence(s) understandable by humans. The electronic device based on the NLP technology may execute a function(s) corresponding to human intentions by processing human utterance (e.g., utterance including a natural language sentence(s)) and/or a text input (e.g., texts including a natural language sentence(s)).

The above-described information may be provided as a related art for the purpose of helping to understand the present disclosure. No assertion or determination is raised as to whether any of the above-described information may be applied as a prior art related to the present disclosure.

### SUMMARY

According to an example embodiment, an electronic device may comprise: a touchscreen display, memory comprising one or more storage media storing instructions, and at least one processor comprising processing circuitry. At least one processor, individually or collectively, may be configured to execute the instructions and to cause the electronic device to: based at least in part on a determination that time information of the electronic device corresponds to a specified time, identify first information of a first application and second information of a second application among a plurality of applications. The first information and the second information may be respectively obtained in a specified period corresponding to the time information. The instructions, when executed by the at least one processor individually or collectively, may cause the electronic device to determine, via a machine learning model, a first content including a first image and a first text using the first information, and a second content including a second image and a second text using the second information. The instructions, when executed by the at least one processor individually or collectively, may cause the electronic device to determine a rank of the first content and the second content based on the time information. The instructions, when executed by the at least one processor individually or collectively, may cause the electronic device to, based on the rank, display, via the touchscreen display, the first content and the second content concurrently.

According to an example embodiment, an electronic device may comprise: a display, memory comprising one or more storage media storing instructions, and at least one processor comprising processing circuitry. The instructions, when executed by the at least one processor individually or collectively, may cause the electronic device to identify messages generated by execution of software applications. The instructions, when executed by the at least one processor individually or collectively, may cause the electronic device to determine ranks respectively corresponding to the messages. The instructions, when executed by the at least one processor individually or collectively, may cause the electronic device to obtain texts representing a summary at least one of the messages, using the determined ranks. The instructions, when executed by the at least one processor individually or collectively, may cause the electronic device to display, together with the obtained texts, visual objects respectively including the messages which are arranged by the determined ranks.

In an example embodiment, a method of operating an electronic device including a touchscreen display is provided. The method may comprise, based at least in part on a determination that time information of the electronic device corresponds to a specified time, identifying first information of a first application and second information of a second application among a plurality of applications. The first information and the second information may be respectively obtained in a specified period corresponding to the time information. The method may comprise generating, via a machine learning model, a first content including a first image and a first text using the first information, and a second content including a second image and a second text using the second information. The method may comprise determining a rank of the first content and the second content based on the time information. The method may comprise, based on the rank, displaying, via the touchscreen display, the first content and the second content concurrently.

In an example embodiment, a non-transitory computer readable storage medium storing instructions is provided. The instructions, when executed by an electronic device including a display, may cause the electronic device to identify messages generated by execution of software applications. The instructions, when executed by the electronic device, may cause the electronic device to determine ranks respectively corresponding to the messages. The instructions, when executed by the electronic device, may cause the electronic device to obtain texts representing summarization of at least one of the messages, using the determined ranks. The instructions, when executed by the electronic device, may cause the electronic device to display, together with the obtained texts, visual objects respectively including the messages which are arranged by the determined ranks.

According to an example embodiment, an electronic device may comprise a display, memory comprising one or more storage media storing instructions, and at least one processor comprising processing circuitry. The instructions, when executed by the at least one processor individually or collectively, may cause the electronic device to identify at least one cluster of a plurality of images. The instructions, when executed by the at least one processor individually or collectively, may cause the electronic device to, based on identifying a cluster including a plurality of images, identify a first portion of images among the plurality of images included in the cluster, the first portion having a time difference greater than a reference time difference. The instructions, when executed by the at least one processor individually or collectively, may cause the electronic device to identify a second portion of the images included in the first portion by using timings of the images of the first portion. The instructions, when executed by the at least one processor individually or collectively, may cause the electronic device to obtain texts representing a summary of the images of the second portion. The instructions, when executed by the at least one processor individually or collectively, may cause the electronic device to display the obtained texts in relation to the cluster.

According to an example embodiment, an electronic device may comprise: a touchscreen display, memory comprising one or more storage media storing instructions, and at least one processor comprising processing circuitry. The instructions, when executed by the at least one processor individually or collectively, may cause the electronic device to identify time information and location information of the electronic device. The instructions, when executed by the at least one processor individually or collectively, may cause the electronic device to identify a first content and a second content from among a plurality of contents obtained within a specified period, according to identifying the time information and the location information satisfying a specified condition, based on first metadata of the first content and second metadata of the second content. The instructions, when executed by the at least one processor individually or collectively, may cause the electronic device to generate text information through a machine learning model stored in the memory, based at least in part on the first content, the second content, the first metadata, and the second metadata. The machine learning model may be trained to generate the text information based on at least one content including an image, a video, a text, a sound, or a drawing. The instructions, when executed by the at least one processor individually or collectively, may cause the electronic device to display, through the touchscreen display, at least a portion of the first content and the second content on a first portion and display text corresponding to the generated text information on a second portion different from the first portion.

In an example embodiment, a method of operating an electronic device comprising a display may be provided. The method may comprise: identifying at least one cluster of a plurality of images. The method may comprise, based on identifying a cluster including a plurality of images, identifying a first portion of images having a time difference greater than a reference time difference among the plurality of images included in the cluster. The method may comprise, by using timings of the images of the first portion, identifying a second portion of images included in the first portion. The method may comprise obtaining texts representing a summary the images of the second portion. The method may comprise displaying the obtained texts in relation to the cluster.

In an example embodiment, a non-transitory computer-readable storage medium storing instructions may be provided. The instructions, when executed by an electronic device comprising a touchscreen display, may cause the electronic device to identify time information and location information of the electronic device. The instructions, when executed by the electronic device, may cause the electronic device to, based at least in part on determining that the time information and the location information correspond to a specified condition, identify a first content and a second content among a plurality of contents obtained within a specified period based on first metadata of the first content and second metadata of the second content. The instructions, when executed by the electronic device, may cause the electronic device to, based at least in part on the first content, the second content, the first metadata, and the second metadata, generate text information through a machine learning model. The machine learning model may be trained to generate the text information based on at least one content including an image, a video, a text, a sound, or a drawing. The instructions, when executed by the electronic device, may cause the electronic device to display at least a portion of the first content and the second content in a first portion and display texts corresponding to the text information in a second portion different from the first portion through the touchscreen display.

In an example embodiment, an electronic device may comprise a display, memory comprising one or more storage media storing instructions, and at least one processor comprising processing circuitry. The instructions, when executed by the at least one processor individually or collectively, may cause the electronic device to identify a first text representing a summary of at least one content. The instructions, when executed by the at least one processor individually or collectively, may cause the electronic device to, based on the first text, generate a second text having a length less than a reference length of a widget object. The instructions, when executed by the at least one processor individually or collectively, may cause the electronic device to display, on a home screen through the display, a widget object including the second text. The instructions, when executed by the at least one processor individually or collectively, may cause the electronic device to, while displaying the widget object including the second text, determine a reference time length for maintaining displaying of the widget object including the second text, based on a rank of the at least one content and a number of accesses with respect to the at least one content. The instructions, when executed by the at least one processor individually or collectively, may cause the electronic device to identify a time length of displaying the widget object including the second text. The instructions, when executed by the at least one processor individually or collectively, may cause the electronic device to, based at least in part on determining that the time length is greater than the reference time length, change a text in the widget object from the second text to a third text.

In an example embodiment, a method of operating an electronic device comprising a display may be provided. The method may comprise identifying a first text representing a summary of at least one content. The method may comprise generating a second text having a length less than a reference length of a widget object based on the first text. The method may comprise displaying, on a home screen through the display, a widget object including the second text. The method may comprise, while displaying the widget object including the second text, determining a reference time length for maintaining displaying of the widget object including the second text, based on a rank of the at least one content and the number of accesses with respect to the at least one content. The method may comprise identifying a time length of displaying the widget object including the second text. The method may comprise changing a text in the widget object from the second text to a third text, based at least in part on determining that the time length is greater than the reference time length.

According to an example embodiment, an electronic device may comprise a display, memory comprising one or more storage media storing instructions, and at least one processor comprising processing circuitry. The instructions, when executed by the at least one processor individually or collectively, may cause the electronic device to identify a first text representing summary of at least one first content. The instructions, when executed by the at least one processor individually or collectively, may cause the electronic device to obtain a second text having a length less than a reference length of a widget object from the first text. The instructions, when executed by the at least one processor individually or collectively, may cause the electronic device to display the obtained second text within the widget object, based on displaying a home screen including the widget object. The instructions, when executed by the at least one processor individually or collectively, may cause the electronic device to, based on identifying a second content while displaying the obtained second text, identify a rank of the second content. The instructions, when executed by the at least one processor individually or collectively, may cause the electronic device to, based on identifying the rank of the second content higher than a rank of the at least one first content, change a text in the widget object from the second text to a third text representing a summary of the second content.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating example states of an electronic device according to various embodiments;

FIG. 2 is a block diagram illustrating an example configuration of an electronic device according to various embodiments;

FIG. 3A, FIG. 3B, FIG. 3C, and FIG. 3D are block diagrams illustrating example operations performed by an electronic device to process a content provided by a software application according to various embodiments;

FIGS. 4A, 4B, 4C, 4D, 4E, and 4F include flowcharts and diagrams illustrating example operations of an electronic device according to various embodiments;

FIG. 5 is a signal flow diagram illustrating example operations of an electronic device according to various embodiments;

FIG. 6 is a diagram illustrating an example of a document object generated based on execution of a software application of an electronic device, according to various embodiments;

FIG. 7 is a diagram illustrating an example screen displayed by an electronic device to obtain context information associated with a user, according to various embodiments;

FIG. 8 is a diagram illustrating an example briefing screen displayed by an electronic device according to various embodiments;

FIG. 9 is a diagram illustrating an example operation of an electronic device for displaying a widget object connected to a briefing screen through a lock screen according to various embodiments;

FIG. 10 is a diagram illustrating example states of an electronic device for obtaining feedback data on contents included in a briefing screen according to various embodiments;

FIGS. 11A, 111B, and 11C are diagrams illustrating example states of a briefing screen displayed by an electronic device according to various embodiments;

FIGS. 12A and 12B are diagrams illustrating example operations of an electronic device that generates a content to be displayed on a briefing screen and/or a layout of a widget object using a document object provided by a software application according to various embodiments;

FIGS. 13A and 13B are diagrams illustrating example states of a multi-foldable electronic device displaying a briefing screen according to various embodiments;

FIG. 14 is a diagram illustrating an example briefing screen displayed by an electronic device having a form factor of a tablet personal computer (PC) according to various embodiments;

FIG. 15 is a diagram illustrating example states of an electronic device displaying summary content with respect to a user-generated content (e.g., image and/or video), according to various embodiments;

FIG. 16 is a diagram illustrating an example state of an electronic device displaying a briefing screen according to various embodiments;

FIG. 17 is a block diagram illustrating an example configuration of an electronic device according to various embodiments;

FIG. 18 is a flowchart illustrating example operations of an electronic device according to various embodiments;

FIG. 19 is a diagram illustrating example operations of an electronic device according to various embodiments;

FIG. 20 is a flowchart illustrating example operations of an electronic device according to various embodiments;

FIG. 21 is a diagram illustrating an example operation of an electronic device that determines weights of each of a plurality of images according to various embodiments;

FIG. 22 is a diagram illustrating an example operation of an electronic device that generates a briefing content using images included in a cluster according to various embodiments;

FIGS. 23A and 23B are diagrams illustrating example layouts of images included in a briefing content according to various embodiments;

FIG. 24 is a diagram illustrating example states of an electronic device displaying a briefing content according to various embodiments;

FIG. 25 is a diagram illustrating example states of an electronic device for editing a briefing content according to various embodiments;

FIG. 26 is a diagram illustrating example states of an electronic device displaying a briefing content in a landscape mode according to various embodiments;

FIG. 27 is a diagram illustrating an example operation of an electronic device displaying a widget object based on a content of a briefing screen according to various embodiments;

FIG. 28 is a flowchart illustrating example operations of an electronic device according to various embodiments;

FIG. 29 is a diagram illustrating an example operation of an electronic device displaying a widget object according to various embodiments;

FIGS. 30A and 30B are diagrams illustrating an example operation of an electronic device displaying a widget object having a variable size according to various embodiments;

FIGS. 31A and 31B are diagrams illustrating example states of a multi-foldable electronic device displaying a widget object according to various embodiments;

FIG. 32 is a diagram illustrating example states of a rollable electronic device displaying a widget object according to various embodiments;

FIG. 33 is a diagram illustrating example widget objects displayed on each of a home screen and a lock screen by an electronic device according to various embodiments;

FIG. 34 is a diagram illustrating example operations of an electronic device and/or an external electronic device that display a visual object related to a widget object according to various embodiments;

FIG. 35 is a block diagram illustrating an example electronic device in a network environment according to various embodiments; and

FIG. 36 is a diagram illustrating an example configuration of an example AI system according to various embodiments.

### DETAILED DESCRIPTION

Hereinafter, various example embodiments of the present disclosure will be described in greater detail with reference to the accompanying drawings.

The various example embodiments of the present disclosure and terms used herein are not intended to limit the technology described in the present disclosure to specific embodiments, and should be understood to include various modifications, equivalents, or substitutes. In relation to the description of the drawings, a reference numeral may be used for a similar component. A singular expression may include a plural expression unless it is clearly meant differently in the context. In the present disclosure, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, are used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

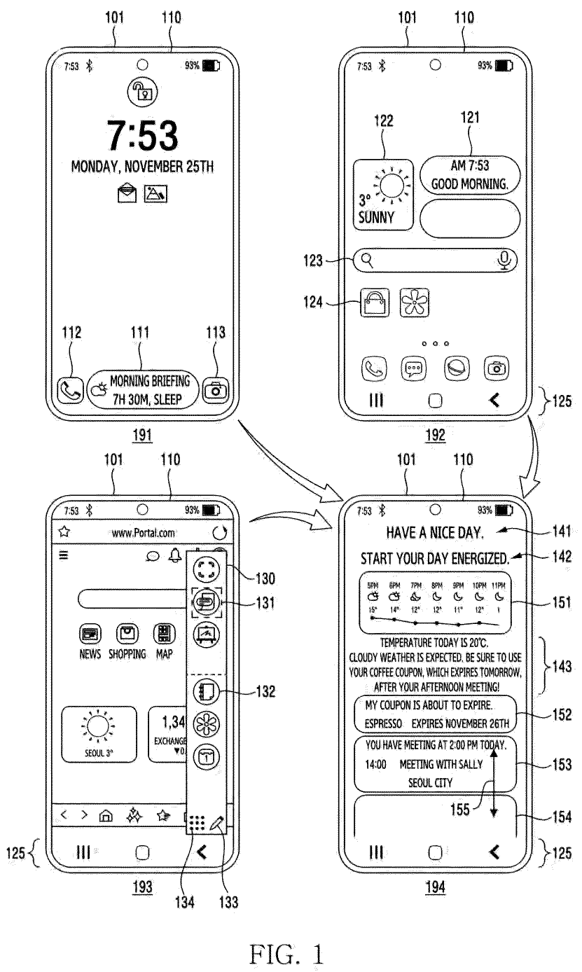

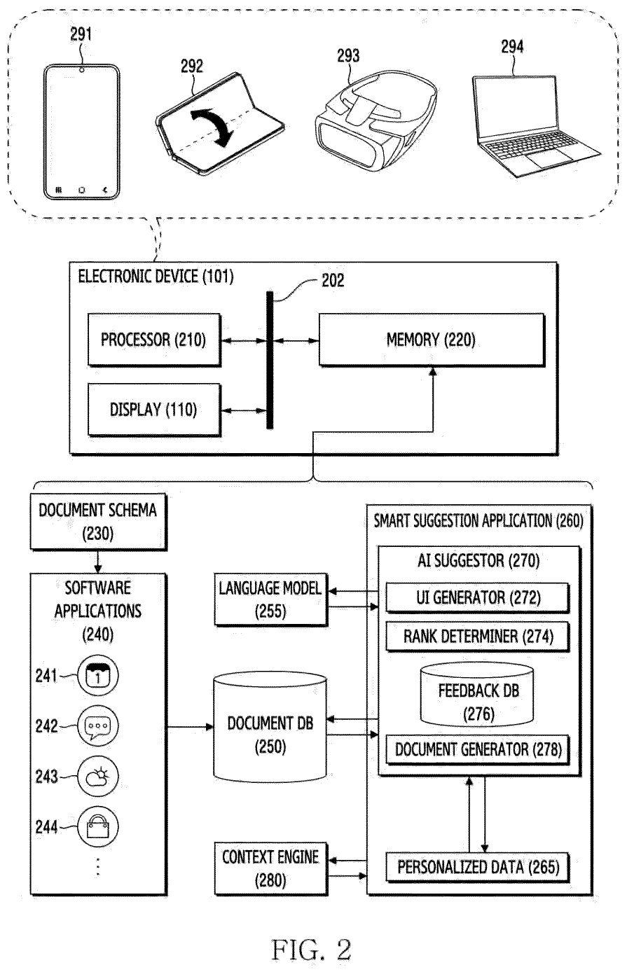

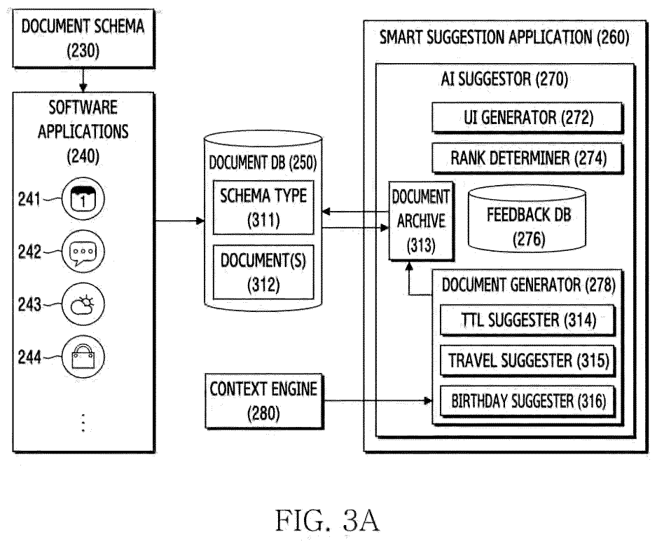

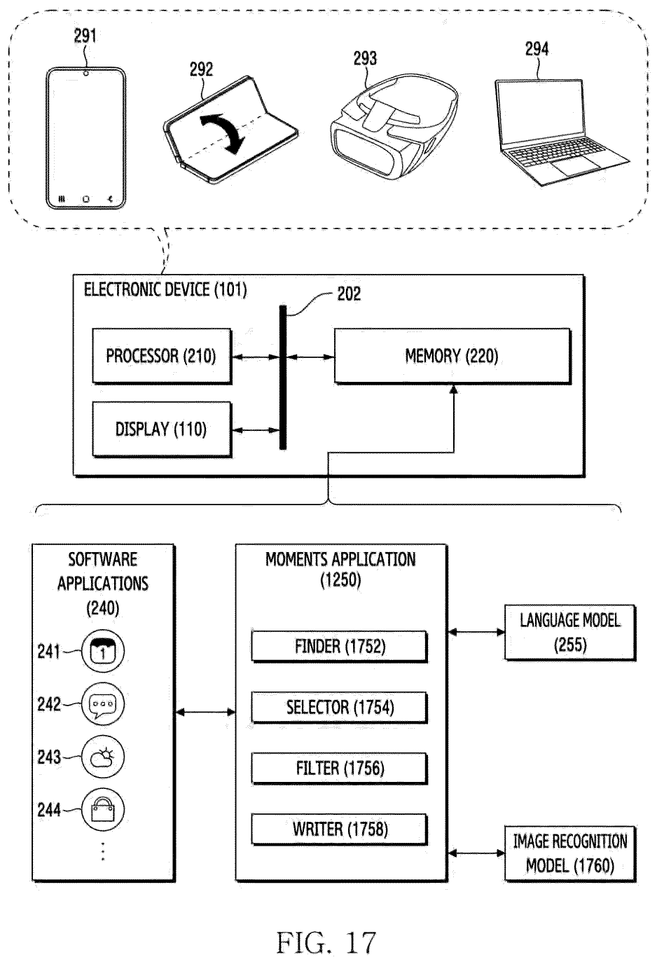

FIG. 1 is a diagram illustrating example states 191, 192, 193, and 194 of an electronic device 101 according to various embodiments. The electronic device 101 of the present disclosure may be referred to as a mobile device, a user equipment (UE) (or user terminal), a multifunctional device, a portable communication device, and/or a portable device. Example hardware component(s) included in the electronic device 101 is described in greater detail below with reference to FIGS. 2, 17, and/or 35.

According to an embodiment, the electronic device 101 may display or visualize a content stored in the electronic device 101 (e.g., a content generated and/or stored by a software application executed by the electronic device 101). The electronic device 101 may provide summarization or a summary for a content(s) stored in the electronic device 101. The terms “summarization” and “summary” may be used interchangeably herein. The summarization may include insight (e.g., text for summarization, description, and/or suggestion) for a content stored in the electronic device 101. The summarization for the content provided by the electronic device 101 may be generated based on personalized data (e.g., a user's interest and/or feedback) of a user (e.g., user owning the electronic device 101) of the electronic device 101. The present disclosure may include descriptions of the electronic device 101, a method, and/or a non-transitory computer-readable storage medium for providing insight for the stored content (e.g., summarization, description, and/or suggestion for the content).

Referring to FIG. 1, example states 191, 192, 193, and 194 of the electronic device 101 providing various content through the display 110 are illustrated. The state 191 may be an example state of the electronic device 101 displaying a lock screen. The state 192 may be an example state of the electronic device 101 displaying a home screen (or a launcher screen). The state 193 may be an example state of the electronic device 101 displaying a screen based on execution of a specific software application (e.g., web browser). The state 194 may be an example state of the electronic device 101 displaying a screen including contents provided from software applications including a web browser, and summarization for the content. The state 194 may be an example state of the electronic device 101 displaying a screen including the contents and a content (e.g., AI-generated content) generated using the contents. In the present disclosure, a screen displayed in the state 194 may be referred to as a briefing screen in terms of briefing contents. In the present disclosure, a screen displayed in the state 194 may be referred to as a smart suggestion screen.

Referring to the state 194 of FIG. 1, the electronic device 101 may display contents arranged (or curated) based on personalized data and/or context (e.g., a current time, a location, and/or a user's current state). The screen displayed through the display 110 in the state 194 may include contents arranged based on artificial intelligence. In terms of displaying contents arranged based on artificial intelligence, the screen displayed in the state 194 may be referred to as an AI space.

Referring to the state 194 of FIG. 1, the electronic device 101 may display card objects 151, 152, 153, and 154 respectively corresponding to contents provided from various software applications. In this disclosure, the term “card object” may be used interchangeably with terms such as “content object”, “document object”, “document”, and/or “card”. In some descriptions, the card object may be referred to as a visual object. Referring to FIG. 1, the example state 194 displaying a briefing screen including a card object 151 provided by a software application (e.g., weather application) that provides weather-related information, a card object 152 provided by a software application for a coupon and/or shopping, and a card object 153 provided by a software application (e.g., calendar application) to manage schedule information is illustrated.

As in the state 194 of FIG. 1, by displaying a briefing screen in which contents provided from a plurality of software applications are aggregated, the electronic device 101 may collectively provide information derived from different sources (e.g., the plurality of software applications) to a user. In the example state 194 in which card objects 151, 152, 153, and 154 are arranged along a vertical direction 155 of the display 110, the electronic device 101 may (collectively) move or scroll the card objects 151, 152, 153, and 154, based on a touch gesture (or touch input) performed on the display 110 along the vertical direction 155 (e.g., a drag gesture and/or a swipe gesture performed on the display 110 along the vertical direction 155). For example, when a size of a display region (or an active region) of the display 110 is insufficient to display contents such as the card objects 151, 152, 153, and 154, the electronic device 101 may support or assist in searching the contents based on scrolling. According to an embodiment, the electronic device 101 may display suitable contents for the user prior to other contents by dynamically determining and/or changing an order of the card objects 151, 152, 153, and 154 displayed on the display 110. For example, the electronic device 101 may display a content suitable for a situation of the user inferred according to a location and/or a time, above other contents. An example operation of the electronic device 101 displaying a briefing screen using contents generated from a plurality of software applications and/or an example operation of the electronic device 101 determining an order of the contents (e.g., an order of the card objects 151, 152, 153, and 154 within the briefing screen) will be described in greater detail below with reference to FIGS. 2 to 8.

Referring to the state 194 of FIG. 1, the electronic device 101 may display, together with card objects 151, 152, 153, and 154 respectively including contents obtained from a plurality of software applications, texts (e.g., texts 141, 142, and 143) representing summarization of the contents. For example, as in the texts 141 and 142, the electronic device 101 may display a greeting based on contents and/or a state (e.g., a state of the electronic device 101 and/or a user).

For example, the text 141 may be (arbitrarily) selected from predefined texts according to an event, a context, and/or a time. The predefined texts may include “Time is running out!”, “Don't miss it!”, “It's time to leave!”, “Good night!”, and/or “Cheer up in the afternoon”. When the electronic device 101 identifies a valid event at a current time (e.g., an event associated with a travel schedule and/or a moving schedule), the electronic device 101 may display the text 141 including a message associated with the event regardless of the context and the time. When the electronic device 101 does not identify a valid event at the current time, the electronic device 101 may display the text 141 including a message based on a context of the user (e.g., a place and/or the state of the user). When the electronic device 101 does not identify both the event and the context, the electronic device 101 may display the text 141 including a message based on the current time.

For example, the text 142 may be referred to as a main insight message. The electronic device 101 may display, together with card objects 151, 152, 153, and 154 corresponding to different contents, the text 142 representing summarization of an important content among the contents. The electronic device 101 may group contents according to the number of the contents. The electronic device 101 may generate summarization for each of the grouped contents. For example, when the electronic device 101 identifies contents associated with a golf schedule (e.g., a reminder notification, SMS messages, and/or a schedule), the electronic device 101 may display the text 142 representing summarization of the contents (e.g., “You had a productive day today! Since you have a golf schedule tomorrow morning, it would be good to check the alarm in advance and take a good rest.”).

For example, in the example state 194 displaying a briefing screen in the morning, the electronic device 101 may display the text 142 including a greeting associated with the morning (e.g., “Have a vibrant start to your day.”). Referring to FIG. 1, the electronic device 101 may display the text 143 representing a description and/or summarization of at least one of the card objects 151, 152, 153, and 154. The description and/or summarization included in the text 143 may be associated with ranks of the card objects 151, 152, 153, and 154 and/or a display order thereof in a briefing screen. For example, the text 143 may include summarization of two card objects 151 and 152 located at the top on the display 110 (e.g., “The temperature today is 20° C. Cloudy weather is expected. Be sure to use coffee coupon expiring tomorrow after your afternoon meeting!”). In order to provide insights to a user viewing the briefing screen including the card objects 151, 152, 153, and 154, the electronic device 101 may display the texts 141, 142, and 143.

Referring to FIG. 1, states 191, 192, and 193 of the electronic device 101, which are different from the state 194 displaying the briefing screen, are illustrated. In the state 191 displaying a lock screen, the electronic device 101 may display a widget object 111 referred to as a Now Bar. The lock screen may include a screen displayed before user authentication (e.g., authentication based on a password, a personal identification number (PIN), an unlock pattern, a fingerprint, an iris, a face, and/or a voice). A state of the electronic device 101 displaying the lock screen may be referred to as a locked state. Although an embodiment is illustrated in which the widget object 111 is displayed together with a shortcut icon (e.g., icons 112 and 113) related to a function allowed in a locked state (e.g., an emergency call function and/or a camera shooting function), a location of the widget object 111 within the lock screen is not limited thereto. The widget object 111 may be located not only at the lock screen but also at an always on display (AOD) screen.

Referring to FIG. 1, in the state 192 displaying a home screen, the electronic device 101 may display a widget object 121. In the present disclosure, the widget objects 111 and 121 may be referred to as a Now Bar, a Now Brief widget, and/or a Now widget. The home screen may include not only the widget object 121 but also widget objects 122 and 123 provided from each of software applications. The home screen may include an icon 124 corresponding to a software application. The home screen may be displayed based on user authentication performed on the lock screen. The home screen may be referred to as a launcher screen.

Referring to FIG. 1, in the state 193 in which a specific software application (e.g., web browser) is executed, the electronic device 101 may display a screen (e.g., web browser screen) provided from the specific software application. While displaying an execution screen provided from the specific software application, the electronic device 101 may (continuously) display a navigation bar 125. In the state 193, the electronic device 101 may display a pop-up menu referred to as an edge panel 130 based on a touch input performed at a portion adjacent to an edge of the display 110. For example, based on a drag gesture started at a location adjacent to a right edge of the display 110 and performed along a horizontal direction of the display 110, the electronic device 101 may display the edge panel 130. The edge panel 130 may include icons 131 and 132 for execution of at least one of a plurality of software applications installed in the electronic device 101. The edge panel 130 may include options 133 and 134 for editing a software application(s) registered at the edge panel 130 (e.g., registered to display an icon in the edge panel 130).

As in the states 192 and 193 of FIG. 1, a state of the electronic device 101 in which user authentication has been completed may be referred to as an unlock state. In the unlock state, the electronic device 101 may display icons (e.g., a recent apps button, a home button, and/or a back button) for switching a screen displayed on the display 110, in a portion of the display 110 referred to as the navigation bar 125.

In the states 191, 192, and 193 of FIG. 1, the electronic device 101 may identify or receive a user input for displaying a briefing screen. For example, based on a user input (e.g., a tapping gesture of tapping the display 110) for selecting the widget object 111, the widget object 121, and/or the icon 131 in the edge panel 130, the electronic device 101 may switch to the state 194 displaying the briefing screen. For example, based on receiving a user input associated with the widget object 111, the electronic device 101 may perform authentication for a user of the electronic device 101. Based on the authentication, the electronic device 101 may switch to the state 194 displaying a briefing screen (e.g., a briefing screen including texts 141, 142, and 143, and card objects 151, 152, 153, and 154). The disclosure is not limited thereto, and the electronic device 101 may switch to the state 194 without the authentication based on the user input associated with the widget object 111.

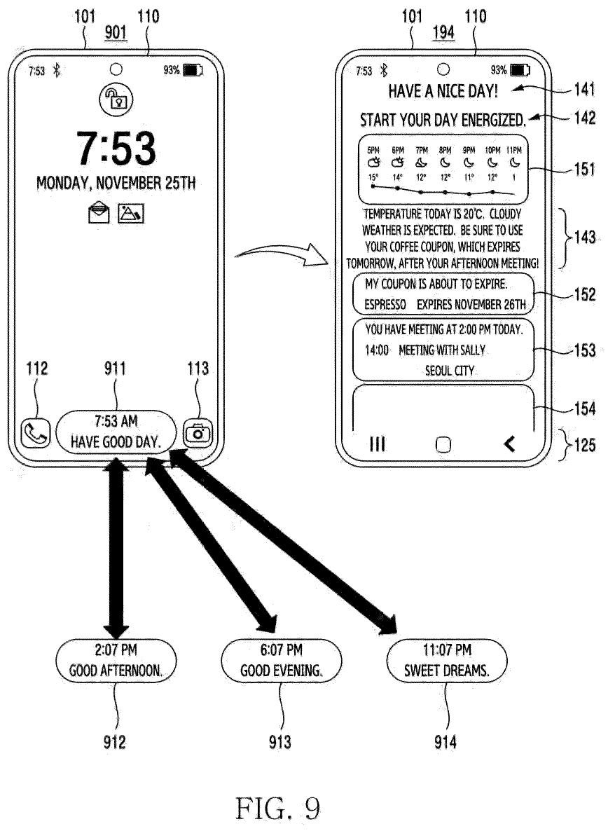

According to an embodiment, the electronic device 101 may display a text associated with a content(s) to be displayed through a briefing screen at a widget object linked to the briefing screen, such as the widget objects 111 and 121. Referring to FIG. 1, in the example state 191 in which the widget object 111 is displayed in a morning time, the electronic device 101 may display a text (e.g., “Morning Briefing”) associated with the morning time in the widget object 111. Referring to FIG. 1, in the example state 192 in which the widget object 121 is displayed in a morning time, the electronic device 101 may display a greeting (e.g., “Good morning”) based on a current time in the widget object 121. The text included in the widget objects 111 and 121 may include a content associated with a text (e.g., texts 141, 142, and 143) generated to be displayed on the briefing screen. An example operation of the electronic device 101 for generating a text included in a widget object (e.g., the widget objects 111 and 121) linked to the briefing screen will be described in greater detail below with reference to FIG. 9.

As described above, according to an embodiment, the electronic device 101 may display contents (e.g., contents associated with card objects 151, 152, 153, and 154) stored in the electronic device 101 to a user according to an order based on ranks. Before displaying a briefing screen including the contents (e.g., the screen displayed in the state 194), the electronic device 101 may display summarization of the contents and/or an insight message (or insight text) based on the contents using a widget object (e.g., the widget objects 111 and 121). For example, before displaying the briefing screen including the contents, the electronic device 101 may preferentially display, through the widget object, an important content to the user among the contents. In this example, the electronic device 101 may display, through the widget object, texts for guiding and/or recommending a user action associated with the contents. In order to guess important contents to the user, the electronic device 101 may include hardware and/or software for processing contents obtained from software applications.

Hereinafter, hardware and/or software included in the electronic device 101 for managing content will be described in greater detail below with reference to FIG. 2.

FIG. 2 is a block diagram illustrating an example configuration of an electronic device 101 according to various embodiments. The electronic device 101 of FIG. 2 may include the electronic device 101 of FIG. 1. The electronic device 101 may have a form factor of not only a bar-type smartphone 291 but also a laptop personal computer (PC) 294, a foldable-type smartphone 292, a slidable (or rollable) type smartphone, a head-mounted display (HMD) device 293 (or head-wearable electronic device), a watch, an electronic control unit (ECU) in a vehicle (e.g., an electric vehicle (EV)), a tablet PC, and/or another suitable computing device (e.g., desktop PC).

Referring to FIG. 2, the electronic device 101 may include a processor (e.g., including processing circuitry) 210, memory 220, and/or a display 110. The processor 210 may be electrically and/or operably coupled to the memory 220 and/or the display 110. Electronic components being electrically coupled may include a state in which a wired signal path for signal transmission (or connection for wireless communication) is established between the electronic components. Electronic components being operably coupled may include a state in which the electronic components are directly coupled (or a state in which the electronic components are indirectly coupled) so that an electronic component is controlled by another electronic component among the electronic components. Referring to FIG. 2, an electrical connection between the processor 210, the memory 220, and the display 110 based on an electronic component, referred to as a communication bus 202, is schematically illustrated. The processor 210, the memory 220, and the display 110 may be communicatively coupled through the communication bus 202.

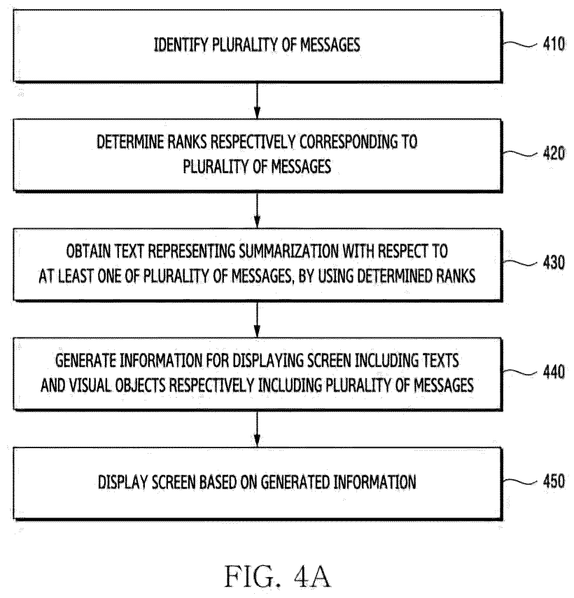

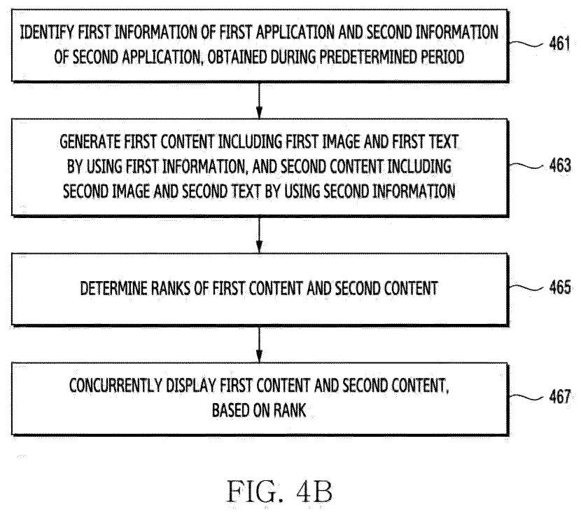

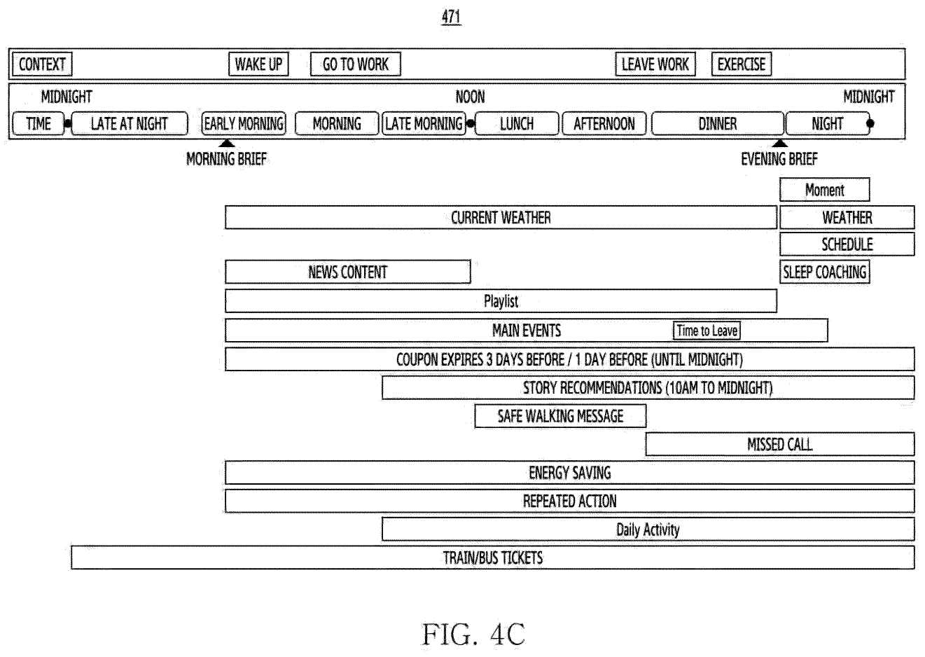

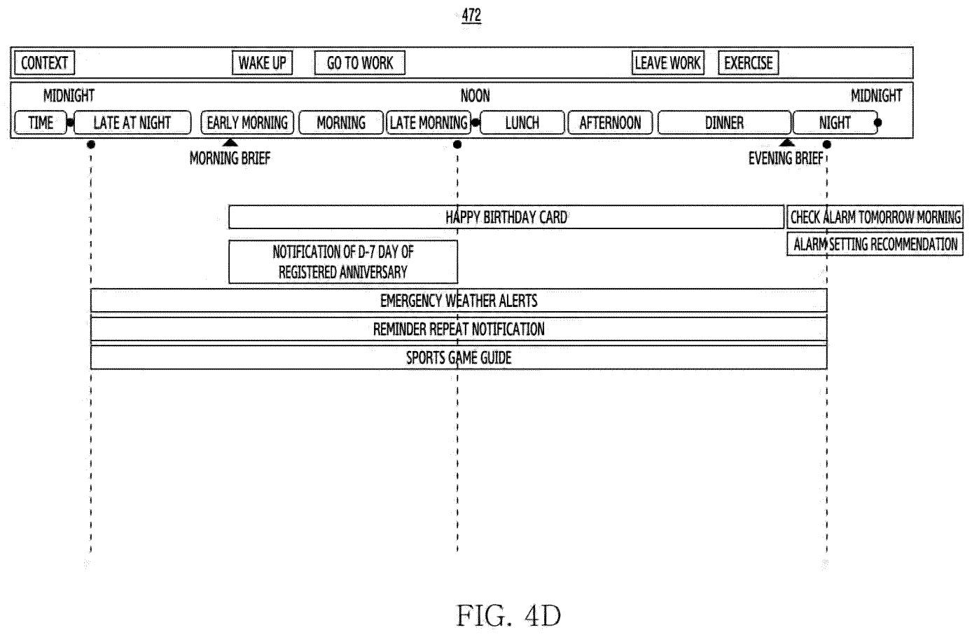

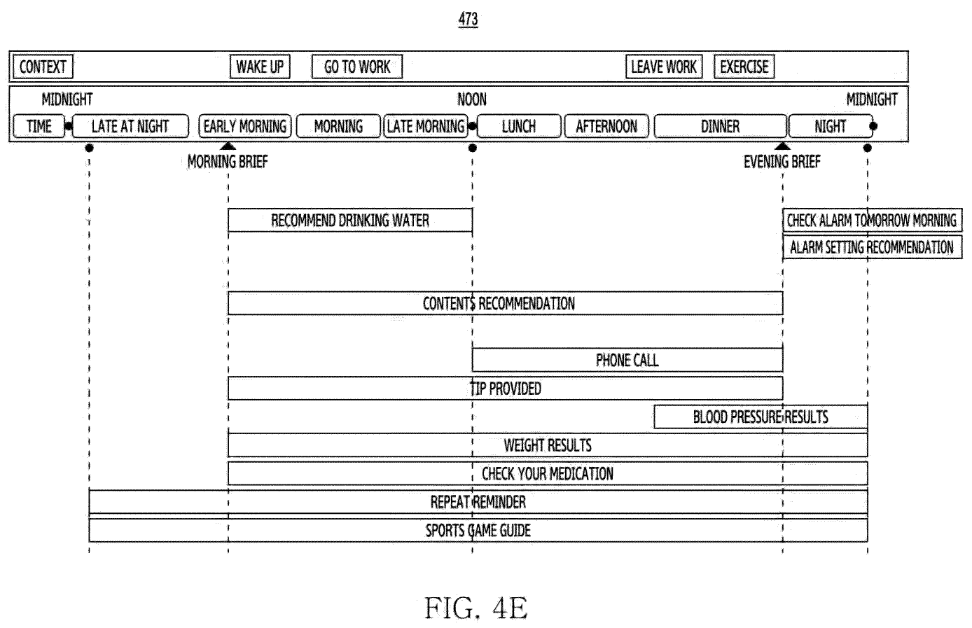

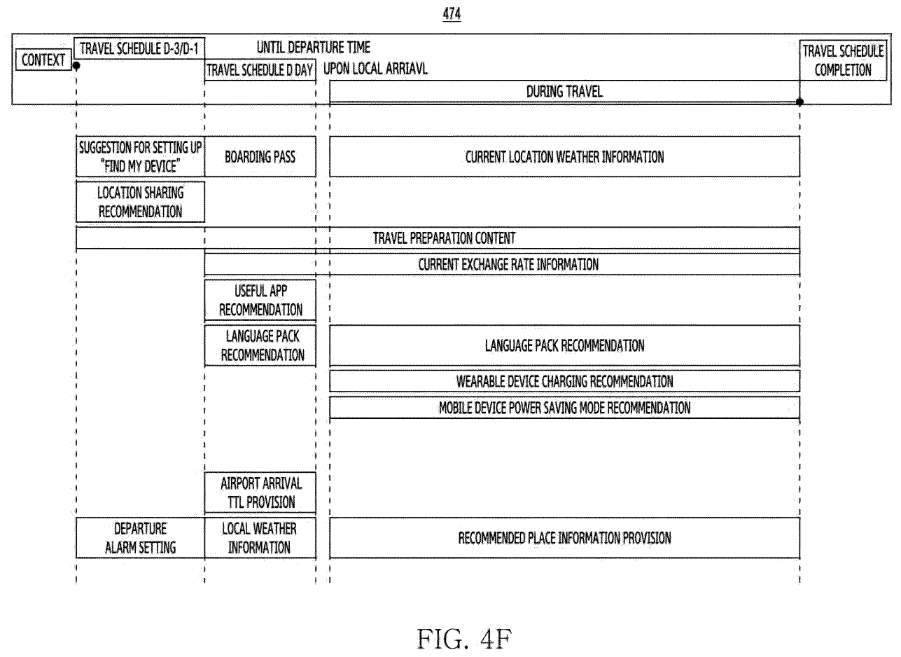

Referring to FIG. 2, the processor 210 of the electronic device 101 may include circuitry (e.g., processing circuitry and/or core) for performing an operation (e.g., arithmetic operation and/or logical operation) on data. A binary code (e.g., instruction) indicating the operation may be input to the processor 210. The processor 210 may include a central processing unit (CPU), a graphic processing unit (GPU), and/or a neural processing unit (NPU). The processor 210 may be referred to as an application processor (AP) and/or a system on a chip (SoC). The processor 210 may have a structure for simultaneously loading (or fetching) and/or executing a plurality of instructions (e.g., a multi-core structure based on a combination of a plurality of core circuits such as dual core, quad core, hexa core, or octa core). In the electronic device 101 including at least one processor 210, the at least one processor 210 may perform operations of the present disclosure individually or collectively. For example, and without limitation, the at least one processor 210 may perform, by executing instructions stored in the memory 220, operations of, for example, FIGS. 4A to 4B individually and/or collectively. Thus, the processor 210 may include processing circuitry, and/or may include multiple processors. For example, as used herein, including the claims, the term “processor” or “model” (e.g., a machine learning model) may include various processing circuitry, including at least one processor, wherein one or more of at least one processor, individually and/or collectively in a distributed manner, may be configured to perform various functions described herein. As used herein, when “a processor,” “at least one processor,” “a model,” “at least one model,” “a machine learning model” and “one or more processors” are described as being configured to perform numerous functions, these terms cover various situations, for example and without limitation, in which one processor and/or model performs some of recited functions and another processor(s) and/or model(s) performs other of recited functions, and also situations in which a single processor and/or model may perform all recited functions. Additionally, the at least one processor may include a combination of processors performing various of the recited/disclosed functions, e.g., in a distributed manner. At least one processor may execute program instructions to achieve or perform various functions. Likewise, the at least one model may include a combination of circuitry and/or processors performing various of the recited/disclosed functions, e.g., in a distributed manner. At least one processor and/or model may execute program instructions to achieve or perform various functions.

The memory 220 of FIG. 2 may include circuitry for storing data (or instructions) input to the processor 210 or output from the processor 210. The memory 220 may include a volatile memory such as a random-access memory (RAM) and/or a non-volatile memory such as a read-only memory (ROM). The non-volatile memory may be referred to as storage. The volatile memory may include, for example, at least one of a dynamic RAM (DRAM), a static RAM (SRAM), a cache RAM, and a pseudo SRAM (PSRAM). The non-volatile memory may include at least one of, for example, a programmable ROM (PROM), an erasable PROM (EPROM), an electrically erasable PROM (EEPROM), a flash memory, a hard disk, a compact disk, a solid state drive (SSD), and an embedded multimedia card (eMMC). The memory 220 may include one or more storage media (e.g., the volatile memory and/or the non-volatile memory described above) located in the electronic device 101 in a distributed manner. The processor 210 of the electronic device 101 may perform, by executing instructions of the memory 220 in the electronic device 101, a functions and/or an operation (e.g., operations of FIGS. 4A and 4B) indicated by the instructions.

The display 110 of the electronic device 101 may include circuitry for visualizing information provided from the processor 210. The display 110 may include a liquid crystal display (LCD), a plasma display panel (PDP), and/or light emitting diodes (LEDs). The LED may include an organic LED (OLED). The disclosure is not limited thereto, and the display 110 may include electronic paper. A display region (or active region) of the display 110 may include a region where light formed by pixels (e.g., activated pixels) of the display 110 is emitted. The display 110 may include a sensor (e.g., touch sensor) for detecting an external object (e.g., a user's finger) on the display 110. The sensor may be included in the display 110 in a form of a panel (e.g., touch sensor panel (TSP)). The display 110 including the sensor may be referred to as a touch screen display.

In an embodiment, software applications 240 may be installed in the electronic device 101. A state in which a software application is installed in the electronic device 101 may include a state in which information (e.g., instructions and/or resource for executing the instructions) for driving the software application is stored in the memory 220. Referring to FIG. 2, as a non-limiting examples of the software applications 240 installed in the electronic device 101, a calendar application 241, a messenger (e.g., instant message) application 242, a weather application 243, and/or a shopping application 244 are illustrated. The disclosure is not limited thereto, and the software applications 240 may include a myfile application for managing files stored in the memory 220, a web browser application, a routine application for work automation, a smart things application for executing a function related to an Internet of things (IoT) device, a reminder application for notification, a gallery application for managing images and/or videos stored in the memory 220, a wallet application for digital payment, and/or a health application for managing health information.

In an embodiment, the software applications 240 may be configured to register and/or store a content (e.g., contents indicating each of the card objects 151, 152, 153, and 154 in FIG. 1) in the document database (DB) 250. The processor 210 may register or store a content in the document DB 250, by executing at least one of the software applications 240. The document DB 250 may be a database for managing a content having a format based on a document schema 230 (or document data structure or document format). In this disclosure, the database may include a combination of a program(s) to support a function (e.g., addition, deletion, change, and/or search) associated with systematic information and hardware (e.g., the processor 210 and/or the memory 220) to execute the program. The document schema 230 is information for defining information (e.g., field, variable, attribute, and/or parameter) included in the content, and may indicate that a content including information such as Table 1 may be stored in the document DB 250.

TABLE 1

| Variable Name | |
|---|---|
| (or Attribute Name) | Explanation |
| ID | An identifier and/or index uniquely assigned to each of contents |
| | included in the document DB 250 |
| name | A name of the content |
| deviceIcon | An icon of a device corresponding to the content |
| deviceName | The name of the device corresponding to the content |
| deviceNumber | The number of activated devices corresponding to the content |
| cardArctColor | A color of a card object corresponding to the content |
| cardFontColor | A color of a text of the card object corresponding to the content |
| title | A title text of the card object corresponding to the content |
| insightMessageTitle | A title of an insight text displayed with the content |
| insightMessageDescription | A description of the insight text displayed with the content |
| creationTimestampMillis | A timestamp (unit: milliseconds) indicating a time when the |
| | content was created |
| documentTtlMills | A valid period of the content (unit: milliseconds) |
| ImportantTimeFrames | An importance level of the content |
| ImportantContexts | A context corresponding to the content (a value of this variable |
| | may be compared with the context information of the electronic |
| | device 101, described later, to determine the importance level of |
| | the content) |
| ValidTimeFrames | A time intervals in which the content is to be displayed |
| ValidContexts | A valid context of the content (a value of this variable may be |
| | compared with the context information of the electronic device |
| | 101, described later, to determine whether the content is to be |
| | displayed) |
| StartTimeMillis | A start time of the content |
| EndTimeMillis | An end time of the content |
| DailyTime | A time period (e.g., early morning, morning, lunch, afternoon, |
| | evening, night, late night) of the start time and/or end time of the |
| | content |

When a content provided from at least one of the software applications 240 is stored in the document DB 250, the processor 210 may execute a smart suggestion application 260. For example, instructions of the smart suggestion application 260 may be connected to the document DB 250 as a callback function. The processor 210 that stores a content in the document DB 250 may execute instructions of the smart suggestion application 260, which are defined as the callback function.

The smart suggestion application 260 may be installed in the electronic device 101 to display the briefing screen of FIG. 1 (e.g., a screen displayed through the display 110 in the state 194 of FIG. 1) and/or the widget object (e.g., the widget objects 111 and 121 of FIG. 1). The smart suggestion application 260 may be executed to generate a personalized screen (e.g., the briefing screen illustrated in FIG. 1) based on a context (e.g., time, location, and/or behavior) of a user of the electronic device 101. In order to execute the personalized screen, the smart suggestion application 260 may be configured to utilize the document DB 250 and/or a language model 255. Referring to FIG. 2, functions of the smart suggestion application 260 may be illustrated as blocks. The functions of the smart suggestion application 260 are not limited to the functions illustrated by the blocks of FIG. 2. The smart suggestion application 260 may be referred to as a briefing application (e.g., a Now Brief application) in terms of providing a briefing screen.

The smart suggestion application 260 may include an AI suggestor 270 for determining ranks of contents and/or generating a text representing summarization of the contents. The AI suggestor 270 may include at least one of a UI generator 272 for generating a briefing screen and/or a widget object, a rank determiner 274 for determining ranks of contents, a feedback DB 276 for storing feedback data on the contents, and/or a document generator 278 for generating and/or registering contents in the document DB 250, each of which may include various circuitry and/or executable program instructions.

The smart suggestion application 260 may generate, store, and/or manage personalized data 265. The personalized data 265 may include data used for determining ranks of contents based on the AI suggestor 270 and/or summarizing the contents. The personalized data 265 may include data associated with the user's activity of the electronic device 101 (e.g., staying, moving, exercising, sleeping, taking photos, eating, calling, listening to music, watching video, playing game, reservation, and/or payment). The personalized data 265 may include data indicating an environmental context such as time, date, location, and/or weather, an activity and/or behavioral context of a user of the electronic device 101, a device context of the electronic device 101 (e.g., a state of charge (SOC) of a battery of the electronic device 101, and an execution history of software applications (e.g., app usage)), a context related to contents stored in the electronic device 101 (e.g., content context) (e.g., upcoming events and/or expiration date of coupon), and/or a characteristic of the user of the electronic device 101 (e.g., preference of the user). The personalized data 265 may include data for retrieval-augmented generation (RAG).

The electronic device 101 may include a context engine 280 for identifying and/or inferring a context (e.g., spatial context, behavioral context, and/or temporal context) related to the electronic device 101. For example, the processor 210 executing the context engine 280 may obtain or manage spatial context information, which is information about a place where the user of the electronic device 101 is repeatedly located (e.g., home, workplace, other frequently visited place, car, entry to and/or exit to certain place). In order to obtain the spatial context information, the processor 210 may obtain information related to a global navigation satellite system (GNSS), connectivity of the electronic device 101, and/or a point of interest (POI).

The processor 210 executing the context engine 280 may obtain or manage behavioral context information, which is information about the user's operation of the electronic device 101 (e.g., a function of the electronic device 101 repeatedly executed by the user) and/or a current state (e.g., going to work, driving, parking, sleeping, waking up, exercising, and the like). In order to obtain the behavioral context information, the processor 210 may obtain sensor data and/or health information from the electronic device 101 and/or another device (e.g., a user-wearable device, such as watch and/or ring) connected to the electronic device 101.

The processor 210 executing the context engine 280 may obtain or manage temporal context information, which is information about a repetition operation (e.g., an operation mainly performed at a specific time zone) of the user of the electronic device 101. In order to obtain the temporal context information, the processor 210 may obtain spatial context information, behavioral context information, sensor data of the electronic device 101, and/or connectivity information of the electronic device 101. The user's repetitive operation, indicated by the temporal context information, may include a routine before going to work, a routine before sleeping, and/or a routine after exercising.

Referring to FIG. 2, a language model 255 for natural language processing (NLP) may be installed in the electronic device 101. In the present disclosure, the language model 255 may be used interchangeably with terms such as a machine learning model, a trained model, an artificial intelligence model, a neural network, and/or a deep learning model. The trained model may include a computational model defined to simulate a neural activity of an organism, instructions indicating the computational model, and/or a set of parameters used to define the computational model. For example, the trained model may include nodes referred to as artificial neuron and/or perceptron, and weights assigned to connections between the nodes. For example, nodes of a trained model based on a feedforward neural network (FNN) may be included in each of an input layer, one or more hidden layers, and an output layer. The weights may define a weighted sum between nodes included in each of the layers, such as the input layer, the hidden layer, and/or the output layer. A set of weights may be stored in the memory 220. Nodes of the trained model may be arranged according to a structure such as a convolutional neural network (CNN), a recurrent neural network (RNN), a long-short term memory (LSTM), and/or a transformer. In terms of being installed in the electronic device 101 owned by a user, the language model 255 may be referred to as an on-device model.

According to an embodiment, the processor 210 may obtain or generate personalized text (e.g., personalized suggestion message) using the language model 255, based on execution of the smart suggestion application 260. For example, the processor 210 may obtain or generate personalized text from the language model 255, based on executing the smart suggestion application 260 based on the callback function. For example, the processor 210 may obtain personalized text based on contents stored in the document DB 250, by executing the language model 255 at a predetermined time (e.g., evening time and/or midnight time). For example, the processor 210 may execute the language model 255 using weather information and/or schedule information to generate personalized text. The texts 141, 142, and 143 of FIG. 1 may be an example of personalized text obtained using the language model 255. In order to obtain personalized text by executing the language model 255, the electronic device 101 may use a content(s) stored in the document DB 250. For example, when a plurality of contents are stored in the document DB 250, the electronic device 101 may obtain personalized text based on a content having a relatively high rank from the language model 255, using ranks of the plurality of contents. For example, the electronic device 101 may obtain text related to contents stored in the document DB 250 using the language model 255.

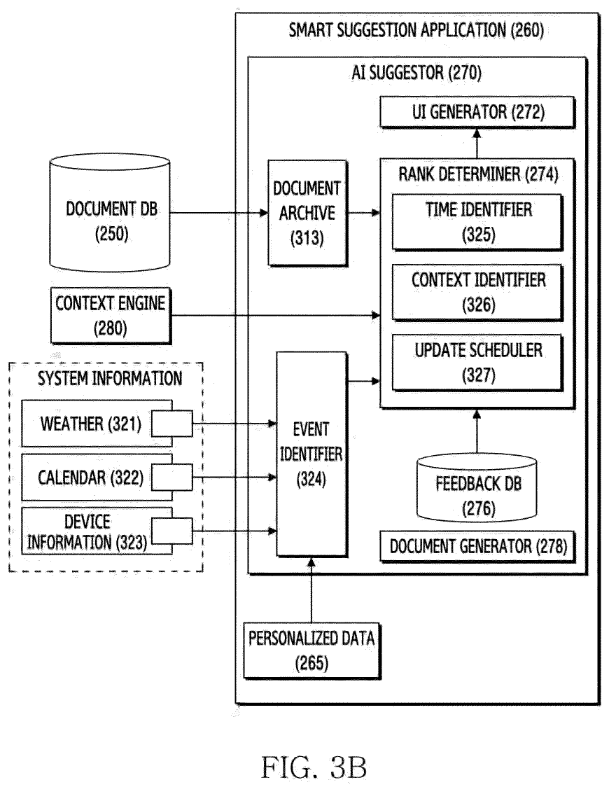

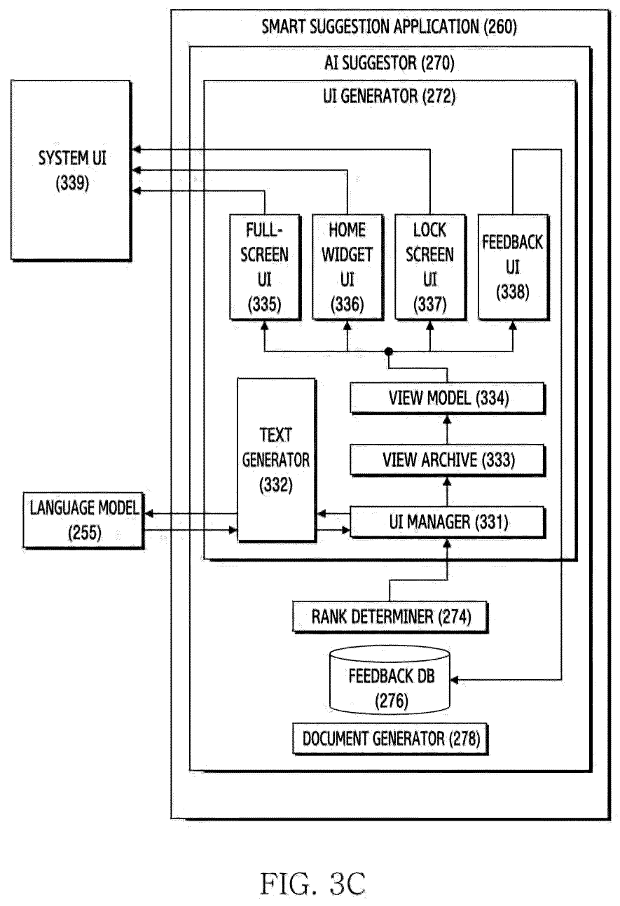

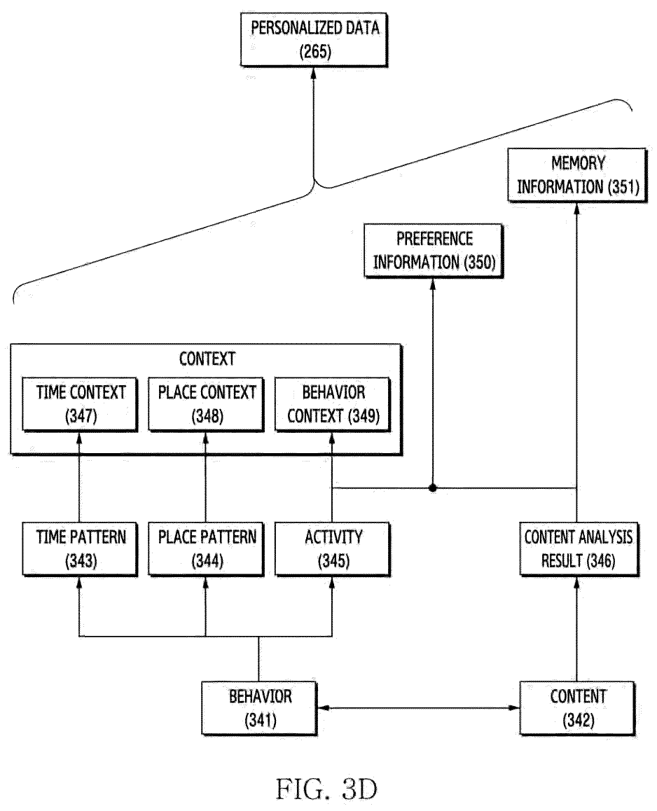

Hereinafter, an example operation of the processor 210 executing the smart suggestion application 260 will be described in greater detail below with reference to FIGS. 3A, 3B, 3C, and 3D.

FIG. 3A, FIG. 3B, FIG. 3C, and FIG. 3D are diagrams illustrating example operations performed by an electronic device to process a content provided by a software application according to various embodiments. The electronic device 101 of FIGS. 1 to 2 and/or the processor 210 of FIG. 2 may perform operations of the electronic device described with reference to FIGS. 3A to 3D.

In each of FIG. 3A, FIG. 3B, FIG. 3C, and FIG. 3D, programs (e.g., software applications 240 and/or smart suggestion applications 260) of the electronic device 101 described with reference to FIG. 2 are illustrated. In FIG. 3A, an example operation of an electronic device storing a content (e.g., document(s) 312) in a document DB 250 is illustrated. In FIG. 3B, an example operation of an electronic device determining ranks of contents stored in the document DB 250 is illustrated. In FIG. 3C, an example operation of an electronic device for generating and/or displaying a user interface (UI) for contents using the determined ranks is illustrated. In FIG. 3D, an example operation of an electronic device for generating and/or determining personalized data 265 is illustrated.

As described above with reference to FIG. 2, a content generated based on execution of at least one of the software applications 240 may be stored in the document DB 250. The electronic device executing at least one of the software applications 240 may generate or store a content according to a condition defined by each software application and/or a request from the smart suggestion application 260. The document(s) 312 stored in the document DB 250 may include at least one of attributes defined in Table 1. The document(s) 312 of FIG. 3A may be stored in a form of a list, within the document DB 250. The document DB 250 may include information on a format of information capable of being stored in the document DB 250 and/or information on schema (e.g., schema type 311).

An embodiment in which a content (e.g., the document(s) 312) provided from the software applications 240 is stored in the document DB 250 is illustrated, but the disclosure is not limited thereto. For example, the electronic device executing the smart suggestion application 260 may generate a content to be stored in the document DB 250. For example, the electronic device may check, by executing the document generator 278, a context (e.g., spatial context information, behavioral context information, and/or temporal context information of the context engine 280) of a user. The electronic device may generate a content based on the checked context. For example, based on execution of the document generator 278, the electronic device may generate a content including text suggesting an action of the user.

Referring to FIG. 3A, as a function of the document generator 278 capable of generating a content suggesting a behavior of a user, a time-to-leave (TTL) suggester 314, a travel suggester 315, and/or a birthday suggester 316 are illustrated. By executing the TTL suggester 314, the electronic device may generate a content suggesting a movement according to a next schedule after a current schedule of the user. By executing the TTL suggester 314, the electronic device may calculate a time required to move to a place of the next schedule. The electronic device may generate a content including a text suggesting the movement and reserved to be displayed based on the calculated time, using the calculated time.

Referring to FIG. 3A, the electronic device may generate a content associated with a trip scheduled by a user by executing the travel suggestor 315. By executing the travel suggestion 315, the electronic device may identify a user's travel schedule, using user's schedule information (e.g., schedule information included in the user's behavioral context information, generated by the context engine 280). The electronic device may generate a content including information (e.g., information on a travel place) associated with the identified travel schedule.

Referring to FIG. 3A, the electronic device may identify a birthday of a user of the electronic device and/or another user (e.g., another user who is registered in a contact or has a follow relationship through a social network service (SNS)) related to the user. Based on identifying a birthday corresponding to a current date (e.g., current date identified by device information of the electronic device), and/or adjacent to the current date, the electronic device may generate a content related to the birthday.

Referring to FIG. 3A, a content generated based on execution of the document generator 278 may be stored in a document archive 313 and/or the document DB 250. The document archive 313 may include a buffer defined for exchange of contents between the document DB 250 and the smart suggestion application 260 and/or a program for managing the buffer. For example, when a callback function connected to the document DB 250 is executed (e.g., when a new document is stored in the document DB 250, or when the callback function is executed based on an update of the document DB 250), the electronic device may store or copy a content (e.g., the document(s) 312) of the document DB 250 in the document archive 313.

Referring to FIG. 3B, the electronic device may determine, by executing a rank determiner 274, ranks of the contents of the document DB 250. A time identifier 325, a context identifier 326, and/or an update scheduler 327 of FIG. 3B may indicate functions for determining an execution condition of the rank determiner 274. For example, at a timing reserved by the update scheduler 327, the electronic device may execute the rank determiner 274. For example, by executing update scheduler 327, the electronic device may schedule execution of the rank determiner 274 and/or the smart suggestion application 260 at a specific time (e.g., time between 18:00 and 20:00 and/or time between 21:00 and 23:00). For example, by executing the update scheduler 327, the electronic device may schedule execution of the rank determiner 274 and/or the smart suggestion application 260, based on a change in the user's context, indicated by the personalized data 265 and/or context information of the context engine 280.

For example, the electronic device executing the time identifier 325 may determine whether to change ranks of contents, according to a current time indicated by system information (e.g., device information 323). For example, the electronic device executing the context identifier 326 may determine whether to change ranks of contents, according to a change in the user's context indicated by the context engine 280. The electronic device may identify, by executing an event identifier 324, update of system information (e.g., weather 321, calendar 322, and/or device information 323) and/or the personalized data 265. The electronic device identifying the update may execute the rank determiner 274 and/or the document generator 278 according to the update. Referring to FIG. 3B, the device information 323 illustrated as system information may include various states of an electronic device, such as a battery state (e.g., SOC) of the electronic device, audio mode (e.g., vibration mode and/or silent mode), a do not disturb mode, and/or dark mode. The system information may be used for execution of the document generator 278 and/or the UI generator 272 as well as the rank determiner 274.

For example, the determining ranks based on the rank determiner 274 may be performed when a context of the electronic device and/or user indicated by the context engine 280 is changed when the document DB 250 is updated. The disclosure is not limited thereto, and the determining of ranks based on the rank determiner 274 may be performed when generating a briefing screen according to execution of the smart suggestion application 260.

In an embodiment, ranks of each of the contents determined by executing the rank determiner 274 may be determined by context information generated by the context engine 280 and/or system information (e.g., weather 321, calendar 322, and/or device information 323), as well as the importance level and/or urgency of the contents. The electronic device may determine or change ranks of contents, using spatial context information generated by the context engine 280 (e.g., information indicating a current location of a user such as a home and/or a workplace), behavioral context information (e.g., information indicating an activity of the user such as sleeping, commuting, and traveling), and/or a current time indicated by system information, preferences (e.g., cold start preference) of the user and/or feedback stored in the feedback DB 276.

In an embodiment, the electronic device may determine ranks of the contents according to an order of Table 2.

TABLE 2

| Order | Description |
|---|---|
| 1 | The electronic device may determine whether the content is valid |
| | at a current time using time information of the content. For |
| | example, when creation TimestampMillis + documentTtlMills of |
| | Table 1 are later than the current time, a corresponding content |
| | may be ignored. |
| 2 | The electronic device may determine whether to display the |
| | content by comparing context information identified by the |
| | context engine 280 and a context corresponding to the content |
| | (e.g., a context included in ValidContexts of Table 1). For |
| | example, when the context corresponding to the content does not |
| | match the context information identified by the context engine |
| | 280, the content may not be displayed. |
| 3 | The electronic device may determine ranks of the contents using |
| | ranks included in each of the contents. |
| 4 | The electronic device may change a rank using a period set in |
| | each content (e.g., a period indicated by ImportantTimeFrames of |
| | Table 1). For example, when the current time of the electronic |
| | device is included in a period set in a specific content, the |
| | electronic device may increase the rank of the specific content. |
| 5 | When contents having the same ranks are identified among the |
| | contents, the electronic device may change a rank of at least one |
| | of the contents using sizes of intersections between the context |
| | information identified by the context engine 280 and contexts of |
| | each of the contents. |
| 6 | When contents having the same ranks are identified among the |
| | contents, the electronic device may change a rank according to |
| | time differences between times set in each of the contents and the |
| | current time. For example, a rank of a content having the time |
| | closest to the current time may be increased. |

The order in which the electronic device performs operations of Table 2 to determine ranks of contents is not limited to the order of Table 2. As described above with reference to Table 2, the electronic device may determine whether to display the content and/or the rank of the content, using the current time indicated by the device information 323 and time information of the content. For example, the content may be displayed on a briefing screen (e.g., a briefing screen generated by the smart suggestion application 260) within a valid time zone set by the content.

In an embodiment, the electronic device executing the rank determiner 274 may determine or calculate scores of each of the contents, as shown in a rank score of Equation 1.

$$Rank score = ( Priority \times 0.5 + ImportantDuration \times 0.25 + ImportantContext \times 0.25 ) \times Valid \qquad [ Equation 1 ]$$

Priority of Equation 1 is a floating-point number between 0 and 1 and may be a rank assigned to the content. Coefficients (e.g., 0.5 and/or 0.25) described in Equation 1 may be changed according to embodiments. ImportantDuration of Equation 1 may be a floating-point number between 0 and 1, determined by comparing time information set by the content and a current time. For example, when the current time corresponds to the time information set by the content (e.g., when the current time is included in a time interval defined by the time information), ImportantDuration may be set to 1. For example, when the current time does not correspond to the time information set by the content, ImportantDuration may be changed according to a temporal distance between the current time and the time interval defined by the time information. For example, ImportantDuration may be calculated as shown in Equation 2.

$$ImportantDuration = 1 - \frac{\begin{matrix}temporal distance between \\ current time and time interval\end{matrix}}{length of time interval} \qquad [ Equation 2 ]$$

The ImportantContext of Equation 1 is a floating-point number between 0 and 1, and may indicate a size of an intersection between the context information generated by the context engine 280 and the context set by the content. The Valid of Equation 1 is an integer between 0 and 1, and may be set to 1 when a valid time and/or valid context set by the content matches the current time of the electronic device and/or the current context.

The electronic device determining ranks of the contents by executing the rank determiner 274 may store the contents in the document archive 313, according to the ranks. After the contents are stored in the document archive 313, the electronic device may generate a briefing screen (or information indicating a layout of the briefing screen). The electronic device executing the rank determiner 274 may transmit the contents stored in the document archive 313 to the UI generator 272 in the order based on the ranks of the contents (e.g., return).

Referring to FIG. 3C, by executing the UI generator 272, the electronic device may generate or display a UI associated with at least one of the contents (e.g., a briefing screen displayed in the state 194 of FIG. 1 and/or the widget objects 111 and 121 displayed in the states 191 and 192 of FIG. 1). A UI manager 331 may correspond to a function of generating visual objects (e.g., card objects 151, 152, 153, and 154 of FIG. 1) representing each of contents. By executing the UI manager 331, the electronic device may determine a layout of a visual object representing the content. For example, the electronic device may determine the layout of the visual object, using a size of at least a portion of a display on which the visual object is to be displayed. The electronic device executing the UI manager 331 may obtain text (e.g., texts 141, 142, and 143 of FIG. 1) representing summarization of a content(s) to be displayed through a briefing screen, using a text generator 332. The text may be referred to as an insight message and/or an insight text.

Referring to FIG. 3C, the text generator 332 may correspond to a function of executing the language model 255 to generate a text representing summarization of the content(s). By executing the text generator 332, the electronic device may generate a prompt (or prompt sentence(s)) to be input into the language model 255. For example, a prompt generated based on the text generator 332 may include weather (e.g., lowest temperature and/or highest temperature of yesterday and/or today, weather type) and/or a current time, as information to be input into the language model 255. For example, a prompt generated based on the text generator 332 may include contents (or texts of the contents) arranged according to ranks. Table 3 illustrates an example prompt generated based on the text generator 332.

TABLE 3

```
      “You are a helpful AI assistant specializing in concise summarization. You
excel at prioritizing information and creating coherent, concise summaries. Follow
the steps below to summarize the information.\\n”+
          “<Input>\\n”+
          “==replace==\\n” +
          “<Instructions>\\n” +
      “1. Prioritize Information: Consider the order in which the information is
presented. Information appearing earlier should be given higher priority in the
summary.\\n” +
      “2. Select Key Information: Choose the top two most important pieces of
information based on the prioritization in step 1.” +
      “3. Concise Summarization: Condense the selected information into one clear
and concise sentence as briefly as possible. Avoid unnecessary details or
repetition.\\n” +
      “4. Ensure Coherence: Maintain consistency and logical flow throughout the
summary. The sentence should connect seamlessly and form a cohesive unit.\\n” +
      “5. Use Conjunctions: Utilize appropriate conjunctions (e.g., \“and,\” \“but,\”
\“because,\” \“therefore\”) to create smooth transitions and enhance the overall
coherence of the summary.\\n” +
      “<Output>\\n” +
          “- Adopt a Friendly, Professional Tone: Maintain a tone that is both
approachable and professional. Avoid overly casual or overly formal language.\\n” +
          “- Write in ==replace:Language==.\\n”
```

Referring to Table 3, a prompt may include a natural language sentence indicating a writing style of text output from the language model 255 (e.g., “You are a helpful AI assistant specializing in concise summarization. You excel at prioritizing information and creating coherent, concise summaries.” and/or “Adopt a Friendly, Professional Tone: Maintain a tone that is both approachable and professional. Avoid overly casual or overly formal language.”). Referring to Table 3, a prompt may include text indicating a language of a text output from the language model 255 (e.g., “‘- Write in ==replace:Language==.”). Referring to Table 3, a prompt may include a natural language sentence instructing to generate a text using at least one content having a higher rank than other contents among the contents (e.g., “Consider the order in which the information is presented. Information appearing earlier should be given higher priority in the summary.”).

Visual objects (e.g., card objects 151, 152, 153, and 154 of FIG. 1) generated by executing the UI manager 331 and/or text (e.g., texts 141, 142, and 143 of FIG. 1) representing summarization of contents may be stored in a view archive 333. Within the view archive 333, the visual objects and/or the text may be stored or bound based on a format of a view object (e.g., a view object defined by an Android operating system). For example, the electronic device may connect or bind a view object(s) indicating the visual object and/or the text to an object (e.g., activity object) corresponding to a briefing screen.

Referring to FIG. 3C, a view model 334 may be a function for generating a UI of the electronic device (e.g., a full-screen UI 335, a home widget UI 336, a lock screen UI 337, and/or a feedback UI 338) from the view objects stored in the view archive 333. The full-screen UI 335 may correspond to a briefing screen occupying an entire display region of the display 110. The home widget UI 336 may correspond to a widget object (e.g., the widget object 121 of FIG. 1) located on a home screen. The lock screen UI 337 may correspond to a widget object (e.g., the widget object 111 of FIG. 1) located on a lock screen. The widget objects may be used as entry points for the full-screen UI 335 (e.g., a briefing screen). The text included in the widget object may be a text generated using the language model 255. The text generated by the UI manager 331 and/or the text generator 332 may be used to change the text of the widget object. For example, the home widget UI 336 and/or the lock screen UI 337 may be a shortcut UI (e.g., an icon and/or a shortcut) for quickly executing the full-screen UI 335.

The feedback UI 338 may correspond to a UI for receiving feedback on a visual object(s) displayed through a briefing screen (or feedback on a content included in the visual objects). The feedback UI 338 may be included at least partially in the full-screen UI 335. The user input received through the feedback UI 338 may cause a change and/or update of the feedback DB 276.

In order to display a UI of the electronic device, a system UI 339 may be used. The system UI 339 is at least a portion of an operating system and/or system software of the electronic device, and may correspond to a function for displaying a lock screen and/or a home screen. In order to display the full screen UI 335, the home widget UI 336, and/or the lock screen UI 337, the electronic device may execute the system UI 339.

As described above, the electronic device may determine, based on generating a plurality of contents including a first content and a second content, ranks of the plurality of contents. The electronic device may generate a summarization text for a portion of the plurality of contents. For example, a rank of a portion of the plurality of contents may be higher than ranks of remaining contents. The electronic device may display the summarization text through a display, and may display the plurality of contents arranged according to the rank below the summarization text (e.g., the full screen UI 335). The disclosure is not limited thereto, and the electronic device may display the summarization text below one of the plurality of contents. The electronic device may determine or change an order of the summarization text and the plurality of contents within the display according to at least one of the plurality of contents.

Referring to FIG. 3D, a block diagram for describing an operation of an electronic device generating the personalized data 265 is illustrated. According to an embodiment, the electronic device may identify or infer a behavior 341 of a user, using schedule information and/or sensor data of a sensor. When a user is running, the electronic device may identify the behavior 341 of the user, using location information of the electronic device and/or information indicating a health state of the user. The electronic device identifying the behavior 341 may determine a content 342 being output by the electronic device as a content related to the behavior 341. For example, when the user is running while listening to music being output through the electronic device, the electronic device may determine the music as a content related to the behavior 341.

Referring to FIG. 3D, the electronic device may identify or determine a time pattern 343, a place pattern 344, and/or an activity 345 associated with the behavior 341. The time pattern 343 may indicate a time characteristic with respect to the behavior 341 of the user performed repeatedly. The place pattern 344 may indicate a characteristic of a location and/or a movement path of the user. The activity 345 may indicate a characteristic (e.g., a characteristic of listening to music) associated with the behavior 341 of the user.

Referring to FIG. 3D, the electronic device may generate or determine a time context 347 using the time pattern 343. For example, in a case of identifying the user who is running, the electronic device may generate the time context 347 for checking information (e.g., weather and/or wearing information of a wearable device such as a watch) associated with running before running. The electronic device may check whether a current location corresponds to a place frequently visited by the user, using a space context 348. For example, in the case, the electronic device may generate the space context 348 indicating that the current location of the electronic device is a place where the user frequently performs running. The electronic device may generate a behavior context 349 indicating a detailed behavior of the user who is running, using information on the activity 345. For example, in the case, the electronic device may generate the behavior context 349 indicating a content 342 (e.g., music) output by the electronic device.

Referring to FIG. 3D, the electronic device may obtain or generate a content analysis result 346 by analyzing the content 342. The content analysis result 346 may include information (in the case, a title, a genre, and/or a singer of the music) on the content being output by the electronic device. The content analysis result 346 may include information (e.g., a moving distance and/or measured calories) generated by the electronic device in relation to the behavior 341. The electronic device may generate preference information 350 using information on the activity 345 and the content analysis result 346. The preference information 350 may indicate a preference (e.g., a content preferred by the user) of the user associated with the behavior 341. For example, in the case, the preference information 350 may include data on a genre of music and/or a singer preferred by the user who is running.

Referring to FIG. 3D, the electronic device may obtain or generate memory information 351 using the activity 345 and the content analysis result 346. The memory information 351 may include a behavior (in the case, running) of the user indicated by the activity 345 and a content (in the case, music) associated with the behavior. The memory information 351 may include an engram with respect to the behavior of the user.

Referring to FIG. 3D, the time context 347, the space context 348, the behavior context 349, the preference information 350, the memory information 351, or any combination thereof may be stored in the personalized data 265.

Hereinafter, an operation of an electronic device executing the smart suggestion application 260 described with reference to FIGS. 2, 3A to 3D will be described in greater detail below with reference to FIGS. 4A to 4F.

FIGS. 4A, 4B, 4C, 4D, 4E and 4F include flowcharts and diagrams illustrating example operations of an electronic device according to various embodiments. The electronic device 101 of FIGS. 1 to 2 and/or the processor 210 of FIG. 2 may perform operations described with reference to FIG. 4A and/or FIG. 4F. An order in which the operations of FIG. 4A and/or FIG. 4B are performed is not limited to the order illustrated in FIG. 4A and/or FIG. 4B. For example, the electronic device 101 and/or the processor 210 of FIG. 2 may perform the operations of FIG. 4A and/or FIG. 4B in an order different from the order illustrated in FIG. 4A and/or FIG. 4B. For example, the electronic device 101 and/or the processor 210 of FIG. 2 may perform at least two operations of FIG. 4A and/or FIG. 4B at substantially the same time (e.g., multitasking and/or multithread). The operations of FIG. 4A and/or FIG. 4B may be performed by the electronic device executing the smart suggestion application 260 of FIG. 2.

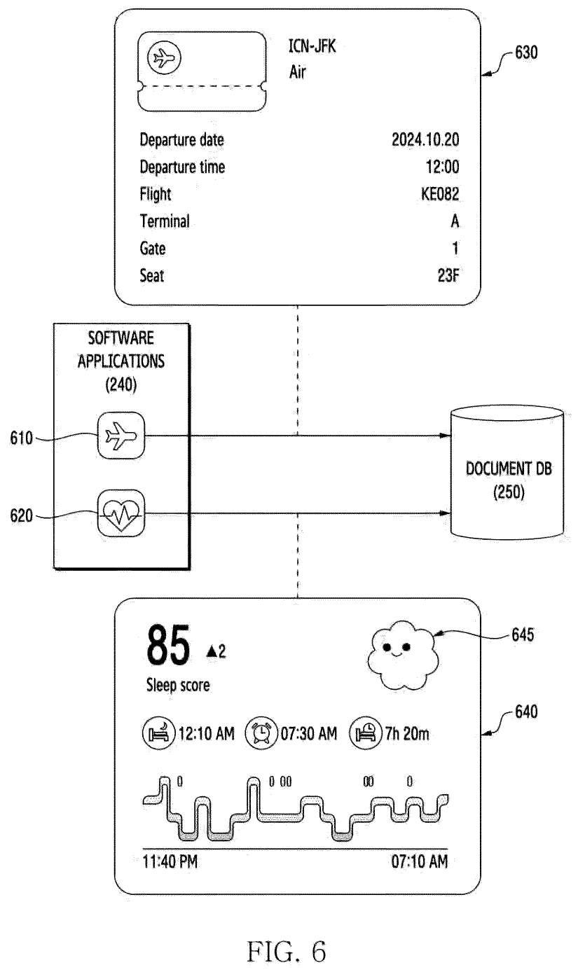

Referring to FIG. 4A, in operation 410, the electronic device according to an embodiment may identify a plurality of messages. The plurality of messages of the operation 410 may include contents generated based on execution of software applications. The plurality of messages of the operation 410 may include a content generated based on execution of the smart suggestion application 260 and/or the document generator 278 of FIG. 2. The plurality of messages of the operation 410 may be stored in the document DB 250 of FIG. 2. Examples of the plurality of messages of the operation 410 are described in greater detail below with reference to FIG. 6.

Referring to FIG. 4A, in operation 420, the electronic device according to an embodiment may determine ranks respectively corresponding to the plurality of messages. The ranks may determine or obtain the ranks of the operation 420 using a time of the electronic device, a location, an SOC of a battery of the electronic device, or schedule information stored in the memory. The operation 420 may include an operation performed based on execution of the rank determiner 274 of FIG. 3B.

Referring to FIG. 4A, in operation 430, the electronic device according to an embodiment may obtain a text representing summarization with respect to at least one of the plurality of messages, using the determined ranks. For example, the electronic device may obtain or generate a text representing summarization of at least one of the messages of the operation 410, using the ranks determined based on the operation 420. For example, the electronic device may obtain a prompt (e.g., a prompt included in Table 3) including the messages arranged according to the ranks. By executing a model (e.g., the language model 255 of FIG. 2) trained using the prompt, the electronic device may obtain the text of the operation 430.

Referring to FIG. 4A, in operation 440, the electronic device according to an embodiment may generate information for displaying a screen including visual objects respectively including the plurality of messages and texts. For example, the electronic device may generate layout information for an execution screen (e.g., the briefing screen displayed in the state 194 of FIG. 1) including the text obtained based on the operation 430 and the visual objects. The layout information may be generated using the ranks determined based on the operation 420. For example, an order of the visual objects in the execution screen may correspond to an order of ranks of the messages corresponding to the visual objects (e.g., in a descending order).

Referring to FIG. 4A, in operation 450, the electronic device according to an embodiment may display a screen based on the generated information. For example, the electronic device may display visual objects respectively including the messages arranged according to the ranks determined based on the operation 420, together with the text obtained based on the operation 430. While displaying the screen of the operation 450, the electronic device may receive a user input associated with one of visual objects included in the screen. Based on the user input, the electronic device may display a screen provided by a software application corresponding to the visual object associated with the user input.

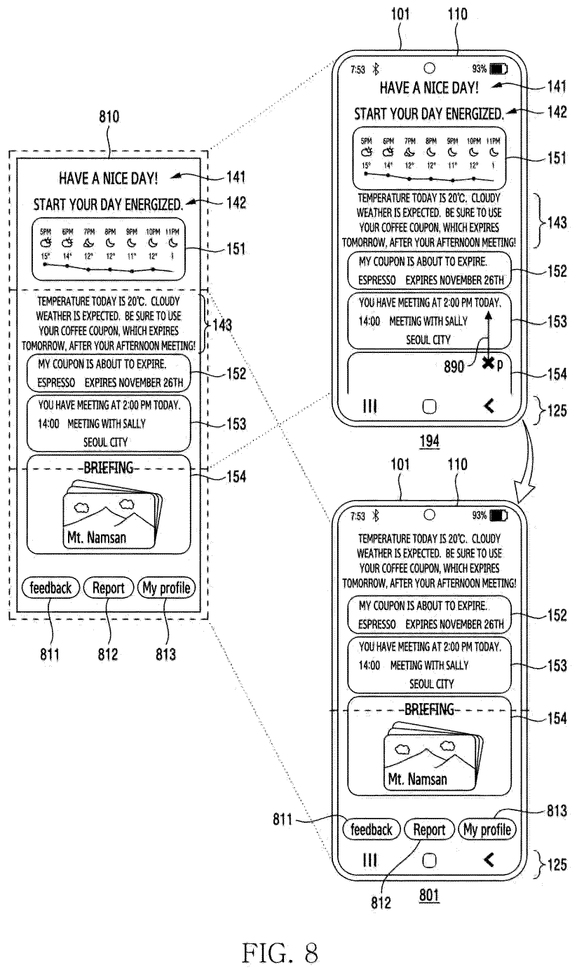

The screen of the operation 450 may be directly displayed based on generating the information of the operation 440. The disclosure is not limited thereto, and the electronic device may display a widget object and/or an icon (e.g., the icon 131 of FIG. 1) related to the screen of the operation 450, such as the widget objects 111 and 121 of FIG. 1. Based on a user input associated with the widget object and/or the icon, the electronic device may display the screen of the operation 450 through a display (e.g., the display 110 of FIG. 1 and/or FIG. 2). The briefing screen displayed in the state 194 of FIG. 1 and/or a briefing screen described with reference to FIG. 8 may be an example of the screen of the operation 450.

Referring to FIG. 4B, in operation 461, the electronic device according to an embodiment may identify first information of a first application and second information of a second application obtained during a predetermined period. The electronic device may perform the operation 461 of FIG. 4B, based on determining that time information of the electronic device corresponds to a predetermined time. For example, the electronic device may identify information generated within the predetermined period by various applications installed in the electronic device. Each of the first information and the second information may be obtained during the predetermined period corresponding to the time information. The predetermined time may be a time (e.g., a time between 18:00 and 20:00 and/or a time between 21:00 and 23:00) reserved by the update scheduler 327 of FIG. 3B. When the time information of the electronic device corresponds to the predetermined time, the electronic device may perform the operations of FIG. 4B using a dedicated process and/or a dedicated thread. The disclosure is not limited thereto, and the electronic device may perform at least one of the operations of FIG. 4B before (in advance) the predetermined time.

Referring to FIG. 4B, in operation 463, the electronic device according to an embodiment may generate a first content including a first image and a first text using the first information, and a second content including a second image and a second text using the second information. For example, the electronic device may generate or obtain the first content and the second content, using a trained model (e.g., the language model 255 of FIG. 2). When the electronic device obtains information from various applications based on the operation 461, the electronic device may perform the operation 463 using information corresponding to each of the applications, and obtain contents corresponding to each of the applications. Although an embodiment in which the electronic device obtains the first image together with the first text using the first information is described, the disclosure is not limited thereto, and the electronic device may obtain or generate information (e.g., video) different from the first image.

Referring to FIG. 4B, in operation 465, the electronic device according to an embodiment may determine ranks of the first content and the second content generated based on the operation 463. For example, the electronic device may determine ranks of the first content and the second content based on time information of the electronic device. For example, the electronic device may determine the ranks of the operation 465, using a state and/or a context of the user estimated by the time information.

Referring to FIG. 4B, in operation 467, the electronic device according to an embodiment may concurrently display the first content and the second content through a touchscreen display (e.g., the display 110 of FIG. 1), based on the rank of the operation 465. For example, the electronic device may display the first content and the second content side-by-side or sequentially within a screen displayed through the display.

Referring to FIGS. 4C, 4D, 4E and 4F, timing diagrams 471, 472, 473, and 474 indicating an example content generated by the electronic device performing the operation of FIG. 4A and/or FIG. 4B are illustrated. In the timing diagrams 471, 472, 473, and 474, midnight may indicate a time section from 12 a.m. to 6 a.m., early morning may indicate a time section from 6 a.m. to 8 a.m., morning may indicate a time section from 8 a.m. to 10 a.m., late morning may indicate a time section from 10 a.m. to 12 p.m., lunch may indicate a time section from 12 p.m. to 2 p.m., afternoon may indicate a time section from 2 p.m. to 6 p.m., evening may indicate a time section from 6 p.m. to 10 p.m., and night may indicate a time section from 10 p.m. to 12 a.m.

Referring to the timing diagram 471 of FIG. 4C, the electronic device may provide summarization of contents referred to as a morning brief in early morning. The electronic device may provide summarization of contents referred to as an evening brief in evening. In a time section between early morning and evening, the electronic device may add a current weather to the summarization of contents referred to as the morning brief. The electronic device may display a content associated with a news content, a playlist, a main schedule (e.g., a schedule including a moving time such as time to leave), a coupon (e.g., coupon one to three days before expiration), a story recommendation, a safe walking message, and/or a missed call, in corresponding time sections illustrated in the timing diagram 471. The electronic device may display a content associated with energy saving, repetitive performing actions, daily activity, and a train/bus ticket in corresponding time sections illustrated in the timing diagram 471, according to a display condition of the contents.

Referring to the timing diagram 472 of FIG. 4D, the electronic device may provide contents based on schedule information. For example, in a time section between early morning and evening, the electronic device may display a content for transmitting a birthday card to a user of a specific birthday and/or for providing a birthday gift. The electronic device may display a content including a notification associated with an anniversary within one week in a time section between early morning and late morning. The electronic device may display a content associated with an emergency weather alert (e.g., short-term rainfall), a reminder set as repetitive alerts, and/or a sports game, according to a display condition. A content associated with weather may be displayed based on a context (e.g., weather and/or going to work) identified by the electronic device.

Referring to the timing diagram 473 of FIG. 4E, the electronic device may display a content associated with health information such as drinking water, within a time section between early morning and late morning. The electronic device may display a content for recommending a content (e.g., a content of a video streaming service) within a time section between early morning and evening. The electronic device may display a content for recommending a call (e.g., making a call to a specific user) within a time section between lunch and evening. The electronic device may display a content associated with providing tip, blood pressure result, weight result, medication check, repetitive alert, and/or sports game according to a display condition. The timing diagram 473 may indicate a content generated and/or displayed in an electronic device (e.g., the HMD device 293 of FIG. 2) for providing mixed reality.

Referring to the timing diagram 474 of FIG. 4F, when identifying a travel schedule, the electronic device may display a content for preparing the travel schedule (e.g., suggestion of setting Find My Device, location sharing recommendation, travel preparation content, and/or departure alarm setting) on a date one to three days before the travel schedule. The electronic device may provide a content associated with a boarding pass, a travel preparation content, a useful app recommendation, a language pack recommendation, airport arrival TTL, and/or local weather, on a date when the travel schedule starts (e.g., D-day). The electronic device may provide a content associated with a current location weather, a travel preparation content, exchange rate information, a language pack, a charging recommendation (e.g., wearable device and/or electronic device), and/or recommended place information during the travel schedule.

Time sections of FIGS. 4C, 4D, 4E and 4F are examples and may be changed according to various embodiments. An order of contents output by the electronic device and/or texts included in the contents may be displayed differently according to a user, based on personalized information, and are not limited to the timing diagrams 471, 472, 473, and 474 of FIGS. 4C, 4D, 4E and 4F.

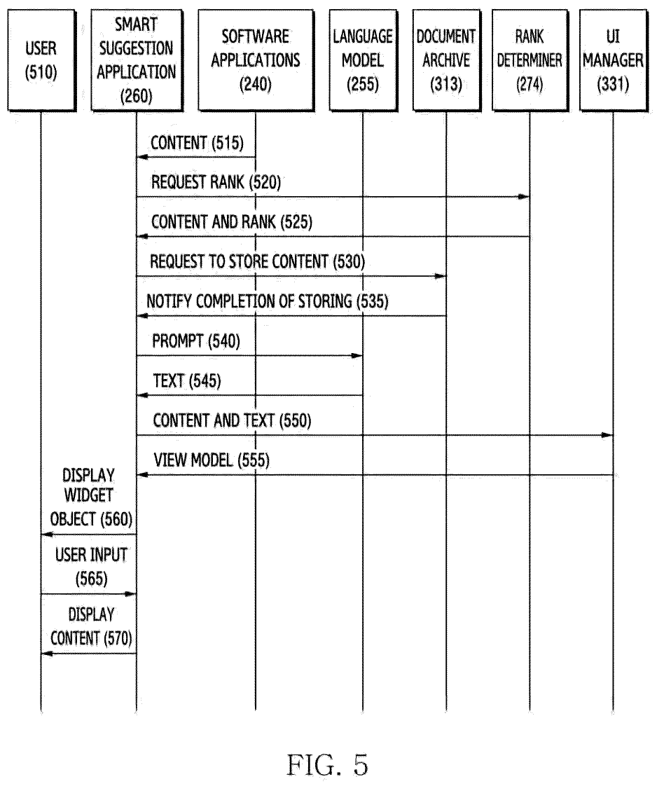

Hereinafter, referring to FIG. 5, information exchanged to perform the operations of FIG. 4A and/or FIG. 4B will be described in greater detail in terms of programs executed by the electronic device.

FIG. 5 is a signal flow diagram illustrating example operations of an electronic device according to various embodiments. The electronic device 101 of FIGS. 1 to 2 and/or the processor 210 of FIG. 2 may perform operations described with reference to FIG. 5. The operation of the electronic device described with reference to FIG. 5 may be associated with the operations described with reference to FIGS. 3A to 3D, FIG. 4A, and/or FIG. 4B.

Referring to FIG. 5, the electronic device executing the smart suggestion application 260 may obtain or collect a content 515 from the software applications 240. The content 515 may be contents stored in the document DB 250 of FIG. 2. The electronic device may obtain the content 515 based on requesting the content 515 from the software applications 240 and/or identifying that the content 515 is stored in the document DB. The content 515 may include information managed by a software application generating the content 515. For example, a content generated based on execution of a calendar application (e.g., the calendar application 241 of FIG. 2) may include information on a schedule. For example, a content generated based on execution of a messenger application (e.g., the messenger application 242 of FIG. 2) may include at least one unread message. For example, a content generated based on execution of a weather application (e.g., the weather application 243 of FIG. 2) may include information associated with weather. The content 515 may include information for displaying a visual object such as the card objects 151, 152, 153, and 154 of FIG. 1. The content 515 may have attributes and/or a data structure described based on Table 1. Document objects 630 and 640 described with reference to FIG. 6 may be an example of the content 515 of FIG. 5.

Referring to FIG. 5, the electronic device executing the smart suggestion application 260 may request to determine a rank of the content 515 by executing the rank determiner 274 (in operation 520). Based on execution of the rank determiner 274, the electronic device may determine or obtain the rank of the content 515 by performing the operations described with reference to FIG. 3B. By executing the rank determiner 274, the electronic device may identify contents arranged according to ranks (or rank scores of Equation 1) (in operation 525). The contents arranged according to the ranks may be stored in the document archive 313 of the smart suggestion application 260 (in operation 530). Based on a notification 535 of the document archive 313, the electronic device may identify that the contents are stored in the document archive 313.

Referring to FIG. 5, the electronic device executing the smart suggestion application 260 may input a prompt 540 (e.g., the example prompt of Table 3) to the language model 255. The prompt 540 may include information identified by the electronic device, such as the content 515 and/or weather, for example, “Generate a departure guide message including a route to a meeting place ABC building at 3 μm. The current weather is sunny, 25° C.”. A text 545 obtained from the language model 255 may include a natural language sentence(s) (e.g., “To depart for the meeting at 3 p.m., please leave in 30 minutes. The current weather is sunny, and the expected arrival time is 2:50 p.m.”) based on the prompt 540.

Referring to FIG. 5, the electronic device executing the smart suggestion application 260 may execute a UI manager 331, using the text 545 and a content (in operation 550). By executing the UI manager 331, the electronic device may generate a view model 555 for displaying a briefing screen and/or a widget object (e.g., the widget objects 111 and 121 of FIG. 1). Based on the view model 555, the electronic device may display a widget object (e.g., in operation 560) or may display the content 515 (e.g., in operation 570). The content 515 may be displayed in response to a user input 565 for displaying a briefing screen. The electronic device performing the operation 570 may display, together with the content 515, an insight message (e.g., the text 545) associated with the content 515.

FIG. 6 is a diagram illustrating an example of a document object generated based on execution of a software application of an electronic device according to various embodiments. The electronic device 101 of FIGS. 1 to 2 and/or the processor 210 of FIG. 2 may perform operations described with reference to FIG. 6. The operation of the electronic device described with reference to FIG. 6 may be associated with the smart suggestion application 260 described with reference to FIGS. 3A to 3D and/or the operation 410 of FIG. 4A.

Referring to FIG. 6, document objects 630 and 640 generated in each of a reservation application 610 and/or a health application 620, which are an example of the software applications 240, are illustrated. Based on execution of the reservation application 610, the electronic device may generate a document object 630 representing reservation information managed by the reservation application 610. The electronic device may store or register the generated document object 630 in the document DB 250. For example, the electronic device may store information for visualizing the document object 630 in the document DB 250, based on the data structure described with reference to Table 1. Similarly, based on execution of the health application 620, the electronic device may generate a document object 640 including health information. The document object 640 may include a graphical object for enhancing user experience, such as an icon 645, together with texts and/or a graph indicating health information. Information for displaying the document object 640 may be stored in the document DB 250.

The document objects 630 and 640 stored in the document DB 250 may be maintained in the document DB 250 for a predetermined period (e.g., 24 hours). For example, a life cycle of the document objects 630 and 640 may be 24 hours or less. The disclosure is not limited thereto, and the document objects 630 and 640 may be maintained in the document DB 250 for a time exceeding the predetermined period. Using the document objects 630 and 640 stored in the document DB 250, the electronic device may display a briefing screen and/or a widget object.

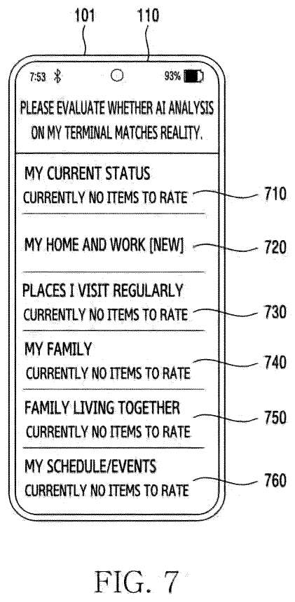

FIG. 7 is a diagram illustrating an example screen displayed by the electronic device 101 to obtain context information associated with a user, according to various embodiments. Referring to FIG. 7, an example screen displayed by the electronic device 101 of FIGS. 1 to 2 is illustrated. Through the display 110, the electronic device 101 may display a screen of FIG. 7 to obtain personalized data (e.g., the personalized data 265 of FIG. 2 and/or context information of the context engine 280).

Referring to FIG. 7, a screen displayed through the display 110 may include visual objects 710, 720, 730, 740, 750, and 760 for obtaining personalized data. A visual object 710 may be displayed to receive information on a current state of a user of the electronic device 101. A visual object 720 may be displayed to receive a place (e.g., a home and/or a workplace) where the user of the electronic device 101 frequently stays. A visual object 730 may be displayed to receive a place (e.g., another place different from the home and/or the workplace) periodically visited by the user of the electronic device 101. A visual object 740 may be displayed to check family of the user of the electronic device 101. A visual object 750 may be displayed to identify another user living with the user of the electronic device 101. A visual object 760 may be displayed to check a schedule and/or an event of the user of the electronic device 101.

While displaying a screen including the visual objects 710, 720, 730, 740, 750, and 760, the electronic device 101 may obtain personalized data from the user. The personalized data 265 of FIG. 2 may include data obtained through the screen of FIG. 7. Using the personalized data, the electronic device 101 may determine or obtain ranks of contents generated by software applications (e.g., the software applications 240 of FIG. 2) of the electronic device 101.

FIG. 8 is a diagram illustrating an example briefing screen displayed by the electronic device 101 according to various embodiments. The electronic device 101 of FIGS. 1 to 2 and/or the processor 210 of FIG. 2 may perform operations of the electronic device 101 described with reference to FIG. 8. The operation of the electronic device 101 described with reference to FIG. 8 may be associated with the operation 450 of FIG. 4A and/or the operation 570 of FIG. 5.

Referring to FIG. 8, example states 194 and 801 of the electronic device 101 displaying a briefing screen are illustrated. The briefing screen may include at least a portion of a UI 810 in which card objects 151, 152, 153, and 154 and texts 141, 142, and 143 are arranged. Information indicating a layout of the UI 810 may be generated based on operations described with reference to FIGS. 1 to 5. For example, an order of the card objects 151, 152, 153, and 154 in the UI 810 may be associated with ranks of contents respectively corresponding to the card objects 151, 152, 153, and 154. For example, the texts 141, 142, and 143 may be generated or obtained from a language model (e.g., the language model 255 of FIG. 2) receiving at least one of the contents. For example, the ranks may be determined based on a current time of the electronic device 101. For example, in the UI 810 generated in morning time, a card object 151 corresponding to a content provided from a weather application may be located above other card objects 152, 153, and 154.

Referring to FIG. 8, in the state 194, the electronic device 101 may display texts 141, 142, and 143 and card objects 151, 152, and 153 adjacent to an upper end of the UI 810 through the electronic device 101. The state 194 may be a state in which a briefing screen is initially displayed according to a user input. In the state 194, the electronic device 101 may identify a scroll input (e.g., a drag gesture and/or a swipe gesture) starting from a point p of the display 110 and performed along a direction 890 substantially parallel to a vertical direction of the display 110. Based on the scroll input, the electronic device 101 may change a portion of the UI 810 displayed through the display 110. The state 801 of FIG. 8 may be a state of the electronic device 101 after receiving the scroll input. Although the direction 890 toward an upper direction of the display 110 is illustrated, a direction of the scroll input is not limited thereto. For example, based on the scroll input performed along a lower direction of the display 110, the electronic device 101 may change a portion of the UI 810 displayed through the display 110.

In the state 801 of FIG. 8, the electronic device 101 may display visual objects 152, 153, and 154 adjacent to a lower end of the UI 810. Together with the visual objects 152, 153, and 154, the electronic device 101 may display UI objects 811, 812, and 813 respectively corresponding to functions associated with the briefing screen. A UI object 811 may be displayed to receive feedback on contents included in the briefing screen. For example, based on a user input associated with the UI object 811, the electronic device 101 may display a screen (e.g., a screen displayed in a state 1002) of FIG. 10. A UI object 812 may be displayed to receive feedback on the briefing screen. A UI object 813 may be displayed to obtain personalized data used to determine ranks of the contents used to display the briefing screen. For example, based on a user input associated with the UI object 813, the electronic device 101 may display the screen of FIG. 7.

FIG. 9 is a diagram illustrating an example operation of an electronic device displaying a widget object 911 connected to a briefing screen through a lock screen according to various embodiments. The electronic device 101 of FIGS. 1 to 2 and/or the processor 210 of FIG. 2 may perform operations described with reference to FIG. 9. The operation of the electronic device 101 described with reference to FIG. 9 may be associated with the operation 450 of FIG. 4A and/or the operations 560 and 570 of FIG. 5.

Referring to FIG. 9, an example state 901 of the electronic device 101 displaying a lock screen is illustrated. The electronic device 101 obtaining a text 143 representing summarization of contents may display a widget object 911 including a text (e.g., “Have a good day.”) having a shorter length than the text 143 on a lock screen. The text displayed in the widget object 911 may represent summarization of the text 143. In the state 901, based on a user input associated with the widget object 911, the electronic device 101 may display a briefing screen including the text 143 through the display 110, as in the state 194. Based on the user input, the electronic device 101 may perform user authentication. Based on the user authentication, the electronic device 101 may display or output the briefing screen through the display 110, as in the state 194. The disclosure is not limited thereto, and the electronic device 101 may switch to the state 194 without the authentication, based on a user input associated with the widget object 111.

The widget object 911 may include a text determined based on execution of the smart suggestion application 260 of FIG. 2. For example, in morning time, as in the state 901, the widget object 911 including a greeting (e.g., “Have a good day.”) based on the morning time may be displayed on a lock screen. For example, in afternoon time, the electronic device 101 may display a widget object 912 including a text (e.g., “good afternoon”) based on the afternoon time in the lock screen. For example, in evening time, the electronic device 101 may display a widget object 913 including a greeting (e.g., “good evening.”) associated with the evening time in the lock screen. For example, in night time, the electronic device 101 may display a widget object 914 including a greeting (e.g., “Sweet dreams.”) corresponding to the night time in the lock screen.

A text included in the widget object 911 may include not only a greeting based on a current time but also a text representing summarization of contents displayed through a briefing screen. For example, when a text including a description of a coupon expiring today, such as the text 143, is generated, the electronic device 101 may display a suggestion (e.g., “Use the coupon within today.”) associated with the description through the widget object 911. Using the text displayed through the widget object 911, the electronic device 101 may output information to be preferentially provided through the briefing screen to a user of the electronic device 101 before displaying the briefing screen.

FIG. 10 is a diagram illustrating example states of the electronic device 101 for obtaining feedback data on contents included in a briefing screen according to various embodiments. The electronic device 101 of FIGS. 1 to 2 and/or the processor 210 of FIG. 2 may perform operations described with reference to FIG. 10. The operation of the electronic device 101 described with reference to FIG. 10 may be associated with the operation 450 of FIG. 4A and/or the operation 570 of FIG. 5.

Referring to FIG. 10, an example state 801 of the electronic device 101 displaying a briefing screen is illustrated. In the state 801 of FIG. 10, the electronic device 101 may receive a user input associated with a UI object 811. A state 1002 of FIG. 10 may be an example state of the electronic device 101 displaying a screen based on the user input.

Referring to the state 1002 of FIG. 10, the electronic device 101 may display a portion of a UI 1010. The UI 1010 may include, together with card objects 151, 152, 153, and 154 respectively corresponding to contents obtained from software applications (e.g., the software applications 240 of FIG. 2), UI objects 1011, 1012, 1021, 1022, 1031, 1032, 1041, and 1042 for obtaining feedback on the contents. For example, the UI objects 1011 and 1012 may be displayed to obtain feedback (e.g., positive feedback and/or negative feedback) on the card object 151. For example, the UI objects 1021 and 1022 may include buttons (e.g., a like button and/or a dislike button) for obtaining feedback on a content associated with the card object 152. For example, the UI objects 1031 and 1032 may be displayed to obtain feedback on a content corresponding to the card object 153. For example, the UI objects 1041 and 1042 disposed at a location related to the card object 154 may be displayed to receive feedback on a content included in the card object 154.

Referring to the UI 1010 of FIG. 10, a visual object 1050 for receiving feedback on a briefing screen may be included in the UI 1010. The visual object 1050 may include UI objects 1051 for obtaining an evaluation of the briefing screen and/or a text box 1052 for receiving a text on the briefing screen. The visual object 1050 may include a UI object 1053 for completing feedback based on the UI 1010 and/or a UI object 1054 for canceling feedback based on the UI 1010.

Referring to FIG. 10, in the state 1002 displaying at least a portion of the UI 1010, the electronic device 101 may obtain feedback on the briefing screen. In response to a user input associated with the UI object 1053, the electronic device 101 may store data indicating feedback obtained from the user in the state 1002. The data may be stored in the feedback DB 276 of FIG. 2. The data may include at least one of a generation time of a content corresponding to the data, a type, a score of the user, a keyword (e.g., a keyword included in at least one selected by the user among the UI objects 1051), and a text input through the text box 1052. The data may be stored in the feedback DB 276 of FIG. 2, or may be transmitted to a server connected to the electronic device 101.

Feedback obtained through the state 1002 and/or the UI 1010 may be used to determine and/or adjust ranks of contents. For example, when determining ranks based on the operation 420 of FIG. 4A and/or the operation 525 of FIG. 5, the electronic device 101 may identify the feedback.

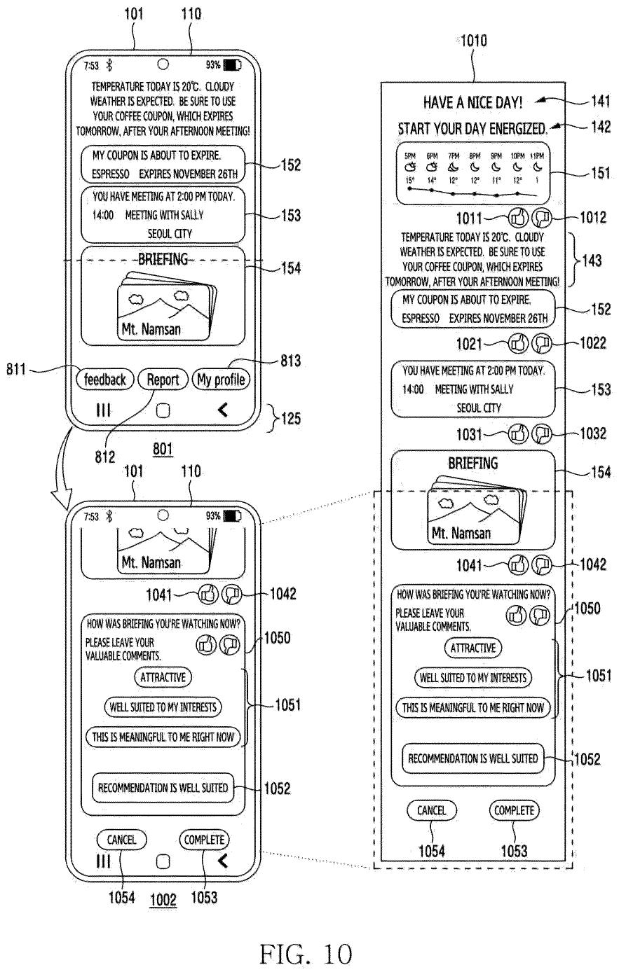

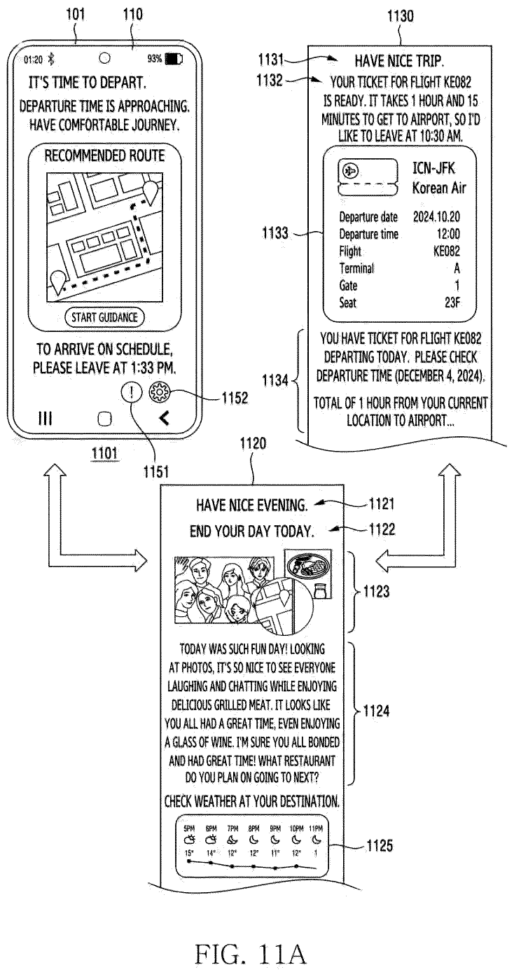

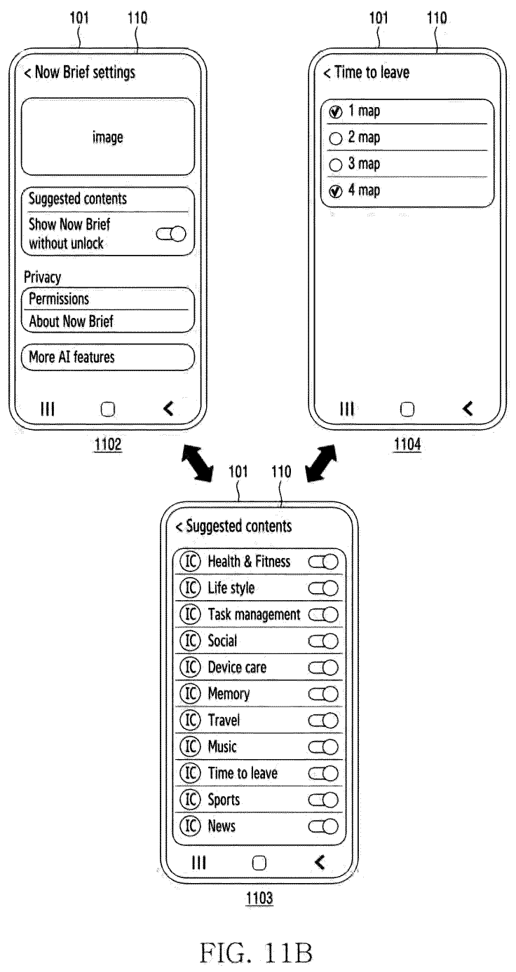

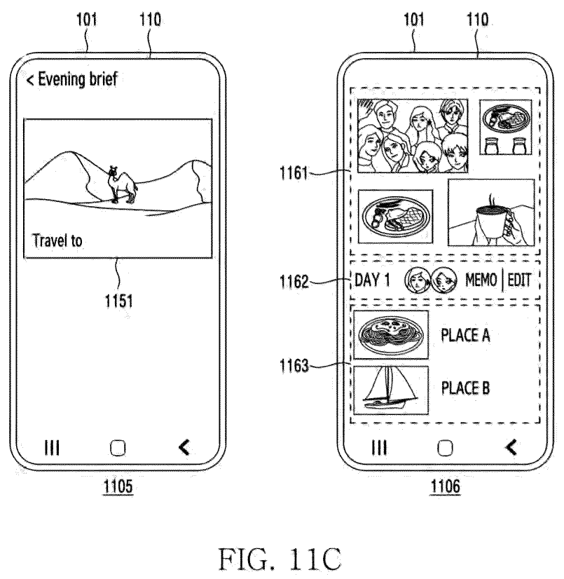

FIGS. 11A, 11B, and 11C are diagrams illustrating example states of a briefing screen displayed by an electronic device according to various embodiments. The electronic device 101 and/or the processor 210 of FIGS. 1 to 2 may perform operations described with reference to FIGS. 11A to 11C. The operations of the electronic device 101 described with reference to FIGS. 11A to 11C may be associated with the operation 450 of FIG. 4A and/or the operation 570 of FIG. 5.

Referring to FIG. 11A, a state 1101 of the electronic device 101 displaying an example briefing screen is illustrated. For example, the electronic device 101 identifying a content (e.g., information generated based on execution of the calendar application 241 of FIG. 2) notifying a schedule at a specific place may determine a rank of the content as a higher rank than ranks of other contents. Using the rank, the electronic device 101 may display a briefing screen including a text (e.g., “It is time to leave.”) representing summarization of the content.

The contents displayed through the briefing screen may be changed. After the state 1101, in the evening time, the electronic device 101 may generate a UI 1120 using contents (e.g., contents stored in the document DB 250 of FIG. 2) generated until the evening time. The UI 1120 may include texts 1121, 1122, and 1124 representing summarization of the contents, and card objects 1123 and 1125 respectively corresponding to the contents. An order of the card objects 1123 and 1125 in the UI 1120 may correspond to a descending order of ranks of the contents, determined based on a current time (e.g., evening time) of the electronic device 101 and/or context information of the electronic device 101. The UI 1120 may be displayed through the display 110 as at least a portion of the briefing screen. The UI 1120 may include a content associated with a travel schedule described with reference to FIG. 11C.

Referring to FIG. 11A, the electronic device 101 identifying a content associated with a travel schedule may determine a rank of the content by comparing time information of the content and a current time of the electronic device 101. For example, the electronic device 101 determining a rank of the content as a higher rank than ranks of other contents may generate a UI 1130 including a card object 1133 corresponding to the content and texts 1131, 1132, and 1134 representing summarization of the content. The UI 1130 may be displayed through the display 110 as at least a portion of the briefing screen.

Referring to FIG. 11A, the electronic device 101 may display at least one of UI objects 1151 and 1152 in the briefing screen. A UI object 1151 including an exclamation mark-shaped icon may be displayed to notify that at least a portion of the briefing screen (e.g., summarization of a content(s) provided through the briefing screen) has been generated using an artificial intelligence model. For example, in response to an input indicating a selection of the UI object 1151, the electronic device 101 may display, by overlapping the briefing screen, a pop-up window notifying that the briefing screen includes a content based on the artificial intelligence model.

Referring to FIG. 11A, a UI object 1152 including a gear-shaped icon may be displayed to change (or customize) a setting value associated with the briefing screen. For example, in response to an input indicating a selection of the UI object 1152, the electronic device 101 may display a screen for changing the setting value(s), as in a state 1102 of FIG. 11B. A screen displayed in the state 1102 of FIG. 11B may be displayed by another input (e.g., an input received through a setting application) different from the input associated with the UI object 1152.

Referring to FIG. 11B, a screen displayed in the state 1102 may be displayed to receive setting values associated with a condition for displaying a briefing screen (e.g., whether to display the briefing screen without unlock) and a permission(s) associated with the briefing screen. The screen displayed in the state 1102 may include an item (e.g., “Suggest contents”) for selecting a content(s) to be displayed through the briefing screen. In response to an input indicating a selection of the item, the electronic device 101 may display a screen displayed in a state 1103 of FIG. 111B. In the state 1103 of FIG. 11B, the electronic device 101 may include items corresponding to each of software applications installed in the electronic device 101, and an UI object (e.g., radio button and/or switch) for selecting whether to display a content generated by each software application on the briefing screen. In the state 1103, in response to an input selecting a specific item (e.g., time to leave), the electronic device 101 may display a screen for selecting a detailed option of the specific item by switching to a state 1104. For example, in the state 1104, the electronic device 101 may display, among software applications (e.g., four map applications) capable of generating a content associated with the specific item, a screen for selecting a software application allowed to generate the content.

Referring to FIG. 11C, a state 1105 of the electronic device 101 displaying a content associated with a travel schedule through the briefing screen is illustrated. The content may be included in the UI 1120 of FIG. 11A. The electronic device 101 may display a content including images and/or videos associated with the travel schedule in the evening (e.g., an evening time section described with reference to FIGS. 4C to 4F). For example, in the state 1105, the electronic device 101 may display a content including an image 1151 associated with the travel schedule together with other contents. The disclosure is not limited thereto, and the electronic device 101 may generate or display a content including summarization of images and/or videos obtained during the travel schedule, on a last day of the travel schedule.

Referring to FIG. 11C, the image 1151 displayed in the state 1105 may correspond to a best image among images and/or videos obtained during the travel schedule. The best image may be determined by a selection of a user and/or an artificial intelligence model with respect to the images and/or the videos. Together with the image 1151, the electronic device 101 may display the image 1151 and/or a text associated with the travel schedule. In the state 1105, based on an input indicating a selection of the image 1151 and/or a content including the image 1151, the electronic device 101 may switch to a state 1106 of FIG. 11C.

In the state 1106 of FIG. 11C, the electronic device 101 may provide a detailed view of images and/or videos associated with the travel schedule. In the state 1106 of FIG. 11C, the electronic device 101 may list images and/or videos in a region 1161 of the detailed view. The electronic device 101 may display, in a region 1162, time information (e.g., a text indicating that the images and/or the videos were obtained on a first day of the travel schedule) on the images and/or the videos displayed in the region 1161, and/or an icon(s) indicating a person(s) identified through the images and/or the videos.

In the state 1106 of FIG. 11C, the electronic device 101 may display information on a place visited during the travel schedule and/or a surrounding place of the place in a region 1163 of the detailed view. An order of regions 1161, 1162, and 1163 is not limited to the example state 1106 of FIG. 11C. The electronic device 101 may (further) display, through a display 110, not only information included in the regions 1161, 1162, and 1163, but also other information such as a tomorrow schedule.

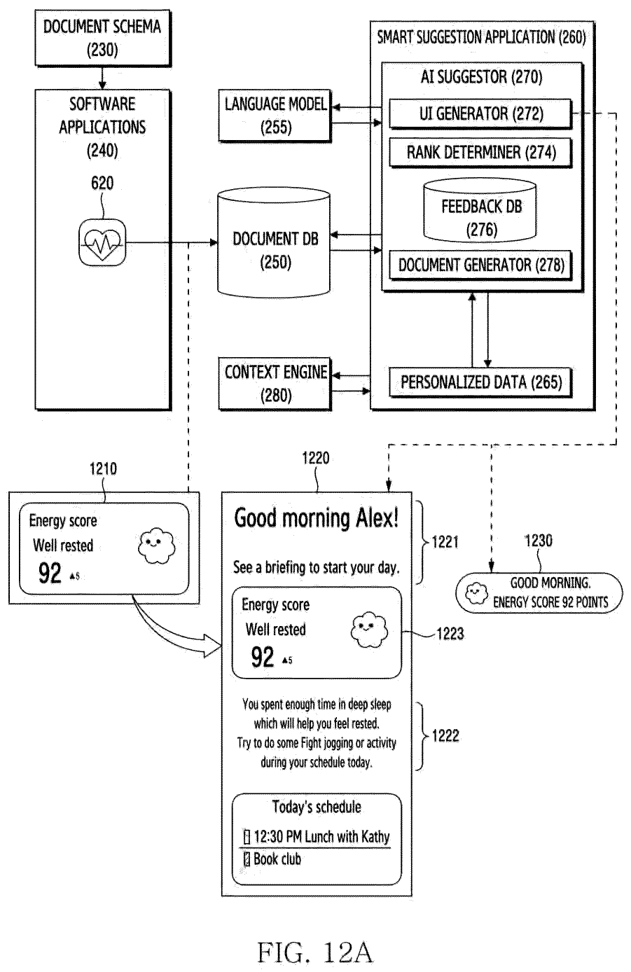

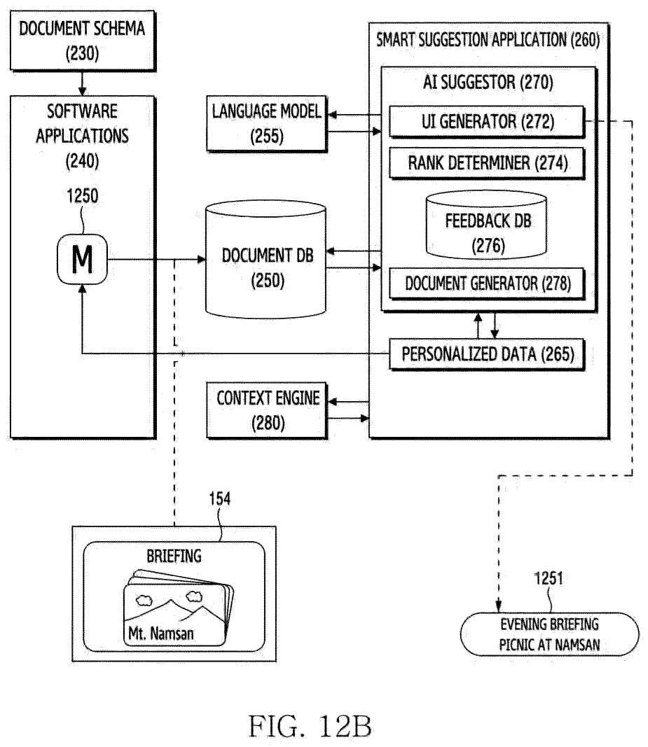

FIGS. 12A and 12B are diagrams illustrating example operations of an electronic device generating a layout of a content (e.g., a card object 1223) and/or a widget object 1230 to be displayed on a briefing screen using a document object provided by a software application according to various embodiments. The electronic device 101 and/or the processor 210 of FIGS. 1 to 2 may perform operations of the electronic device described with reference to FIGS. 12A and/or 12B. The operations of the electronic device described with reference to FIGS. 12A and/or 12B may be associated with the operation 450 of FIG. 4A and/or the operation 570 of FIG. 5.

Referring to FIG. 12A, an example state of an electronic device generating a document object 1210 based on execution of a health application 620 is illustrated. The electronic device identifying the document object 1210 through the document DB 250 may generate a UI 1220 including a card object 1223 corresponding to the document object 1210, based on execution of the smart suggestion application 260. The electronic device may generate the UI 1220 including a text 1222 representing summarization of the document object 1210. Although the UI 1220 in which the text 1222 is disposed below the card object 1223 is illustrated, the disclosure is not limited thereto. The electronic device 101 may display the card object 1223 maintaining a layout of the document object 1210. The disclosure is not limited thereto, and a layout of the card object 1223 may be different from the layout of the document object 1210 according to a resolution of the UI 1220, a size, and/or a visual effect applied to the card object 1223. Together with the text 1222, the electronic device may add, to the UI 1220, a text 1221 representing a greeting based on contents in the document DB 250 including the document object 1210 and/or a time. The UI 1220 may be displayed through the briefing screen.

Referring to FIG. 12A, the electronic device identifying the document object 1210 may identify a text (e.g., “Good morning. Energy score 92 points”) based on the document object 1210. The electronic device may display the identified text through a widget object 1230. The widget object 1230 may be displayed through a lock screen (e.g., Now bar) and/or at least a portion of a home screen. A text disposed in the widget object 1230 may have a shorter length than texts 1221 and 1222 displayed through the UI 1220.

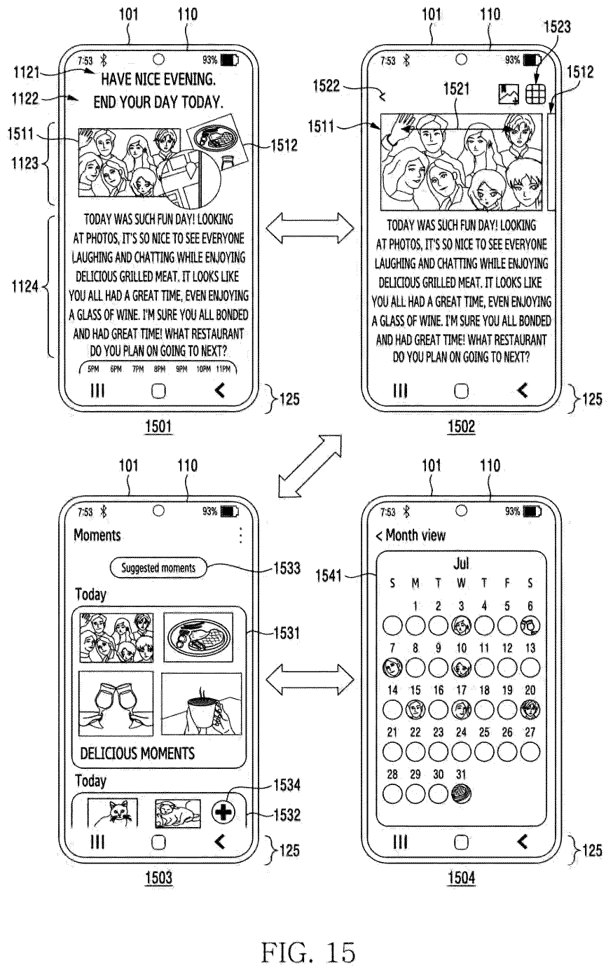

Referring to FIG. 12B, an example state of an electronic device identifying a content (e.g., the briefing object 154) based on execution of a moments application 1250 is illustrated. The moments application 1250 may be configured to perform operations described in greater detail below with reference to FIGS. 15 to 26. Although an example embodiment in which the moments application 1250 is installed independently of the smart suggestion application 260 is illustrated, the disclosure is not limited thereto. For example, the moments application 1250 may be included in the smart suggestion application 260. The electronic device identifying that the briefing object 154 is stored in the document DB 250 may perform calculations defined by the language model 255 by executing the smart suggestion application 260. By performing the calculations, the electronic device may obtain ranks with respect to contents of the document DB 250 including the briefing object 154, or may obtain a text (e.g., “Evening briefing, picnic at Namsan”) representing summarization of the contents. The electronic device may display a widget object 1251 including the text. The briefing object 154 may be displayed through a display as at least a portion of the briefing screen.

Hereinafter, example layouts of a briefing screen according to a form factor of an electronic device will be described in greater detail below with reference to FIGS. 13A, 13B, and/or 14.

FIGS. 13A and 13B are diagrams illustrating example states of a multi-foldable electronic device 1300 displaying a briefing screen according to various embodiments. The electronic device 101 of FIG. 2 may include the multi-foldable electronic device 1300 described with reference to FIGS. 13A and/or 13B. The multi-foldable electronic device 1300 described with reference to FIGS. 13A and/or 13B may perform operations of the electronic device described with reference to FIGS. 1 to 12.

Referring to FIGS. 13A and/or 13B, the multi-foldable electronic device 1300 may include housing parts 1311, 1312, and 1313 connected through rotatable hinge assemblies. A first housing part 1311 may be rotatably coupled to a second housing part 1312. The second housing part 1312 may be rotatably coupled to a third housing part 1313. The multi-foldable electronic device 1300 may include a flexible display 1309 extending from the first housing part 1311 across the second housing part 1312 to the third housing part 1313. A state of the multi-foldable electronic device 1300 may be classified by folding and/or unfolding of the housing parts 1311, 1312, and 1313.

Referring to FIG. 13A, a state 1301 included in a folded state (or fully folded state) of the multi-fold electronic device 1300 is illustrated. In the folded state, a rear surface (e.g., a surface of the first housing part 1311 opposite to a front surface on which the flexible display 1309 is disposed) of the first housing part 1311 may face a front surface (e.g., a surface of the third housing part 1313 on which the flexible display 1309 is disposed) of the third housing part 1313. In the folded state, a rear surface (e.g., a surface of the second housing part 1312 opposite to a front surface on which the flexible display 1309 is disposed) of the second housing part 1312 may face a rear surface (e.g., a surface of the third housing part 1313 opposite to a front surface on which the flexible display 1309 is disposed) of the third housing part 1313.

In the example state 1301 of FIG. 13A, a first portion of a flexible display 1309 located at the first housing part 1311 may be activated with respect to remaining portions of the flexible display 1309, and the remaining portions may be deactivated. For example, the multi-foldable electronic device 1300 may control the flexible display 1309 such that a black color is filled in the remaining portions. In the state 1301, the multi-foldable electronic device 1300 may display a briefing screen through the first portion. For example, at least a portion of a UI 810 may be displayed through the first portion. While displaying a briefing screen based on the UI 810 in which card objects 151, 152, 153, and 154 are sequentially arranged, at least one of housing parts 1311, 1312, and 1313 of the multi-foldable electronic device 1300 may be rotated. For example, in the state 1301, the first housing part 1311 may be rotated with respect to the second housing part 1312.

A state 1302 of FIG. 13B may be included in a half-folded state of the multi-foldable electronic device 1300. For example, in the state 1301 of FIG. 13A, the multi-foldable electronic device 1300 identifying a rotation of the first housing part 1311 with respect to the second housing part 1312 may switch to the state 1302 of FIG. 13B. In the half-folded state, an angle between the first housing part 1311 and the second housing part 1312 may be substantially 180°, and an angle between the second housing part 1312 and the third housing part 1313 may be substantially 360° with respect to a surface on which the flexible display 1309 is disposed. In the half-folded state, a portion of the flexible display 1309 located on the first housing part 1311 and the second housing part 1312 may have a planar shape.

Referring to FIG. 13B, in the state 1302, the multi-foldable electronic device 1300 may display card objects 1321 and 1323 respectively corresponding to card objects 151 and 152 having relatively high ranks in the UI 810, on a portion of the flexible display 1309 located at the first housing part 1311 and the second housing part 1312. The card object 1321 may be located at a portion of the flexible display 1309 located on the second housing part 1312, and the card object 1323 may be located at a portion of the flexible display 1309 located on the first housing part 1311. Sizes of the card objects 1321 and 1323 may be larger than sizes of the corresponding card objects 151 and 152, respectively. In the state 1302 of FIG. 13B, together with the card objects 1321 and 1323, the multi-foldable electronic device 1300 may display texts 1322 and 1324 representing summarizations of contents of the card objects 1321 and 1323. The texts 1322 and 1324 may be obtained based on execution of a language model (e.g., the language model 255 of FIG. 2) based on the contents. In the state 1302 of FIG. 13B, the multi-foldable electronic device 1300 may display, at a portion of the flexible display 1309 located on the second housing part 1312, the card object 1321 having a relatively high rank, in a relatively large size. In the state 1302 of FIG. 13B, the multi-foldable electronic device 1300 may display remaining card objects (e.g., the card object 1323) at a portion of the flexible display 1309 located on the first housing part 1311, according to a size in the state 1301 and/or the UI 810.

A state 1303 of FIG. 13B may be included in an unfolded state (or fully unfolded state) of the multi-foldable electronic device 1300. For example, the multi-foldable electronic device 1300 identifying a rotation of the third housing part 1313 with respect to the second housing part 1312 in the state 1302 of FIG. 13B may switch to the state 1303 of FIG. 13B. In the unfolded state, both an angle between the first housing part 1311 and the second housing part 1312 and an angle between the second housing part 1312 and the third housing part 1313 may be substantially 180°. In the unfolded state, the entire flexible display 1309 may have a planar shape.

Referring to FIG. 13B, in the state 1303, the multi-foldable electronic device 1300 may display card objects 1321, 1323, and 1325 respectively corresponding to card objects 151, 152, and 153 having relatively high ranks in the UI 810, through the flexible display 1309. A card object 1321 located at a portion of the flexible display 1309 located on the third housing part 1313 may correspond to the card object 151 included in the UI 810. A card object 1323 located at a portion of the flexible display 1309 located on the second housing part 1312 may correspond to the card object 152 included in the UI 810. A card object 1325 located at a portion of the flexible display 1309 located on the first housing part 1311 may correspond to the card object 153 included in the UI 810. Together with the card objects 1321, 1323, and 1325, the multi-foldable electronic device 1300 may display texts 1322, 1324, and 1326 representing summarizations of contents of the card objects 1321, 1323, and 1325. The texts 1322, 1324, and 1326 may be obtained based on execution of a language model (e.g., the language model 255 of FIG. 2) based on the contents.

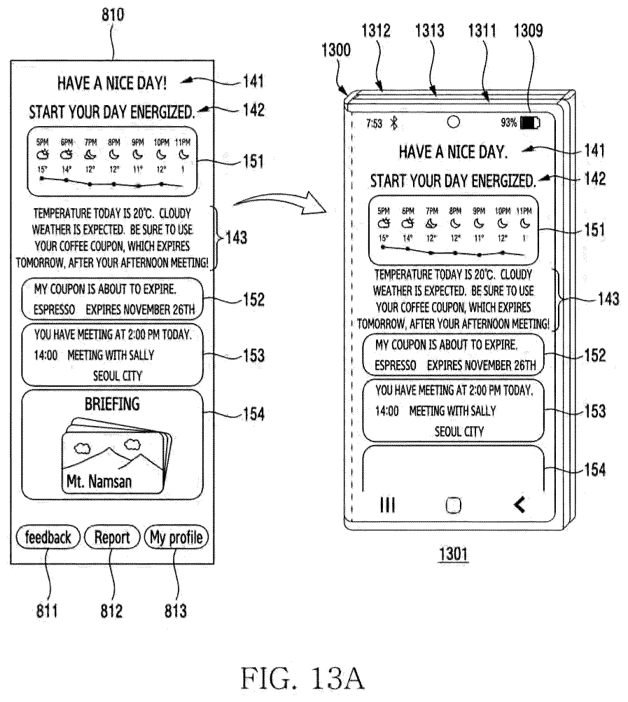

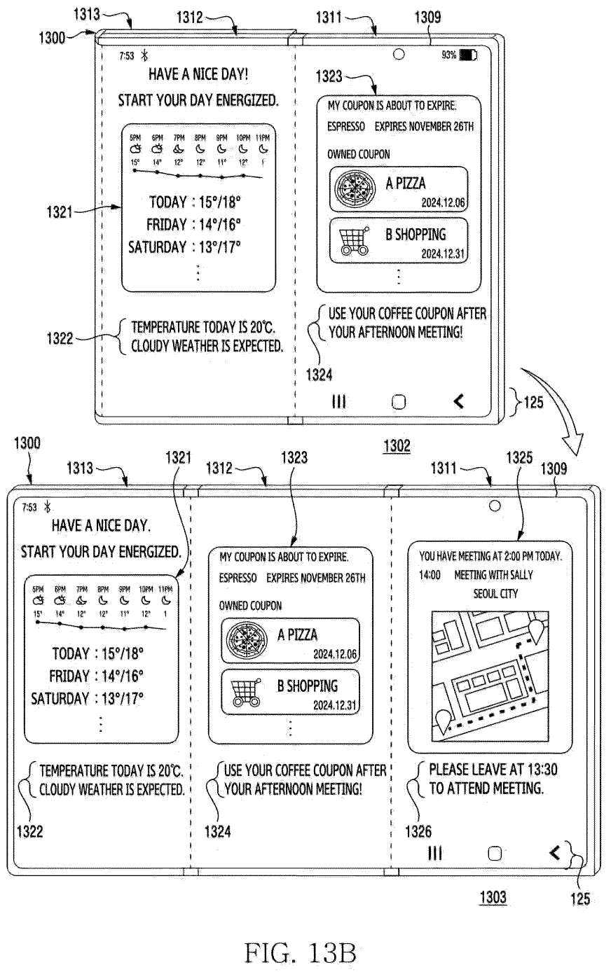

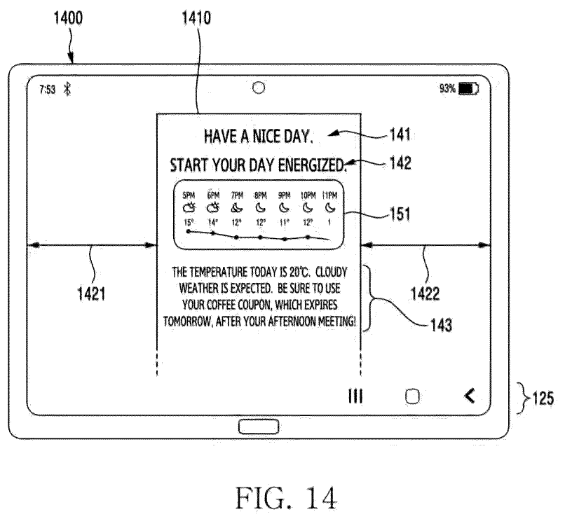

FIG. 14 is a diagram illustrating an example briefing screen displayed by an electronic device 1400 having a form factor of a tablet personal computer (PC) according to various embodiments. The electronic device 101 of FIG. 2 may include the electronic device 1400 described with reference to FIG. 14. The electronic device 1400 described with reference to FIG. 14 may perform operations of the electronic device described with reference to FIGS. 1 to 12. Referring to FIG. 14, an example of a briefing screen displayed by the electronic device 1400 is illustrated. The briefing screen may include a portion 1410 in which a card object 151 and/or texts 141, 142, and 143 are located. The card object 151 may include a content having a highest rank determined based on the operations described with reference to FIGS. 1 to 12. The texts 141, 142, and 143 may include summarization with respect to a plurality of contents including a content corresponding to the card object 151.

In the briefing screen, portions 1421 and 1422 different from the portion 1410 may be referred to as a padding region. Based on a swipe gesture and/or a drag gesture in the padding region, the electronic device 1400 may scroll a briefing screen displayed through the portion 1410. Although an embodiment in which the portion 1410 is located at a center of a display based on the portions 1421 and 1422 is illustrated, a location of the portion 1410 in the display is not limited thereto. For example, the electronic device 1400 may display the briefing screen including the card object 151 through an entire display region of the display. In the example, the electronic device 1400 may display, at a central portion of the display, a content having a highest rank among contents of the briefing screen, and may display remaining contents at remaining portions.

As described above, according to an embodiment, the electronic device may display contents generated by software applications, together with a text representing summarization of the contents. A screen including the contents and the texts may be referred to as a briefing screen. In the briefing screen, the contents may be arranged according to ranks of each of the contents. The ranks may be determined based on state information of the electronic device, state information of a user identified by the electronic device, and/or an importance level of the contents. A text representing summarization of contents may be generated using a portion of contents having relatively high ranks among the contents.

FIG. 15 is a diagram illustrating example states 1501, 1502, 1503, and 1504 of an electronic device 101 displaying a summarization content with respect to a user-generated content (e.g., image and/or video) according to various embodiments. The electronic device 101 of FIG. 15 may include the electronic device 101 of FIG. 1 and/or FIG. 2. An example hardware configuration of the electronic device 101 of FIG. 15 is described in greater detail below with reference to FIG. 17.

Referring to FIG. 15, in a state 1501 displaying a briefing screen, the electronic device 101 may display texts 1121, 1122, and 1124, and a card object 1123. The card object 1123 may include a media content (e.g., image such as photo and/or video) stored in the electronic device 101, such as images 1511 and 1512. According to an embodiment, the electronic device 101 may identify, using media contents stored in the electronic device 101, a user's activity associated with the media contents. The electronic device 101 may generate or display a text 1124 representing summarization of the identified activity. The text 1124 and/or the card object 1123 may be referred to as a briefing content, in terms of a content summarizing the user's activity. The electronic device 101 may classify media contents (e.g., grouping and/or clustering), using a location and a time at which each media content is obtained and/or a context (e.g., a home and/or a workplace) of a user obtaining each media content. The briefing contents may correspond to a cluster and/or a group of media contents generated by classifying the media contents. Operations of the electronic device 101 described with reference to FIGS. 15 to 26 may be performed for generating a briefing content corresponding to a cluster of the media contents.

Referring to FIG. 15, in the state 1501 displaying a briefing screen, the electronic device 101 may receive a user input associated with a briefing content (e.g., the card object 1123 including images 1511 and 1512 and/or the text 1124). The user input may include a tap gesture (or a double-tap gesture) on a portion of the display 110 on which the briefing content is displayed. Based on the user input, the electronic device 101 may provide a detailed view of the briefing content, as in the state 1502. In the state 1502, the electronic device 101 may display a screen for searching a plurality of images included in a cluster corresponding to the briefing content. In the state 1502, the electronic device 101 may display the images 1511 and 1512 having larger sizes than the images 1511 and 1512 included in the briefing screen displayed in the state 1501.

In the example state 1502 of FIG. 15, the electronic device 101 may display images 1511 and 1512 in the cluster corresponding to the briefing content, based on a scroll gesture. The scroll gesture may include a drag gesture and/or a swipe gesture performed along a horizontal direction 1521 of the display 110. Based on the scroll gesture, the electronic device 101 may change an image 1511 displayed through the display 110 to an image 1512 located next to the image 1511. In the state 1502, the electronic device 101 may display a visual object 1522 for switching to the state 1501 before the state 1502. In the state 1502, the electronic device 101 may provide a grid view (e.g., a view having a form of a two-dimensional grid) of images in the cluster including the images 1511 and 1512. For example, based on a user input associated with a visual object 1523, the electronic device 101 may switch to a state 1503. The images 1511 and 1512 displayed in the state 1502 may be arranged based on a carousel view.

In the state 1503 of FIG. 15, the electronic device 101 may display a screen including card objects 1531 and 1532 corresponding to each of clusters. In each of the card objects 1531 and 1532, images in the corresponding cluster may be arranged based on a form of a two-dimensional grid. In the state 1503, the electronic device 101 may display a UI object 1533 for generating and/or recommending a cluster and a briefing content based on the cluster. In the state 1503, the electronic device 101 may display a UI object 1534 for adding a cluster.

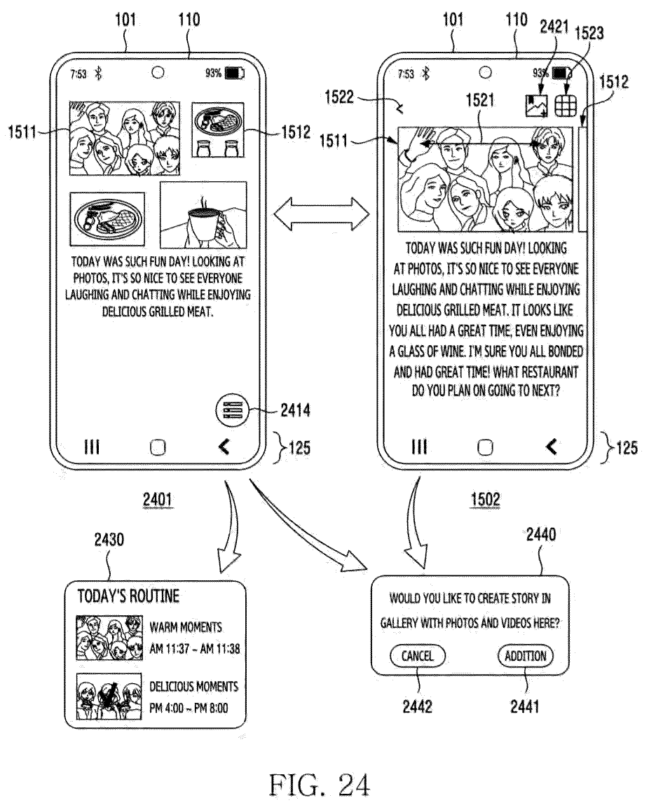

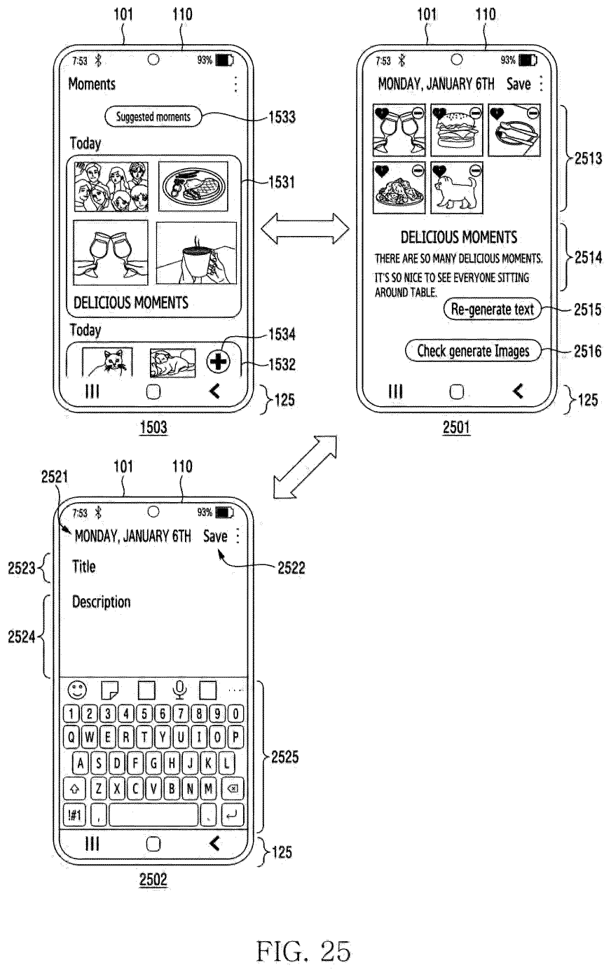

In an example state 1504 of FIG. 15, the electronic device 101 may provide a calendar view (or a monthly view). The electronic device 101 may display, in a calendar view 1541 corresponding to a specific month, a representative image in a cluster of images obtained at each date of the specific month, in a form of a thumbnail object. An image of the thumbnail object may be not only a representative image in the cluster, but also an image automatically generated based on a generative artificial intelligence model. In addition to the thumbnail object, the electronic device 101 may display, in the calendar view 1541, the number of cluster(s) of images obtained at a specific date. Based on an input for the thumbnail object, the electronic device 101 may provide a detailed view of a cluster corresponding to the thumbnail object, as in the state 1502. Based on an input for selecting a specific date of the calendar view 1541, the electronic device 101 may display clusters of images obtained at a specific date, as in the state 1503. Based on an input for selecting a date on which no cluster is generated, the electronic device 101 may display a screen (e.g., an example screen illustrated in FIG. 25) for generating a cluster of images obtained at the selected date and/or a briefing content for the cluster. The calendar view 1541 may be provided through a calendar application (e.g., the calendar application 241 of FIG. 2).

In an example state 1504 of FIG. 15, the electronic device 101 may change a month corresponding to the calendar view 1541, based on a drag gesture and/or a swipe gesture performed on the calendar view 1541. For example, based on a drag gesture and/or a swipe gesture performed along a horizontal direction of the display 110, the electronic device 101 may change the month corresponding to the calendar view 1541. For example, based on a drag gesture performed along a left direction of the display 110, the electronic device 101 may increase the month corresponding to the calendar view 1541. For example, based on a drag gesture performed along a right direction of the display 110, the electronic device 101 may decrease the month corresponding to the calendar view 1541. In the calendar view 1541, the electronic device 101 may apply a visual effect (e.g., dimming) indicating that clusters and/or briefing contents cannot be generated on dates after today's date.

According to an embodiment, a software application for generating a briefing content may be installed in the electronic device 101. The electronic device 101 executing a smart suggestion application (e.g., the smart suggestion application 260 of FIG. 2) executed for displaying a briefing screen of the state 1501 may provide, based on identifying a briefing content generated by the software application, a notification associated with the briefing content. The notification may be provided in a form of the widget objects 111 and 121 of FIG. 1.

According to an embodiment, the electronic device 101 may identify time information and/or location information of the electronic device 101. The electronic device 101 may identify a first content and a second content among a plurality of contents obtained within a predetermined period, based on first metadata of the first content and second metadata of the second content, according to identifying time information and location information satisfying a predetermined condition. A plurality of contents obtained in the predetermined period may include images and/or videos. The electronic device 101 may generate at least one text information using a machine learning model, based at least in part on the first content, the second content, the first metadata, and the second metadata. The at least one text information may represent summarization of the first content and/or the second content. As in the states 1501 and 1502 of FIG. 15, the electronic device 101 may display at least a portion of the first content and the second content at a first portion of the display 110. The electronic device 101 may display a text corresponding to the generated at least one text information, at a second portion different from the first portion.

As described above, according to an embodiment, the electronic device 101 may identify at least one cluster of a plurality of images. The electronic device 101 identifying the cluster including the plurality of images may identify a portion (e.g., images 1511 and 1512) of the plurality of images included in the cluster, using time differences among the plurality of images included in the cluster. The electronic device 101 may obtain or generate a text 1124 representing summarization of the portion of the plurality of images. The electronic device 101 may display the obtained text 1124 in relation to the cluster. The text 1124 may indicate a user's action associated with images (e.g., the images 1511 and 1512) included in the cluster. The electronic device 101 may display the text 1124 together with the portion of the images included in the cluster (e.g., in the states 1501 and 1502).

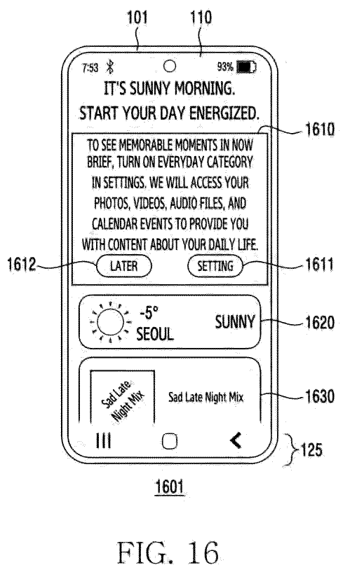

FIG. 16 is a diagram illustrating an example state 1601 of an electronic device 101 displaying a briefing screen according to various embodiments. The electronic device 101 of FIG. 15 may perform an operation of the electronic device 101 described with reference to FIG. 16. Referring to FIG. 16, the example state 1601 of the electronic device 101 displaying a briefing screen generated based on operations described with reference to FIGS. 1 to 14 is illustrated.

Referring to FIG. 16, in the state 1601, the electronic device 101 may display a visual object 1610 for checking whether to generate a briefing content (e.g., the card object 1123 and/or the text 1124 described with reference to FIG. 15) based on media contents (e.g., image and/or video) stored in the electronic device 101 in a briefing screen. The visual object 1610 may have a form of a dialog box included in the briefing screen. Together with a text guiding generation of a briefing content (e.g., “Turn on the daily category to see memorable moments in Now brief. To provide a content on the daily life, access to my photos, videos, audio files, and calendar schedules will be made.”), the visual object 1610 may include a UI object 1611 for receiving an input for allowing generation of a briefing content, and a UI object 1612 for receiving an input for foregoing generation of the briefing content. The electronic device 101 receiving a user input associated with the UI object 1612 may forgo displaying the visual object 1610 in the briefing screen.

In the state 1601 of FIG. 16, the electronic device 101 receiving a user input associated with the UI object 1611 may generate or display a briefing content using media contents stored in the electronic device 101. For example, the electronic device 101 may identify time information and location information of the electronic device 101. The electronic device 101 identifying time information and/or location information satisfying a predetermined condition may identify a first content and a second content among contents obtained within a predetermined period, based on first metadata of the first content (e.g., metadata including time information of the first content) and second metadata of the second content (e.g., metadata including time information of the second content). The electronic device 101 may generate or obtain at least one text information using a machine learning model, based on the first content, the second content, the first metadata, and the second metadata. The electronic device 101 may display at least a portion of the first content and the second content at a first portion (e.g., a portion in which the card object 1123 of FIG. 15 is disposed) of the display 110. The electronic device 101 may display a text corresponding to the generated at least one text information at a second portion (e.g., a portion in which the text 1124 of FIG. 15 is disposed) different from the first portion.

FIG. 17 is a block diagram illustrating an example configuration of an electronic device 101 according to various embodiments. Referring to FIG. 17, the electronic device 101 may have a form factor of not only a bar-type smartphone 291, but also a foldable-type smartphone 292, an HMD device 293, and/or a laptop PC 294. The electronic device 101 may include a processor 210, memory 220, and/or a display 110. Hardware of the electronic device 101 of FIG. 17 may correspond to hardware of the electronic device 101 of FIG. 2. Among descriptions of the hardware of FIG. 17, descriptions overlapping with the descriptions of the hardware of FIG. 2 may not be repeated here.

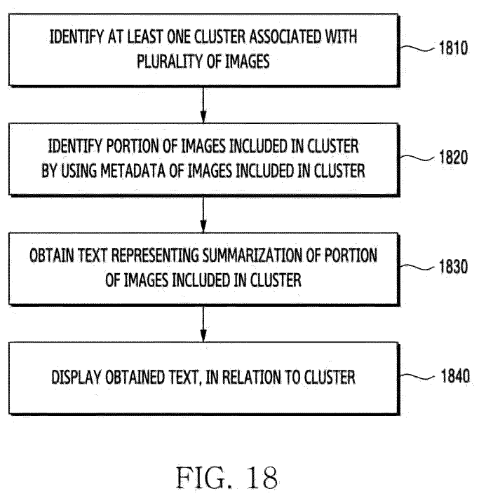

Referring to FIG. 17, software applications 240 installed in the electronic device 101 are illustrated. The software applications 240 of FIG. 17 may correspond to the software applications 240 of FIG. 2. In an embodiment, based on the software applications 240, media contents (e.g., images and/or videos obtained by executing a camera application) stored in the electronic device 101 may be stored in the memory 220. According to an embodiment, the processor 210 of the electronic device 101 may identify a cluster(s) of the media contents stored in the memory 220, by executing a moments application 1250. Based on identifying the cluster of the media contents, the processor 210 executing the moments application 1250 may obtain or generate summarization of the cluster. In order to obtain a text representing the summarization, the processor 210 may execute a language model 255 and/or an image recognition model 1760. The language model 255 of FIG. 17 may correspond to the language model 255 of FIG. 2. In terms of being installed in the electronic device 101 owned by a user, the language model 255 and/or the image recognition model 1760 may be referred to as an on-device model. An operation of the electronic device 101 executing the moments application 1250 is described in greater detail below with reference to FIG. 18.

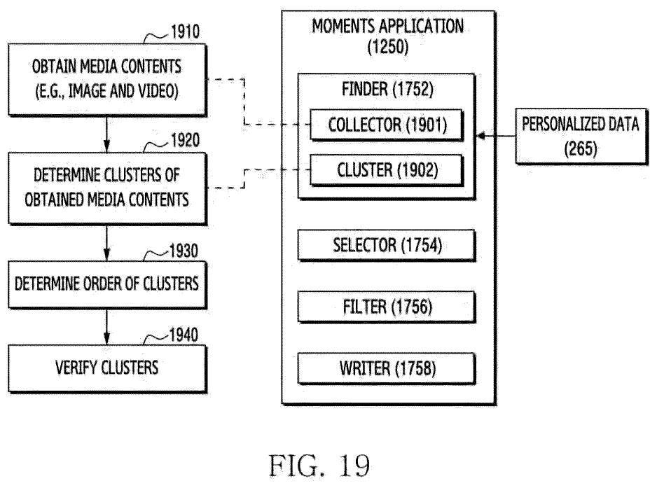

Referring to FIG. 17, boxes included in the moments application 1250 may indicate functions supported by the moments application 1250. For example, a finder 1752 may include various circuitry and/or executable program instructions and correspond to a function of the moments application 1250 classifying (e.g., clustering) media contents (e.g., images and/or videos) stored in the memory 220 of the electronic device 101, according to criteria including a location, a context, and/or a time. An example operation of the electronic device 101 executing the finder 1752 is described in greater detail below with reference to FIG. 19.

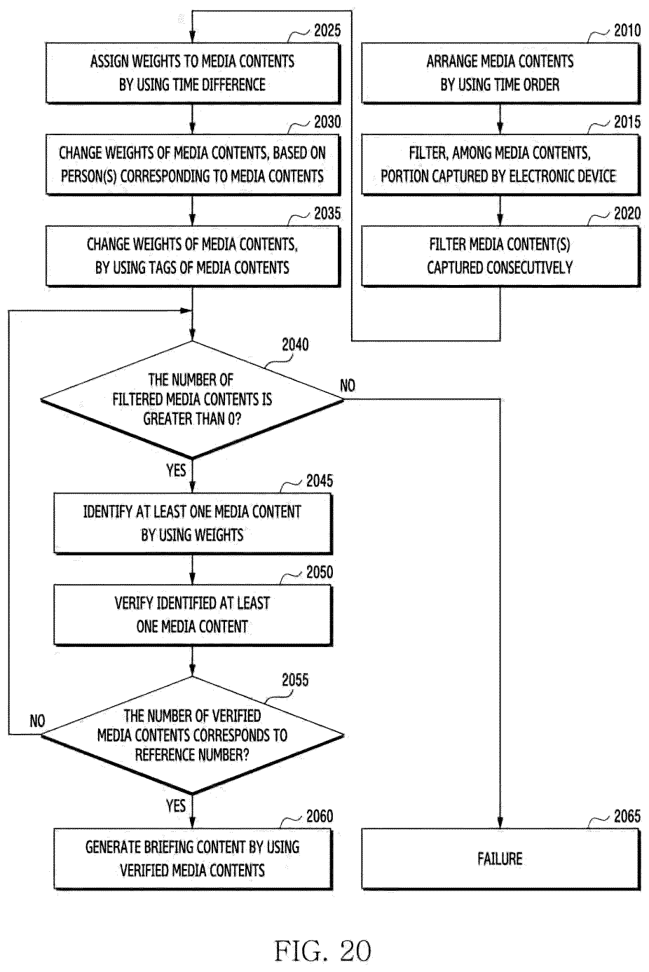

For example, a selector 1754 may include various circuitry and/or executable program instructions and correspond to a function of the moments application 1250 identifying and/or filtering at least one media content to be used for obtaining, from a specific cluster of media contents, a text representing summarization of the cluster. An example operation of the electronic device 101 executing the selector 1754 is described in greater detail below with reference to FIG. 20.

For example, a filter 1756 may include various circuitry and/or executable program instructions and correspond to a function of the moments application 1250 verifying at least one media content identified based on the selector 1754 (e.g., verification of image and/or video based on harmfulness, violence, sensationalism, and/or atmosphere).

For example, a writer 1758 may include various circuitry and/or executable program instructions and correspond to a function of the moments application 1250 executing the language model 255 using at least one media content verified based on the filter 1756. For example, the electronic device 101 may obtain a text representing summarization of the at least one media content from the language model 255. The electronic device 101 may input or apply, to the language model 255, metadata (e.g., a time and/or a location) of the at least one media content together with the verified at least one media content.

In an embodiment, the electronic device 101 may (automatically) execute the moments application 1250, at a specific time and/or a specific place. Based on execution of the moments application 1250, the electronic device 101 may obtain a cluster of media contents and a text representing summarization of the media contents included in the cluster. The briefing content including the cluster and/or the text may be generated based on a user's activity identified by the electronic device 101, such as a payment and/or an exercise. The briefing content may be generated based on health information (e.g., a heart rate, a sleep time, and/or an electrocardiogram (ECG)) of the user of the electronic device 101 and/or an audio signal (e.g., music) output by the electronic device 101.

As described above, according to an embodiment, the electronic device 101 may generate or obtain a briefing content including at least one of images included in a cluster and/or a text representing summarization of the cluster. The electronic device 101 may store the briefing content in the memory 220. For example, the briefing content may be stored in the document DB 250 of FIG. 2. The electronic device 101 may display, during displaying a home screen, a widget object (e.g., a widget object referred to as Now bar and/or the widget objects 111 and 121 of FIG. 1) based at least in part on the briefing content. The electronic device 101 may display, based on a user input associated with the widget object, the text and at least one of the images included in the cluster, through a display 110 (e.g., in the states 1501, 1502, and 1503 of FIG. 15).

FIG. 18 is a flowchart illustrating example operations of an electronic device according to various embodiments. The electronic device 101 of FIG. 2, the electronic device 101 of FIG. 17, and/or a processor 210 of FIG. 17 may perform operations of FIG. 18. An order in which the operations of FIG. 18 are performed may be different from an example order of FIG. 18. For example, the electronic device 101 and/or the processor 210 of FIG. 17 may perform the operations of FIG. 18 in an order different from the order illustrated in FIG. 18. For example, the electronic device 101 and/or the processor 210 of FIG. 17 may perform at least two of the operations of FIG. 18 substantially concurrently. The operations of FIG. 18 may be performed by the electronic device executing the moments application 1250 of FIG. 17. Although an example operation of the electronic device with respect to images is described, the electronic device may perform an operation similar to FIG. 18 with respect to videos as well.

Referring to FIG. 18, in operation 1810, the electronic device according to an embodiment may identify at least one cluster associated with a plurality of images. The plurality of images of the operation 1810 may respectively correspond to files based on Joint Photographic Experts Group (JPEG), Portable Network Graphics (PNG), and/or High Efficiency Image File Format (HEIF). For example, the electronic device may perform the operation 1810 by executing the finder 1752 of FIG. 17. The electronic device may perform the operation 1810 using locations and/or times at which each of the plurality of images were captured. Information indicating the locations and/or the times may be included in metadata of the plurality of images. The electronic device may perform the operation 1810 using a context (e.g., context information identified based on the context engine 280 of FIG. 2) at a time when the plurality of images were captured. An example operation of the electronic device identifying at least one cluster based on the operation 1810 is described in greater detail below with reference to FIG. 19.

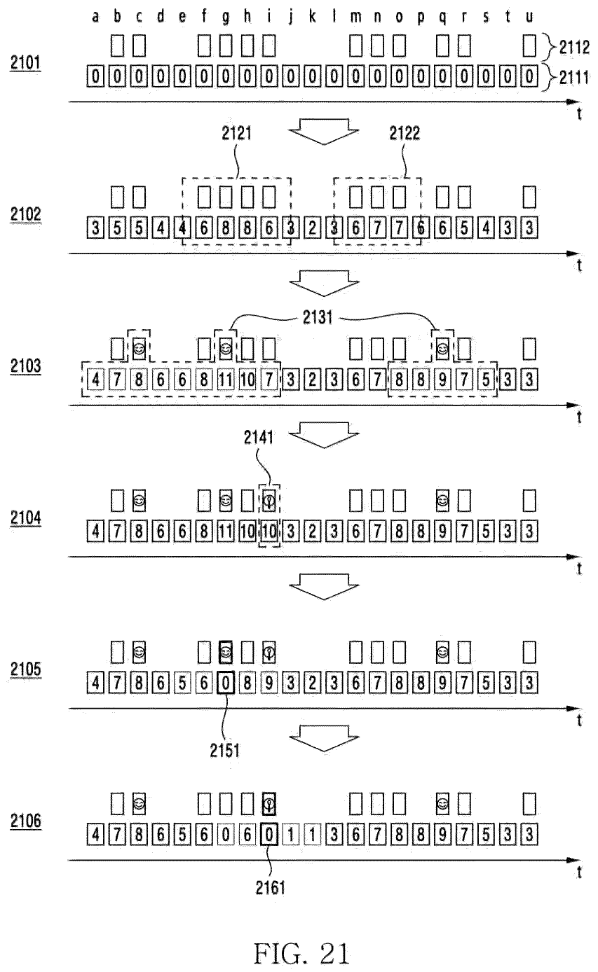

Referring to FIG. 18, in operation 1820, the electronic device according to an embodiment may identify a portion of images included in a cluster using metadata of the images included in the cluster. The metadata may have a data structure of Exchangeable Image File Format (EXIF). The electronic device may perform the operation 1820 by executing the selector 1754 of FIG. 17. An example operation of the electronic device identifying a portion of images included in a cluster based on the operation 1820 is described in greater detail below with reference to FIG. 20 and/or FIG. 21.

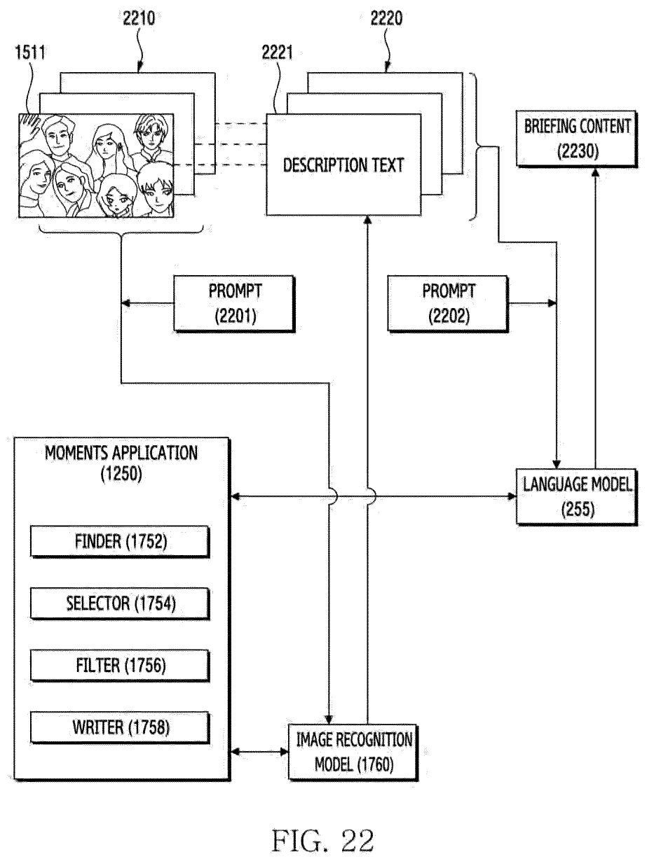

Referring to FIG. 18, in operation 1830, the electronic device according to an embodiment may obtain a text representing summarization of a portion of images included in a cluster. The electronic device may obtain the text of the operation 1830 by executing the language model 255 of FIG. 17. In order to obtain the text of the operation 1830, the electronic device may obtain a text for a portion of the images identified based on the operation 1820, by executing the image recognition model 1760 of FIG. 17. By executing the language model 255 of FIG. 17 using the text, the electronic device may obtain the text of the operation 1830. An example prompt provided to the language model for obtaining the text of the operation 1830 is described in greater detail below with reference to FIG. 22. Since a portion of the images identified based on the operation 1820 is input to the language model instead of all of the images included in the cluster being input to the language model, the electronic device may obtain the text of the operation 1830 more quickly. In order to obtain summarization of the images and/or the cluster using the portion of the images included in the cluster, the electronic device may select a representative image(s) for the cluster among the plurality of images, based on the operation 1820.

Referring to FIG. 18, in operation 1840, the electronic device according to an embodiment may display the obtained text in relation to a cluster. For example, the electronic device may generate or store a briefing content including the text obtained based on the operation 1830. The briefing content may be displayed together with other card objects in the briefing screen, as in the state 1501 of FIG. 15. The electronic device may provide or display a detailed view of the briefing content, as in the state 1502 of FIG. 15.

FIG. 19 is a diagram illustrating example operations of an electronic device according to various embodiments. The electronic device 101 of FIG. 2, the electronic device 101 of FIG. 17, and/or the processor 210 of FIG. 17 may perform operations of FIG. 19. The operations of the electronic device described with reference to FIG. 19 may be associated with the finder 1752 of FIG. 17 (or the moments application 1250 including the finder 1752) and/or the operation 1810 of FIG. 18. An order in which the operations of FIG. 19 are performed is not limited to the order illustrated in FIG. 19. For example, the electronic device 101 and/or the processor 210 of FIG. 17 may perform the operations of FIG. 19 in an order different from the order illustrated in FIG. 19. For example, the electronic device 101 and/or the processor 210 of FIG. 17 may perform at least two of the operations of FIG. 19 substantially concurrently.

Referring to FIG. 19, in operation 1910, the electronic device according to an embodiment may obtain media contents (e.g., image and video). The electronic device may identify media contents obtained during one day (e.g., a current date), one week (e.g., a week including the current date), and/or one month (e.g., a month including the current date). The electronic device may identify metadata corresponding to the media contents. For example, using the metadata, the electronic device may identify the media contents obtained during the period. For example, the electronic device may identify the media contents between a time when a briefing content was last generated and a current time. Using the media contents obtained based on the operation 1910, the electronic device may perform remaining operations of FIG. 19. The operation 1910 may be performed by executing a collector 1901 of the finder 1752.

Referring to FIG. 19, in operation 1920, the electronic device according to an embodiment may determine clusters of the obtained media contents. For example, using at least one of a time or a location of each of the media contents stored in memory (e.g., the memory 220 of FIG. 17), the electronic device may identify or determine at least one cluster of the media contents. For example, the electronic device may classify the media contents using time sections referred to as morning, afternoon, and/or evening. For example, the electronic device may classify the media contents using locations (e.g., a home, a workplace, or another location identified by the electronic device) of the electronic device at times when the media contents were stored. For example, when a user records and/or captures media contents at different locations, the electronic device may identify or obtain clusters of a media content(s) corresponding to each of the locations. The operation 1920 may be performed by executing a cluster 1902 of the finder 1752.

Referring to FIG. 19, in operation 1930, the electronic device according to an embodiment may determine an order of clusters. For example, the electronic device may determine the order of the clusters using occurrence times and/or occurrence orders of events corresponding to each of the clusters. For example, the electronic device may determine the order of the clusters, using a size of a time section corresponding to clusters (e.g., time section between a generation time of a first generated media content and a generation time of a last generated media content among the media contents included in the clusters). For example, the electronic device may determine the order of the clusters, using the number of the media contents included in each of the clusters. For example, the electronic device may identify or determine the order of the clusters, according to types of the events corresponding to each of the clusters. The order of the clusters determined based on the operation 1930 may be an order of displaying briefing contents respectively corresponding to the clusters.

Referring to FIG. 19, in operation 1940, the electronic device according to an embodiment may verify clusters. For example, the electronic device may compare the number of media contents of each of the clusters with a threshold. For example, with respect to a cluster including media contents equal to or less than the threshold, the electronic device may discard or remove the cluster. For example, the electronic device may refrain from or forgo generating a briefing content with respect to the cluster including the media contents equal to or less than the threshold. Using a cluster including media contents greater than the threshold, the electronic device may execute the selector 1754 or perform operations of FIG. 20.

FIG. 20 is a flowchart illustrating example operations of an electronic device according to various embodiments. The electronic device 101 of FIG. 2, the electronic device 101 of FIG. 17, and/or the processor 210 of FIG. 17 may perform operations of FIG. 20. The operation of the electronic device described with reference to FIG. 20 may be associated with the selector 1754 (or the moments application 1250) of FIG. 17 and/or the operation 1820 of FIG. 18. An order in which the operations of FIG. 20 are performed is not limited to the order illustrated in FIG. 20. For example, the electronic device 101 and/or the processor 210 of FIG. 17 may perform the operations of FIG. 20 in an order different from the order illustrated in FIG. 20. For example, the electronic device 101 and/or the processor 210 of FIG. 17 may perform at least two of the operations of FIG. 20 substantially concurrently.

Referring to FIG. 20, in operation 2010, the electronic device according to an embodiment may arrange media contents using a time order. The media contents of the operation 2010 may be included in a cluster obtained by executing the finder 1752 of FIG. 17 (or by performing the operations of FIG. 19). The electronic device may obtain or determine time orders of each of media contents included in a specific cluster.

Referring to FIG. 20, in operation 2015, the electronic device according to an embodiment may filter a portion obtained by the electronic device from among media contents. For example, the electronic device may remove, from a cluster, a screenshot and/or media contents downloaded through Internet (e.g., a mail server and/or a messenger server) using metadata of each of the media contents. For example, the electronic device may extract or identify media contents captured using a camera (e.g., a camera included in the electronic device). The electronic device may perform remaining operations of FIG. 20 using media contents obtained using a camera which are identified based on the operation 2015.

Referring to FIG. 20, in operation 2020, the electronic device according to an embodiment may filter media content(s) captured consecutively. For example, the electronic device may not select at least one media content, which is obtained according to a time difference less than a threshold time difference (e.g., 5 seconds), as a candidate media content to be used to obtain text representing summarization of a cluster. For example, among media contents obtained based on a continuous shooting mode, the electronic device may not select, as the candidate media content, remaining media contents different from one media content, or may remove them from the cluster. For example, by comparing media contents, the electronic device may not select substantially similar media contents as a candidate media content, or may remove them from the cluster.

Referring to FIG. 20, in operation 2025, the electronic device according to an embodiment may assign weights to media contents using a time difference. The electronic device may perform the operation 2025 with respect to remaining media contents in a cluster, which are different from media contents excluded from the cluster based on the operations 2015 and 2020. Before performing the operation 2025, the electronic device may initialize weights (or scores) respectively corresponding to the media contents.

By performing the operation 2025, the electronic device may assign weights and/or scores according to time differences between media contents to the media contents included in the cluster. For example, the electronic device may assign a first score to media contents having a first time difference, and may assign a second score less than the first score to media contents having a second time difference longer than the first time difference. For example, the electronic device may assign relatively large weights to media contents having relatively small time differences. In other words, the electronic device identifying media contents having relatively small time differences may identify a user's intention for capturing media contents at a time when the media contents are captured.

Referring to FIG. 20, in operation 2030, the electronic device according to an embodiment may change weights of media contents, based on a person(s) corresponding to the media contents. For example, the electronic device may change each of the weights assigned based on the operation 2025, using a size of a region associated with a person within a corresponding media content. For example, using the number of person(s) identified from the media content and/or a size of a region associated with a person within the media content, the electronic device may change a weight corresponding to the media content. In the example, the weight may be increased in proportion to the number and/or the size. In the example, the weight may be increased based on a multiplication of the number and the size.

Referring to the operations 2020 and 2025 of FIG. 20, the electronic device may identify or determine a portion of media contents to be used to generate a briefing content from the media contents, using timings at which the media contents were obtained. For example, the electronic device may identify remaining media contents excluding consecutively captured media contents based on the operation 2020. In the example, the electronic device may obtain a portion of media contents captured with relatively small time differences among the remaining media contents, based on the operation 2025. Using the obtained portion, the electronic device may perform remaining operations of FIG. 20 to generate the briefing content.

Referring to FIG. 20, in operation 2035, the electronic device according to an embodiment may change weights of media contents, using tags of the media contents. Based on object recognition, one or more tags may be assigned to the media content. In the present disclosure, a tag may include a keyword indicating a category and/or a subject of the media content (e.g., keyword such as food, mountain, river, exercise, group photo, and/or landscape). The electronic device may change each of the weights determined based on the operations 2025 and 2030, using at least one tag assigned to a corresponding media content. For example, the weight of the media content may be changed using preset weights corresponding to each of tags. For example, the electronic device may combine a weight corresponding to a specific media content with weights corresponding to each of tags assigned to the specific media content (e.g., weighted sum).

Referring to FIG. 20, in operation 2040, the electronic device according to an embodiment may check (e.g., determine) whether the number of filtered media contents is greater than 0. For example, the electronic device may check the number of media contents in a cluster from which at least one media content is removed based on the operations 2015 and 2020. When the number of the media contents is less than or equal to 0 (in 2040-NO), the electronic device may perform operation 2065. When the number of the media contents is greater than 0 (in 2040-YES), the electronic device may perform operation 2045.

Referring to FIG. 20, in operation 2045, the electronic device according to an embodiment may identify at least one media content using weights. For example, the electronic device may identify a portion of media contents included in a cluster, using weights of each of media contents determined based on the operations 2025, 2030, and 2035. For example, the electronic device may identify two to three media contents having the highest weight, based on a descending order of the weights.

Referring to FIG. 20, in operation 2050, the electronic device according to an embodiment may verify the identified at least one media content. For example, the electronic device may check whether at least one media content identified based on the operation 2045 represents a violent, suggestive, or unethical scene. When at least one media content represents a violent, suggestive, or unethical scene, the electronic device may remove the at least one media content from a cluster, or may exclude it from candidate media contents to be used to generate summarization for the cluster.

In an embodiment, the electronic device may perform the operation 2050 using metadata corresponding to a media content (e.g., tag(s) assigned to the media content, indicated by metadata). For example, when a tag(s) corresponding to the media content correspond to a predetermined tag for verification of the operation 2050, the electronic device may remove the media content from a cluster. A list (e.g., a block list) of tag(s) for filtering a media content may be stored in the electronic device.

For the verification of the operation 2050, the image recognition model 1760 of FIG. 17 may be executed. For example, the electronic device may obtain a text representing a description of at least one media content of the operation 2045, by executing the image recognition model. Based on identifying at least one word (e.g., filtering keywords) set for verification of the operation 2050 from the text, the electronic device may remove the at least one media content from the cluster.

Referring to FIG. 20, in operation 2055, the electronic device according to an embodiment may check whether the number of verified media contents corresponds to a reference number. The reference number of the operation 2055 may be three. When the number of verified media contents based on the operation 2050 corresponds to the reference number (in 2055-YES), the electronic device may perform operation 2060. When the number of verified media contents based on the operation 2050 does not correspond to the reference number (in 2055-NO), the electronic device may perform (again) at least one of the operations 2040, 2045, 2050, 2055, and 2065.

Referring to FIG. 20, in operation 2060, the electronic device according to an embodiment may generate a briefing content using verified media contents. For example, the electronic device may execute the language model 255 of FIG. 17 using media contents of the reference number of the operation 2055. For example, the electronic device may generate or obtain a briefing content, using media contents of the reference number of the operation 2055 and metadata of the media contents. The briefing content may include a text representing summarization of the media contents. The briefing content may be linked with at least one media content filtered based on the operations 2015 and 2020.

Referring to FIG. 20, in operation 2065, the electronic device according to an embodiment may refrain from or forgo generating a briefing content corresponding to the cluster.

Hereinafter, an example operation of an electronic device that assigns a weight to each of media contents based on operations 2025, 2030, and 2035 will be described in greater detail with reference to FIG. 21.

FIG. 21 is a diagram illustrating an example operation of an electronic device that determines weights of each of a plurality of images according to various embodiments. The electronic device 101 of FIG. 2, the electronic device 101 of FIG. 17, and/or the processor 210 of FIG. 17 may perform an operation of the electronic device described with reference to FIG. 21. The operation of the electronic device described with reference to FIG. 21 may be associated with the operation of the electronic device of FIG. 20.

Referring to FIG. 21, images, which are media contents included in a cluster, may be arranged according to a time order in which each of the images are captured. The electronic device may filter images 2112 by performing the operations 2015 and 2020 of FIG. 20. For example, the electronic device may filter images 2112 consecutively captured in each of time sections a to u having a predetermined time length (e.g., about 5 seconds). The electronic device may assign weights with respect to images 2111 different from the images 2112 among the images included in the cluster.

In a state 2101 of FIG. 21, the electronic device may initialize weights of all images 2111 to 0. Numbers written in the images 2111 displayed by boxes may indicate a weight (or score) assigned to each of the images 2111. In the state 2101, the electronic device may determine weights of the images 2111 using a time difference between the images, by performing the operation 2025 of FIG. 20. A state 2102 of FIG. 21 may be a state in which a weight based on a time difference is assigned to a corresponding image. Referring to the example state 2102 of FIG. 21, images 2121 and 2122 having small time differences from other images may have higher weights than other images.

In the state 2102 of FIG. 21, the electronic device may determine weights corresponding to each of images, using whether a person is captured in each of the images. A state 2103 of FIG. 21 may be a state in which a weight is adjusted according to whether a person is captured in an image. Referring to the example state 2103 of FIG. 21, weights of images 2131 in which a person is captured may be increased, and weights of remaining images may be maintained.

In the state 2103 of FIG. 21, the electronic device may change or determine a weight of at least one of images, using tags of each of the images. A state 2104 of FIG. 21 may be a state in which a weight of an image is adjusted using a tag. Referring to the state 2104 of FIG. 21, weights of images 2141 to which a tag indicating that food is captured is assigned may be increased, and weights of remaining images may be maintained.

In the state 2104 of FIG. 21, the electronic device may determine an image having the highest weight as an image to be used to generate summarization for a cluster. For example, the electronic device may determine an image 2151 having a weight of 11 as the image to be used to generate the summarization for the cluster. In a state 2105 after selecting the image 2151, the electronic device may initialize a weight corresponding to the image 2151 to 0. In the state 2105, the electronic device may reduce weights of images adjacent to the image 2151. In the state 2105, the electronic device may determine an image having the highest weight as an image to be used to generate the summarization for the cluster. For example, the electronic device may determine an image 2161 having a weight of 9 as the image to be used to generate the summarization for the cluster. A state 2106 of FIG. 21 is a state after selecting the image 2161, and the electronic device may initialize a weight corresponding to the image 2161 to 0 and may reduce weights of images adjacent to the image 2161. After the state 2106, the electronic device may obtain or generate a text representing summarization for the cluster, using the images 2151 and 2161.

As described above, the electronic device may determine, among images included in a cluster, images 2151 and 2161 to be used to generate natural language summarization related to the cluster. Although an operation of the electronic device selecting two images 2151 and 2161 is described, the number of images extracted by the electronic device to generate natural language summarization is not limited thereto. Although an operation of the electronic device reducing weights of the images 2151 and 2161 and other images adjacent to the images 2151 and 2161 (on a time axis) while selecting the images 2151 and 2161 is described, the disclosure is not limited thereto. For example, the electronic device may select or extract a predetermined number (e.g., two to three) of images having relatively high weights (or weights exceeding a threshold) in the state 2104, without changing the weights.

FIG. 22 is a diagram illustrating an example operation of an electronic device generating a briefing content 2230 using images included in a cluster according to various embodiments. The electronic device 101 of FIG. 2, the electronic device 101 of FIG. 17, and/or the processor 210 of FIG. 17 may perform the operation of the electronic device described with reference to FIG. 22. The operation of the electronic device described with reference to FIG. 22 may be associated with the writer 1758 of FIG. 17 and/or the operation 1830 of FIG. 18.

Referring to FIG. 22, images 2210 identified from a cluster are illustrated. The images 2210 including an image 1511 may be selected or extracted from among a plurality of images in the cluster, based on operation └ described with reference to FIGS. 18 to 21. Although an embodiment in which three images 2210 are extracted from a plurality of images in the cluster is illustrated, the disclosure is not limited thereto. The electronic device may execute the image recognition model 1760 using the images 2210 and a prompt 2201. The prompt 2201 may include a natural language sentence(s) for generating a description text with respect to each of the images 2210, such as “Describe the image in 3 sentences in English.”. By executing the image recognition model 1760, the electronic device may obtain description texts 2220 corresponding to each of the images 2210. For example, a description text 2221 may include a natural language sentence(s) for describing the image 1511.

Referring to FIG. 22, the electronic device may execute the language model 255 using the description text 2221 and/or a prompt 2202. Table 4 may indicate an example prompt 2202 input to the language model 255.

TABLE 4

```
      I took the photos for me today. When you see my photos, what would you say
about my day? Your reply should be conversational as if an acquaintance was talking
to me.
      <photo information>
          - Scene 1
            * description : {image description}
            * taken time : {hh:mm:ss}
          - Scene 2
            - description : {image description}
            * taken time : {hh:mm:ss}
          - Scene 3
            * description : {image description}
            * taken time : {hh:mm:ss}
        - Write shortly and concisely in 3 sentences.
        Result { “title”: “Graceful Moments in Water”, “description”: “Your
backstroke captured such a serene and precise movement. The calm water and clear
skies really highlight your grace. The sunlight shimmering on the surface adds a
peaceful touch to the whole scene.”}
```

Referring to Table 4, description texts 2220 may be inserted into {image description} of the prompt 2202. The taken time of Table 4 may indicate timings at which each of the images 2210 is captured. Referring to Table 4, the prompt 2202 may include a command (e.g., “Write shortly and concisely in 3 sentences.”) for generating a summarization text with respect to the images 2210. The prompt 2202 may include a text (e.g., “result”) indicating a format of text to be obtained from the language model 255.

By executing the language model 255 using the description texts 2220 and/or the prompt 2202, the electronic device may obtain a text representing summarization with respect to the images 2210. The electronic device may generate or obtain a briefing content 2230 linked with a cluster including the text and the images 2210. The briefing content 2230 may be registered or stored in the document DB 250 of FIG. 2.

As described above, the electronic device may generate or obtain natural language summarization with respect to a cluster, using a portion (e.g., the images 2210) of images included in the cluster. The electronic device may identify or extract a small number of images 2210 representing the cluster, based on operations described with reference to FIGS. 19 to 21. Using the images 2210, the electronic device may obtain or generate natural language summarization with respect to the cluster, by executing the image recognition model 1760 and/or the language model 255, which is an on-device model. Although an example operation of the electronic device generating the briefing content 2230 using two models (e.g., the image recognition model 1760 and the language model 255) is described, the disclosure is not limited thereto. For example, one model may be used to generate the description texts 2220 and/or the natural language summarization.

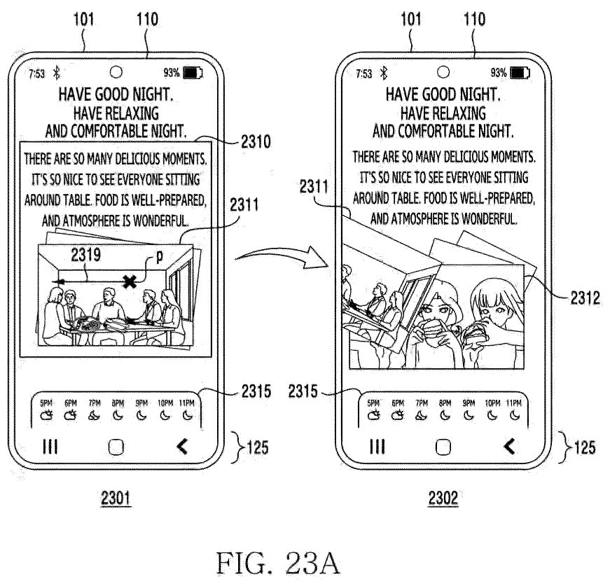

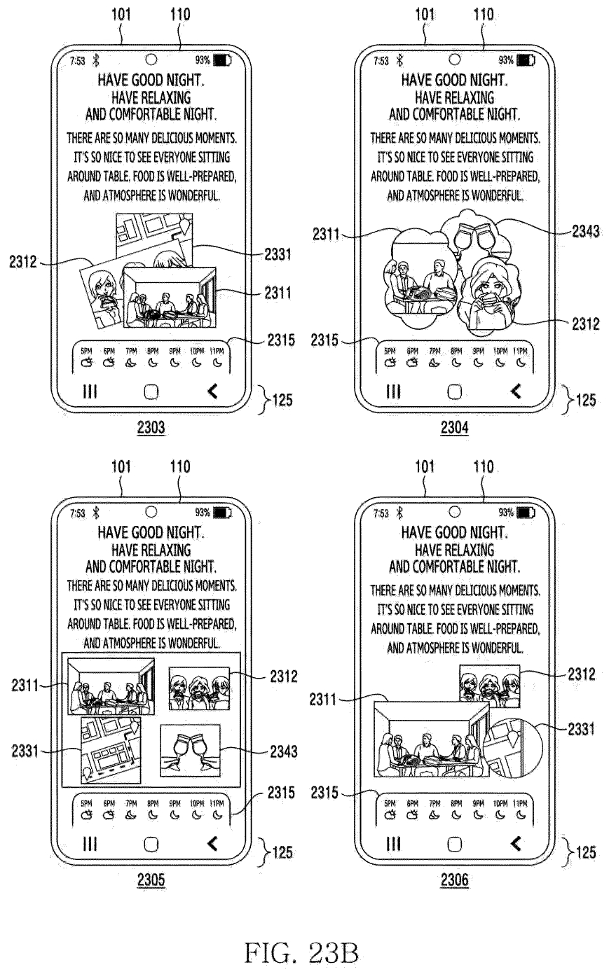

Hereinafter, an example operation of an electronic device displaying the briefing content 2230 will be described in greater detail with reference to FIGS. 23A, 23B, and/or 24.

FIGS. 23A and 23B are diagrams illustrating example layouts of images included in a briefing content according to various embodiments. The electronic device 101 of FIG. 2, the electronic device 101 of FIG. 17, and/or the processor 210 of FIG. 17 may perform operations of the electronic device 101 described with reference to FIGS. 23A and/or 23B. The operations of the electronic device 101 described with reference to FIGS. 23A and/or 23B may be associated with the smart suggestion application 260 of FIG. 2, the moments application 1250 of FIG. 17, and/or the operation 1840 of FIG. 18.

Referring to FIGS. 23A and/or 23B, example states 2301, 2302, 2303, 2304, 2305, and 2306 of the electronic device 101 displaying a briefing content (e.g., the briefing content 2230 of FIG. 22) generated based on operations described with reference to FIGS. 15 to 22 are illustrated. For example, the states 2301, 2302, 2303, 2304, 2305, and 2306 of FIGS. 23A and/or 23B may be described as an example state of the electronic device 101 including a briefing screen including a briefing content.

Referring to FIG. 23A, a state 2301 of the electronic device 101 displaying a card object 2310 corresponding to a briefing content is illustrated. For example, the electronic device 101 may display a briefing screen including the card object 2310. In the briefing screen, another card object 2315 may be located below the card object 2310. The electronic device 101 may display a briefing screen including text representing summarization with respect to contents corresponding to the card objects 2310 and 2315, based on operations described with reference to FIGS. 1 to 14.

Referring to the example state 2301 of FIG. 23A, the card object 2310 may include at least one image (e.g., the image 2311) in a cluster corresponding to a briefing content. When the cluster includes a plurality of images, the electronic device 101 may display the image 2311 overlapped on other images on the card object 2310. The electronic device 101 may display, on the image 2311, a text (e.g., “dinner”) representing summarization with respect to the briefing content. While displaying the card object 2310 including the image 2311, the electronic device 101 may receive a user input for searching images in the cluster, within the card object 2310. For example, the user input may be identified based on a drag gesture and/or a swipe gesture that starts at a point p on the image 2311 and is performed along a horizontal direction 2319 of the display 110. In the state 2301 of FIG. 23A, based on identifying the user input, the electronic device 101 may display, through the display 110, an image 2312 following the image 2311, as in the state 2302 of FIG. 23A.

Referring to FIG. 23B, example states 2303, 2304, 2305, and 2306 displaying images 2311 and 2312 are illustrated, together with texts (e.g., “There are really many delicious moments. It is so nice to see everyone sitting around one table. The food is well prepared, and the atmosphere is really good.”) included in a briefing content through a briefing screen. For example, as in the state 2303, the electronic device 101 may overlappingly display at least two images among images 2311 and 2312 in the cluster corresponding to the briefing content. In the state 2303, the electronic device 101 may display a map image 2331 indicating a place where images in the cluster including the images 2311 and 2312 are captured, together with the images 2311 and 2312. For example, as in the state 2304, the electronic device 101 may display images 2311, 2312, and 2343 in the cluster corresponding to the briefing content, based on a cloud-shaped closed curve. For example, as in the state 2305, the electronic device 101 may display the images 2311, 2312, and 2343 in the cluster corresponding to the briefing content, together with the map image 2331. Referring to the example state 2305 of FIG. 23B, the images 2311, 2312, and 2343 and the map image 2331 may be arranged in a grid form within the briefing screen. For example, in the state 2306, the electronic device 101 may display the images 2311 and 2312 in the cluster, and may display the map image 2331 based on a circular closed curve.

In the briefing screen, an order of displaying media contents included in the cluster is not limited to example layouts of FIG. 23A and/or FIG. 23B. For example, the electronic device 101 may determine, using an order set by a user, the order. For example, the electronic device 101 may display a video included in the cluster through the briefing screen. For example, the electronic device 101 may repeatedly play at least a portion of the video (e.g., section repeat). The map image 2331 may include a pin object indicating a place associated with images in the cluster. In the map image 2331, the pin object may be aligned with a center of the map image 2331. The map image 2331 may include a name indicating the place.

FIG. 24 is a diagram illustrating example states 2401 and 1502 of an electronic device 101 displaying a briefing content according to various embodiments. The electronic device 101 of FIG. 2, the electronic device 101 of FIG. 17, and/or the processor 210 of FIG. 17 may perform an operation of the electronic device 101 described with reference to FIG. 24. The operation of the electronic device 101 described with reference to FIG. 24 may be performed based on execution of the moments application 1250 of FIG. 17. The operation of the electronic device 101 described with reference to FIG. 24 may be associated with the operation 1840 of FIG. 18.

Referring to FIG. 24, a state 2401 displaying a home view provided to execution of the moments application 1250 of FIG. 17 is illustrated. In the state 2401, the electronic device 101 may display a UI object for switching to the state 1504 of FIG. 15. In the state 2401, the electronic device 101 may display a card object(s) corresponding to a briefing content(s) generated during a predetermined period (e.g., today's date). In the example state 2401 of FIG. 24, the electronic device 101 may display a text (e.g., “It must have been a really pleasant day! Seeing the photos, it is really nice to see people laughing and chatting while grilling delicious meat.”) representing summarization with respect to a cluster, together with images 1511 and 1512 included in the cluster. The electronic device 101 may display, together with the text, texts associated with time (e.g., text representing time and/or date) at which the images 1511 and 1512 are obtained and/or a place (e.g., text including a place name and/or an address). The electronic device 101 may further display a text indicating a timing at which a briefing content including the cluster and the text is generated and/or a location associated with the cluster.

Referring to an example state 2401 of FIG. 24, the electronic device 101 may display a UI object 2414 associated with a list of briefing contents. Based on a user input indicating selection of the UI object 2414, the electronic device 101 may display a popup menu 2430. The popup menu 2430 may include a list of briefing contents generated during a predetermined period. Through the popup menu 2430, the electronic device 101 may receive a user input to determine and/or select a briefing content to be displayed through the display 110.

Referring to FIG. 24, the electronic device 101 identifying a user input (e.g., an input based on a tap gesture and/or a double tap gesture) with respect to at least one of images 1511 and 1512 may provide a detailed view with respect to a briefing content including the images 1511 and 1512, as in the state 1502 of FIG. 24. Among descriptions of the state 1502 of FIG. 24, descriptions overlapping with descriptions of the state 1502 of FIG. 15 may not be repeated here.

In the state 1502 of FIG. 24, the electronic device 101 may display a text representing summarization with respect to images 1511 and 1512 (or a cluster including the images 1511 and 1512). In the state 1502 of FIG. 24, the electronic device 101 may display a time of the cluster and/or a generation time of the briefing content. In the state 1502 of FIG. 24, the electronic device 101 may display location information of the cluster.

Referring to the example state 1502 of FIG. 24, the electronic device 101 may display a UI object 2421 for generating a story content corresponding to a specific cluster, together with a detailed view for the specific cluster. The story content, which is a content set such that images and/or a video included in the cluster are sequentially played, may be video summarization with respect to the cluster. Based on a user input associated with the UI object 2421, the electronic device 101 may display a popup-window 2440 on the display 110. The popup-window 2440 may include a UI object 2441 for confirming generation of the story content. The popup-window 2440 may include a UI object 2442 for forgoing generation of the story content. For example, based on a user input associated with the UI object 2441, the electronic device 101 may generate or store a story content, which is video summarization with respect to the cluster including the images 1511 and 1512. For example, based on a user input associated with the UI object 2442, the electronic device 101 may forgo displaying the popup-window 2440, and may forgo or refrain from generating the story content. In the example, the story content generated by the electronic device 101 may be stored in memory (e.g., the memory 220 of FIG. 17) of the electronic device 101. The story content may be played by a software application for searching and/or sharing media contents, including a gallery application.

FIG. 25 is a diagram illustrating example states 1503, 2501, and 2502 of an electronic device 101 editing a briefing content according to various embodiments. The electronic device 101 of FIG. 2, the electronic device 101 of FIG. 17, and/or the processor 210 of FIG. 17 may perform an operation of the electronic device 101 described with reference to FIG. 25. The operation of the electronic device 101 described with reference to FIG. 25 may be performed based on execution of the moments application 1250 of FIG. 17.

Referring to FIG. 25, in the state 1503 displaying card objects 1531 and 1532 respectively corresponding to briefing contents, the electronic device 101 may receive a user input for editing a specific briefing content. The user input may include, for example, a long-press input with respect to the card object 1531. The user input may include an input for selecting an item for editing the briefing content in a popup menu displayed based on the long-press input. Based on the user input, the electronic device 101 may display an editing screen with respect to the briefing content, as in the state 2501.

Referring to FIG. 25, in the state 2501 displaying an editing screen, the electronic device 101 may display images in a cluster corresponding to the briefing content through a portion 2513. Thumbnail objects of the images displayed through the portion 2513 may include UI objects (e.g., a like icon and/or an icon for excluding from the cluster) for receiving feedback with respect to each image. For example, a UI object (e.g., a like icon) for selecting a representative image among the images in the cluster may be displayed on the thumbnail object. For example, a UI object (e.g., a minus icon) for removing a specific image from the cluster may be displayed on the thumbnail object.

In the example state 2501 of FIG. 25, the electronic device 101 may display a text included in a briefing content through a portion 2514. The text may indicate or represent summarization with respect to images in the briefing content obtained using the language model 255 of FIG. 17. The electronic device 101 may display UI objects 2515 and 2516 for changing the text displayed through the portion 2514. The UI object 2515 may correspond to a function of changing the text displayed through the portion 2514 by executing the language model 255 of FIG. 17 or a language model of a server connected to the electronic device 101. The UI object 2516 may correspond to a function of editing images in the cluster corresponding to a briefing content or generating another briefing content.

Referring to FIG. 25, an example state 2502 of the electronic device 101 displaying a screen for generating and/or editing a briefing content is illustrated. In the state 2502, the electronic device 101 may display a text box 2524 for obtaining texts different from the text displayed through the portion 2514. In the state 2502, the electronic device 101 may display a text box 2523 for obtaining a title of the briefing content. In the state 2502, the electronic device 101 may display a virtual keyboard 2525 for inputting text into the text boxes 2523 and 2524. In the state 2502 of FIG. 25, based on an input indicating selection of a visual object 2522 including a predetermined text such as “Save”, the electronic device 101 may generate or store a briefing content related to the text boxes 2523 and 2524 and/or images in the cluster. The disclosure is not limited thereto, and in the state 2502 of FIG. 25, based on an input indicating selection of a UI object 2521, the electronic device 101 may forgo or refrain from saving text input in the state 2502. The briefing content may be visualized in a briefing screen, such as the card objects 1531 and 1532. In order to generate the briefing content, in addition to the text input into the text boxes 2523 and 2524, state information of the electronic device 101 including weather information may be used.

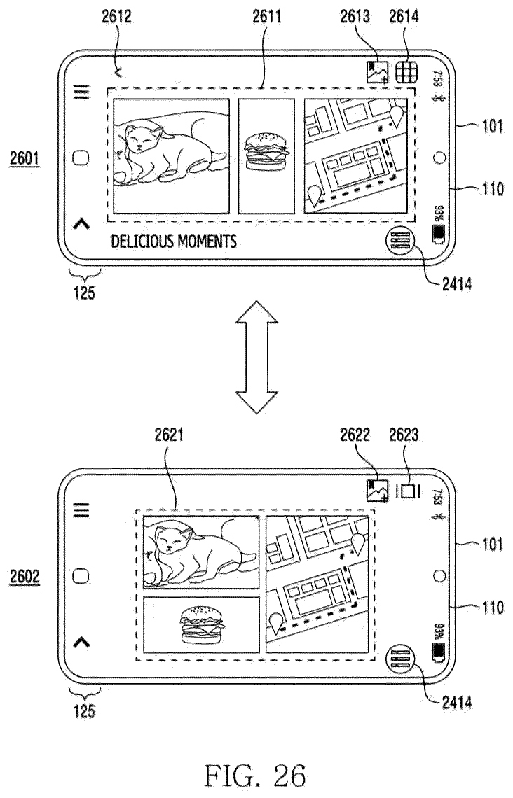

FIG. 26 is a diagram illustrating example states 2601 and 2602 of an electronic device 101 displaying a briefing content in a landscape mode according to various embodiments. The electronic device 101 of FIG. 2, the electronic device 101 of FIG. 17, and/or the processor 210 of FIG. 17 may perform an operation of the electronic device 101 described with reference to FIG. 26. The operation of the electronic device 101 described with reference to FIG. 26 may be performed based on execution of the moments application 1250 of FIG. 17. The operation of the electronic device 101 described with reference to FIG. 26 may be associated with the operation 1840 of FIG. 18.

A layout of a screen including a briefing content may be classified into a landscape mode or a portrait mode, according to an orientation of the electronic device 101. In the portrait mode, a horizontal direction and a vertical direction of the screen displayed through the display 110 may correspond to a horizontal direction and a vertical direction of the display 110. In the portrait mode, among the horizontal direction or the vertical direction of the display 110 of the electronic device 101, the vertical direction may correspond to a direction of gravitational acceleration. In the landscape mode, the horizontal direction and the vertical direction of the screen displayed through the display 110 may respectively correspond to the vertical direction and the horizontal direction of the display 110. In the landscape mode, the horizontal direction among the horizontal direction or the vertical direction of the electronic device 101 may correspond to the direction of gravitational acceleration.

In the example state 2601 of FIG. 26, the electronic device 101 may display a detailed view of a briefing content for a cluster including images 2611. In the state 2601, the electronic device 101 may display a UI object 2612 for displaying another briefing content, a UI object 2613 for generating a story content with respect to the briefing content displayed in the state 2601, and/or a UI object 2614 for displaying a grid view as in the state 1503 of FIG. 15 and/or the state 2501 of FIG. 25. The electronic device 101 may display a UI object 2414 (e.g., a UI object related to the pop-up menu 2430 of FIG. 24) for changing the briefing content displayed in the state 2601. Although the example state 2601 in which the images 2611 are arranged based on a carousel view is illustrated, the disclosure is not limited thereto.

In the example state 2602 of FIG. 26, the electronic device 101 may display a screen including images 2621 arranged based on a grid view. In the state 2602, the electronic device 101 may display or provide a detailed view of a briefing content with respect to a cluster including the images 2621. In the state 2602, the electronic device 101 may display a UI object 2622 for generating a story content and a UI object 2623 for displaying the images 2621 based on a carousel view, as in the state 2601.

As described above, according to an embodiment, the electronic device 101 may generate a text representing summarization with respect to media contents in the electronic device 101, including an image and/or a video. The electronic device 101 may generate or display a briefing content including the text and the media contents. In order to execute a language model (e.g., the language model 255 of FIG. 2 and/or FIG. 17) using limited resources, the electronic device 101 may identify a predetermined number of media contents among media contents in a cluster associated with a specific event. By executing the language model using the identified media contents, the electronic device 101 may generate or store natural language summarization with respect to the predetermined number of media contents and a briefing content including the natural language summarization using relatively few resources.

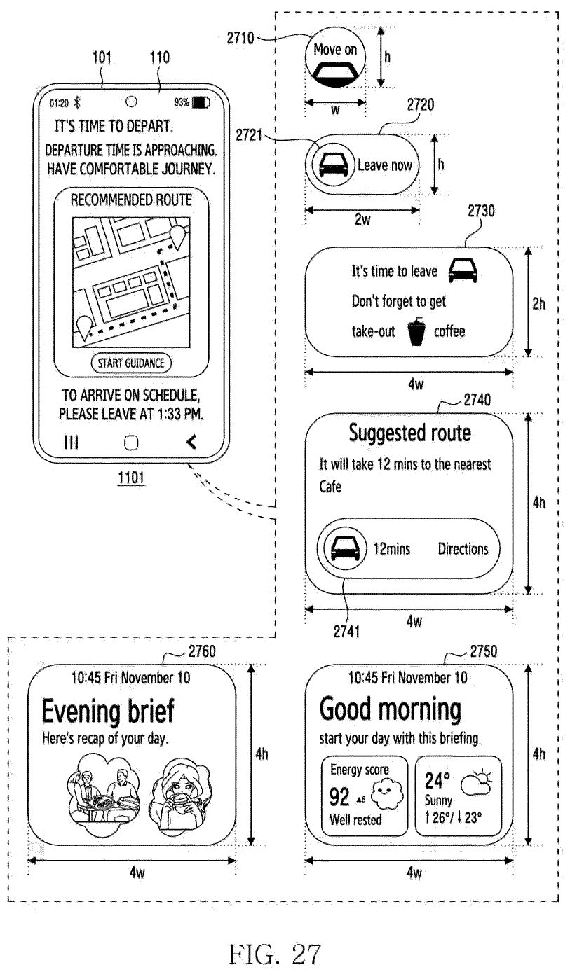

FIG. 27 is a diagram illustrating an example operation of the electronic device 101 displaying a widget object (e.g., widget objects 2710, 2720, 2730, 2740, 2750, and 2760) based on a content of a briefing screen. The electronic device 101 of FIG. 27 may include the electronic device 101 of FIG. 1 and/or FIG. 2, and/or the electronic device 101 of FIG. 15 and/or FIG. 17. An example hardware configuration of the electronic device 101 of FIG. 27 is described in greater detail with reference to FIG. 2.

Referring to FIG. 27, an example state 1101 of the electronic device 101 displaying a briefing screen is illustrated. The briefing screen of FIG. 27 may be displayed by the electronic device 101 executing the smart suggestion application 260 of FIG. 2. In a state (e.g., a state displaying a home screen (or launcher screen) and/or a lock screen, as in the states 191 and 192 of FIG. 1) different from the state 1101 displaying the briefing screen including a content(s), the electronic device 101 may provide summarization with respect to a content(s) included in the briefing screen. The summarization may include a natural language sentence(s) summarized using personalized data, as described above with reference to FIGS. 1 to 14 (e.g., in FIG. 27, “Leave at 1:33 PM to arrive on schedule.”).

In an embodiment, the electronic device 101 may provide summarization with respect to a content(s) included in a briefing screen, using example widget objects 2710, 2720, 2730, 2740, 2750, and 2760 illustrated in FIG. 27. Referring to FIG. 27, widget objects 2710, 2720, 2730, 2740, 2750, and 2760 having various widths and heights are illustrated. A unit width w and a unit height h may respectively correspond to a width and a height of one icon at a home screen. The disclosure is not limited thereto, and the unit width w and the unit height h may respectively correspond to a width and a height of a unit slot and/or a unit grid used to arrange widget objects and/or icons at the home screen.

According to an embodiment, the electronic device 101 may generate an image, text, or any combinations thereof representing summarization with respect to a content(s) included in a briefing screen, according to a size of a widget object arranged at a home screen and/or a lock screen. Widget objects 2710, 2720, 2730, and 2740 of FIG. 27 may respectively include example summarizations obtained based on a content notifying a travel schedule included in the briefing screen.

For example, when displaying a widget object 2710 having the smallest size (e.g., the unit width w and the unit height h), the electronic device 101 may display a text (e.g., “Move on”) of a first length based on a width w and a height h of the widget object 2710. Together with the text of the first length, the electronic device 101 may display an icon (e.g., an icon having a shape of a vehicle) located below the text. When displaying a widget object having a relatively small size such as the widget object 2710, the electronic device 101 may display an icon reduced or cropped according to a size of the widget object.

For example, when displaying a widget object 2720 having a larger size (e.g., a width of 2×w and a unit height h) than the widget object 2710, the electronic device 101 may display, through the widget object 2720, a text of a second length (e.g., “Leave now”) longer than the first length. Together with the text of the second length, the electronic device 101 may display an icon 2721 located next to the text of the second length, within the widget object 2720.

For example, when displaying a widget object 2730 having a larger size (e.g., a width of 4×w and a height of 2×h) than the widget object 2720, the electronic device 101 may embed a text of a third length longer than the second length, within the widget object 2730. The text of the third length may include not only a text representing summarization for a moving schedule (e.g., “It's time to leave”) but also a text (e.g., “take-out coffee”) representing summarization for another contents of the briefing screen. Within the widget object 2730, not only the text of the third length but also one or more icons may be displayed.

For example, Table 5 may include example texts in the widget object 2720 generated using the text displayed on the briefing screen. The text in the widget object 2720 illustrated in Table 5 may be obtained using a language model or using a mapping table based on a relation of Table 5.

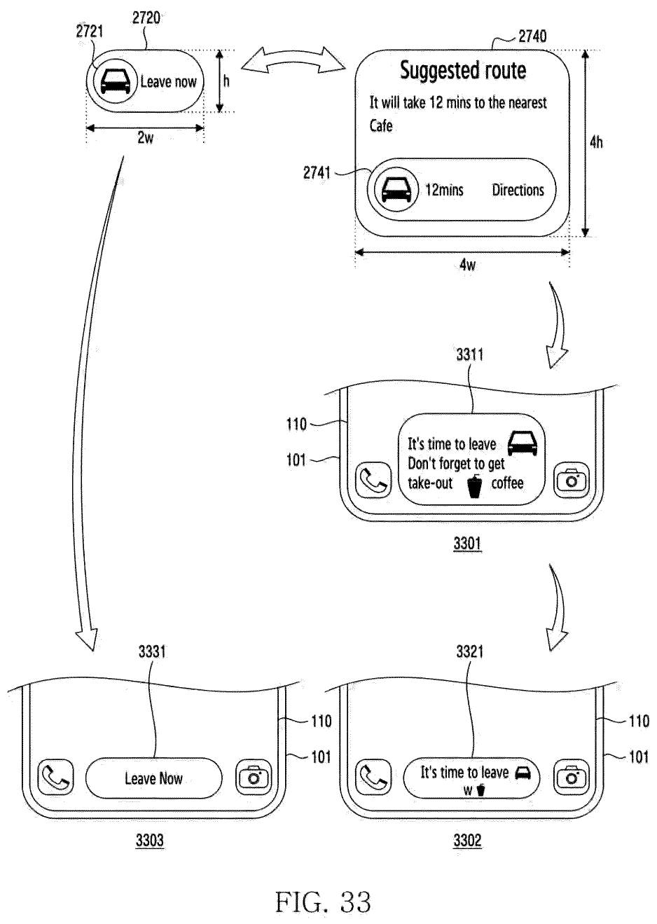

TABLE 5

| | | | Text in Now bar |
|---|---|---|---|
| | | | (e.g., widget |
| | Text of briefing | Text in widget | objects 3331 and |
| Current time | screen | object 2720 | 3321 of FIG. 33) |
| Dawn | Get ready for the | Early bird | A new day is here |
| (04:00-06:00) | new day. | | Hello early bird |
| (Morning-specialized) | It's sunny outside. | | Sunny morning |
| Weather | Enjoy a bright start | | |
| | to your day. | | |
| Early morning | Start your day with | Good morning | Good morning |
| (06:00-09:00) | this briefing. | | |
| | Have a refreshing | | |
| | morning. | | |
| Late morning | Start your day with | Morning brief | Morning brief |
| (09:00-12:00) | this briefing. | | |
| Early afternoon | Enjoy the rest of | Good afternoon | Good afternoon |
| (12:00-15:00) | your day. | Midday brief | Midday brief |
| Late afternoon | Enjoy the rest of | Good day | Have a good day |
| (15:00-18:00) | your day. | | |
| | Hope your day is | | |
| | going as planned. | | |
| Evening | Here's a recap of | Good evening | Good evening |
| (18:00-22:00) | your day. | | |
| | Here's what | Evening brief | Evening brief |
| | happened today. | | |
| | | | Evening check-in |
| Night | Enjoy a peaceful | Night recap | Late night recap |
| (22:00-04:00) | and restful night. | | |
| | | Night owl | Tonight's brief |
| Travel theme | Make special | Travel insights | Travel insights |
| | memories and have | | Enjoy your trip |
| | a safe journey. | | |
| TTL | Check your route | Time to go | Time to go |
| | and drive safely. | Leave now | Leave now |
| During commute | Here are some | | For your commute |
| | things to check | | |
| | before you leave. | | |
| Info recommendation | | Check brief | |
| Urgent check | | Brief ready | |
| Useful recommendation | | New updates | |
| General situation | | View briefing | |

For example, when displaying a widget object 2740 having a larger size (e.g., a width of 4×w and a height of 4×h) than the widget object 2730, the electronic device 101 may display, through the widget object 2740, a text (e.g., “Suggested route” and/or “It will take 12 mins to the nearest Cafe”) indicating summarization with respect to a content(s) included in a briefing screen. The electronic device 101 may display, together with the text, a UI object 2741 for executing a software application (e.g., a navigation application for assisting movement of a user of the electronic device 101) associated with the summarization displayed through the widget object 2740 within the widget object 2740. Based on receiving a user input associated with the UI object 2741, the electronic device 101 may execute the software application. The electronic device 101 may display, through the display 110, a screen provided from the software application.

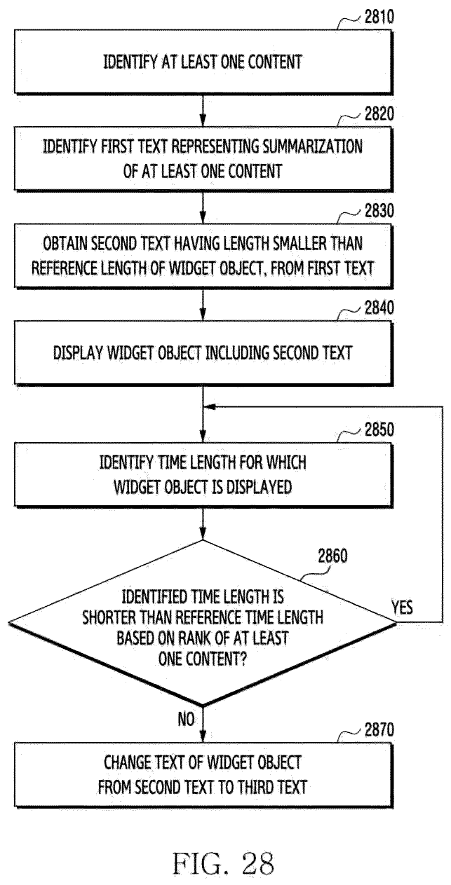

As described above with reference to the widget objects 2710, 2720, 2730, and 2740, the electronic device 101 may generate or display a text having a length based on a size of a widget object. After displaying a widget object including the text, the electronic device 101 may estimate whether information (e.g., information represented by the text) included in the widget object is recognized by a user of the electronic device 101. Based on the estimation, the electronic device 101 may change or maintain the information included in the widget object. Example operations in which the electronic device 101 changes and/or maintains the information included in the widget object are described in greater detail below with reference to FIGS. 28 to 34.

Referring to FIG. 27, example widget objects 2750 and 2760 displayed by the electronic device 101 are illustrated. The electronic device 101 may display a widget object including summarizations with respect to different contents (e.g., content including an energy score based on health information and content including weather information) of a briefing screen, such as the widget object 2750. Based on displaying a widget object having a size capable of providing summarizations with respect to a plurality of contents, such as the widget object 2750, the electronic device 101 may display summarizations with respect to the plurality of contents through the widget object. The electronic device 101 may display, through a widget object, summarization with respect to a briefing content (e.g., briefing content generated based on the operations described with reference to FIGS. 15 to 26) based on an image and/or a video stored in the electronic device 101, such as the widget object 2760. The electronic device 101 receiving a user input associated with a widget object (e.g., the widget objects 2710, 2720, 2730, 2740, 2750, and 2760) may switch to a state displaying a briefing screen (e.g., a screen including at least one content corresponding to a text included in the widget object), as in the state 1101 of FIG. 27.

As described above, according to an embodiment, the electronic device 101 may identify a first text representing summarization of at least one content. The first text (e.g., “Leave at 1:33 PM to arrive on schedule.”) may be displayed in a briefing screen, together with the at least one content. The electronic device 101 may obtain a second text having a length smaller than a reference length of a widget object, from the first text. Based on displaying a home screen including the widget object, the electronic device 101 may display the obtained second text within the widget object. While displaying the obtained second text within the widget object, the electronic device 101 may identify a time length for displaying the widget object including the second text. When the time length is longer than a reference time length associated with a rank of the at least one content, the electronic device 101 may change a text in the widget object from the second text to a third text (e.g., text representing summarization with respect to another content and having a length smaller than the reference length). While displaying the widget object including the second text, based on a user input associated with the widget object, the electronic device 101 may display, through the display 110, a screen (e.g., briefing screen) including the first text and the at least one content.

FIG. 28 is a flowchart illustrating an example operation of an electronic device according to various embodiments. The electronic device 101 of FIG. 2, the electronic device 101 of FIG. 17, the electronic device 101 of FIG. 27, and/or the processor 210 of FIG. 2 may perform operations of FIG. 28. An order in which the operations of FIG. 28 are performed may differ from the example order of FIG. 28. For example, the electronic device 101 of FIG. 25 and/or the processor 210 of FIG. 2 may perform the operations of FIG. 28 in an order different from the order illustrated in FIG. 28. For example, the electronic device 101 of FIG. 25 and/or the processor 210 of FIG. 2 may perform at least two operations of FIG. 28 substantially concurrently. The operations of FIG. 28 may be performed by the electronic device executing the smart suggestion application 260 of FIG. 2.

Referring to FIG. 28, in operation 2810, the electronic device according to an embodiment may identify at least one content. The at least one content may be generated from software applications executed by the electronic device. The at least one content of the operation 2810 may be a content stored in the document DB 250 of FIG. 2.

Referring to FIG. 28, in operation 2820, the electronic device according to an embodiment may identify a first text representing summarization of the at least one content. For example, the electronic device may identify the first text of the operation 2820 by executing a language model (e.g., the language model 255 of FIG. 2). The first text may be used to display summarization with respect to the at least one content in a briefing screen.

Referring to FIG. 28, in operation 2830, the electronic device according to an embodiment may obtain a second text having a length smaller than a reference length of a widget object, from the first text. The electronic device may obtain the second text having a length smaller than the reference length of the widget object, using main information represented by the first text. The reference length may be associated with a size of the widget object. For example, the reference length may be proportional to the size of the widget object. When the size of the widget object is large (or when the reference length is long), the electronic device may obtain or generate the second text of the operation 2830, using the main information and additional information represented by the first text. Since the reference length is associated with the size of the widget object, the second text obtained based on the operation 2830 may have a length suitable for being displayed through the widget object.

Referring to FIG. 28, in operation 2840, the electronic device according to an embodiment may display a widget object including the second text. For example, based on displaying a home screen including the widget object, the electronic device may display, within the widget object, the second text obtained based on the operation 2830. While displaying a widget object including the second text, when receiving a user input associated with the widget object, the electronic device may display or output a screen (e.g., a briefing screen displayed in the state 1101 of FIG. 11) including the at least one content and the first text.

Referring to FIG. 28, in operation 2850, the electronic device according to an embodiment may identify a time length for which the widget object is displayed. For example, the electronic device may identify or check a time length for which the widget object including the second text being displayed based on the operation 2840 is displayed.

Referring to FIG. 28, in operation 2860, the electronic device according to an embodiment may check whether a time length identified based on the operation 2850 is shorter than a reference time length based on a rank of at least one content. When the time length of the operation 2850 is shorter than the time length of the operation 2860 (in 2860-YES), the electronic device may maintain displaying the widget object including the second text. When the time length of the operation 2850 is equal to or longer than the time length of the operation 2860 (in 2860-NO), the electronic device may perform operation 2870.

Referring to FIG. 28, in the operation 2870, the electronic device according to an embodiment may change a text of the widget object from the second text to a third text. The third text may include a default text (e.g., text indicating a current time) assigned to the widget object. The third text may represent summarization of another content different from the at least one content identified based on the operation 2810. A length of the third text may be equal to or smaller than the reference length of the operation 2830.

Referring to FIG. 28, in a state where the time length of the operation 2850 is shorter than the time length of the operation 2860, the widget object including the second text may be displayed continuously. While displaying the widget object including the second text, the electronic device may change a rank (or importance level) of at least one content corresponding to the second text according to a time length for which the widget object is displayed (e.g., decrease). For example, the electronic device may determine or change a rank of the at least one content based on a rank score of Equation 1. For example, according to a size of a widget object and/or a time length for which the widget object is displayed, the electronic device may gradually decrease the rank of the at least one content corresponding to the second text included in the widget object. For example, the electronic device may determine or change the rank of the at least one content corresponding to the second text, according to a user preference (e.g., a preference measured based on the number of accesses) of for the at least one content corresponding to the second text.

While displaying the widget object including the second text, another content different from the at least one content of the operation 2810 may be generated or identified. The electronic device having identified the other content may identify a rank of the other content. When the rank of the other content is lower than the rank of the at least one content corresponding to the second text, the electronic device may maintain displaying the second text within the widget object. When the rank of the other content is higher than the rank of the at least one content corresponding to the second text, the electronic device may change the second text being displayed within the widget object to a fourth text associated with the other content. When receiving a user input associated with a widget object including the fourth text, the electronic device may display, through the display, a briefing screen in which the other content is located above the at least one content.

As described above, according to an embodiment, the electronic device may generate a text representing summarization of at least one content. A length of the text may be associated with a size of a widget object. Using a text having a length suitable for the size of the widget object, the electronic device may automatically generate or display summarization of the at least one content. While displaying the text, the electronic device may change or maintain the text, based on a recognizability with respect to the text by a user and/or generation of other content.

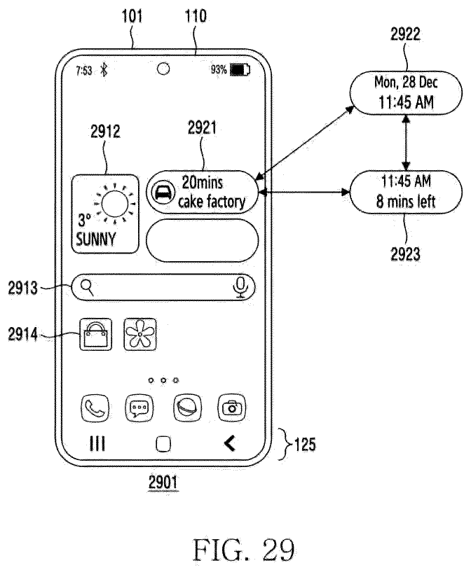

FIG. 29 is a diagram illustrating an example operation of the electronic device 101 displaying a widget object according to various embodiments. The electronic device 101 of FIG. 2, the electronic device 101 of FIG. 17, the electronic device 101 of FIG. 27, and/or the processor 210 of FIG. 2 may perform operations of FIG. 29. For example, the operation of the electronic device 101 described with reference to FIG. 29 may be associated with the operations of FIG. 28.

Referring to FIG. 29, an example state 2901 of the electronic device 101 displaying a home screen is illustrated. The home screen may include widget objects 2921, 2912, and 2913 provided from different software applications and/or an icon 2914 for executing a software application. Although the example state 2901 of the electronic device 101 displaying a widget object 2912 provided from a weather application and a widget object 2913 provided from a search application is illustrated, a type, a number, and/or a category of widget objects capable of being displayed through the home screen is not limited thereto.

Referring to the example state 2901 of FIG. 29, the electronic device 101 may display a widget object 2921 including a text based on the operations described with reference to FIGS. 27 to 28. The widget object 2921 may include a first text (e.g., “20 mins cake factory”) representing summarization with respect to a first content (e.g., a content generated based on a calendar application) for notifying a moving schedule. While displaying the widget object 2921 including the first text, the electronic device 101 may calculate or change a rank (e.g., a rank score calculated based on Equation 1) of the first content using a time length for displaying the widget object 2921. The rank of Equation 1 may be decreased according to the time length of the widget object 2921.

In an embodiment, a maximum time length for which the widget object 2921 including the first text is displayed may be shorter than a reference time length based on the rank. For example, when a time length for which the widget object 2921 is displayed is equal to or longer than the reference time length, the electronic device 101 may display a widget object 2922 including a default text (e.g., text representing a time and/or a date). The widget object 2922 may be displayed at a location within the home screen where the widget object 2921 was displayed. A size of the widget object 2922 may be the same as or similar to a size of the widget object 2921.

In an embodiment, the widget object 2921 including the first text may be displayed until receiving a user input associated with the widget object 2921. Based on receiving the user input, the electronic device 101 may display a briefing screen (e.g., a briefing screen displayed through the display 110 in the state 1101 of FIG. 27). After receiving the user input, based on displaying the home screen, the electronic device 101 may display the widget object 2922 including the default text as a replacement of the widget object 2921.

In an embodiment, while displaying the widget object 2921 including the first text, the electronic device 101 may track or identify a gaze of a user. For example, the electronic device 101 may include a camera disposed on a surface (e.g., a front surface of the electronic device 101) where the display 110 is located. Using an image and/or a video obtained from the camera, the electronic device 101 may identify or detect a gaze of a user viewing the display 110. Using information indicating the gaze of the user based on the camera, the electronic device 101 may identify or determine whether the user is gazing at the widget object 2921. Based on identifying the gaze associated with the widget object 2921 using the information, the electronic device 101 may perform an operation (e.g., displaying a briefing screen) associated with the widget object 2921. Based on identifying the gaze associated with the widget object 2921 using the information, the electronic device 101 may change the widget object 2921 (e.g., change to the widget object 2922 including default text). Based on identifying the gaze associated with the widget object 2921 using the information, the electronic device 101 may perform the illustrated operation (e.g., an operation of displaying the briefing screen and/or an operation of changing the widget object 2921 to the widget object 2922), based on whether the gaze is maintained for a predetermined period (e.g., a period of about 5 seconds).

In an embodiment, during a reference time length corresponding to the first content, the electronic device 101 may display not only the widget object 2921 including the first text based on the first content but also a widget object 2923 including the second text based on the first content. The widget object 2923 may be displayed, as a replacement of the widget object 2921, at a location within the home screen where the widget object 2921 is being displayed. For example, after displaying the widget object 2921, when the electronic device 101 does not receive a user input associated with the widget object 2921 during a time length shorter than the reference time length, the electronic device 101 may change the widget object 2921 displayed on the home screen to the widget object 2923. When a sum of a time length for which the widget object 2923 is displayed and a time length for which the widget object 2921 is displayed is equal to or longer than the reference time length, the electronic device 101 may display the widget object 2922 including default text.

In an embodiment, during a reference time length corresponding to the first content, the electronic device 101 may change or maintain the widget object 2921 based on a user input associated with the widget object 2921. For example, in the state 2901 displaying the widget object 2921 including the first text associated with a moving schedule, based on a user input for executing a software application (e.g., a navigation application) associated with the moving schedule, the electronic device 101 may change or reduce a rank of the first content associated with the first text. Based on the changed rank, the electronic device 101 may change the widget object 2921 being displayed on the home screen to another widget object (e.g., widget object 2922 and/or widget object 2923 including default text).

Although an embodiment providing summarization of a content(s) using a text and/or an icon within a widget object (e.g., widget objects 2921, 2922, and 2923) being displayed on the home screen is described, the disclosure is not limited thereto. For example, the electronic device 101 may display or insert summarization of the content(s), within a widget object within a lock screen, referred to as a Now bar. An example operation of the electronic device 101 displaying summarization of the content(s) using the widget object within the lock screen is described in greater detail below with reference to FIG. 33.

Referring to FIG. 29, in a home screen including various objects (e.g., the widget objects 2912 and 2913 and/or the icon 2914) including the widget object 2921, an empty region may exist in a region adjacent to the widget object 2921 (in the example state 2901 of FIG. 29, an upper portion of the widget object 2921). According to an embodiment, the electronic device 101 may change (e.g., enlarge and/or reduce) a size of the widget object 2921, based on an empty region adjacent to the widget object 2921 and/or an importance level of content corresponding to a text included in the widget object 2921.

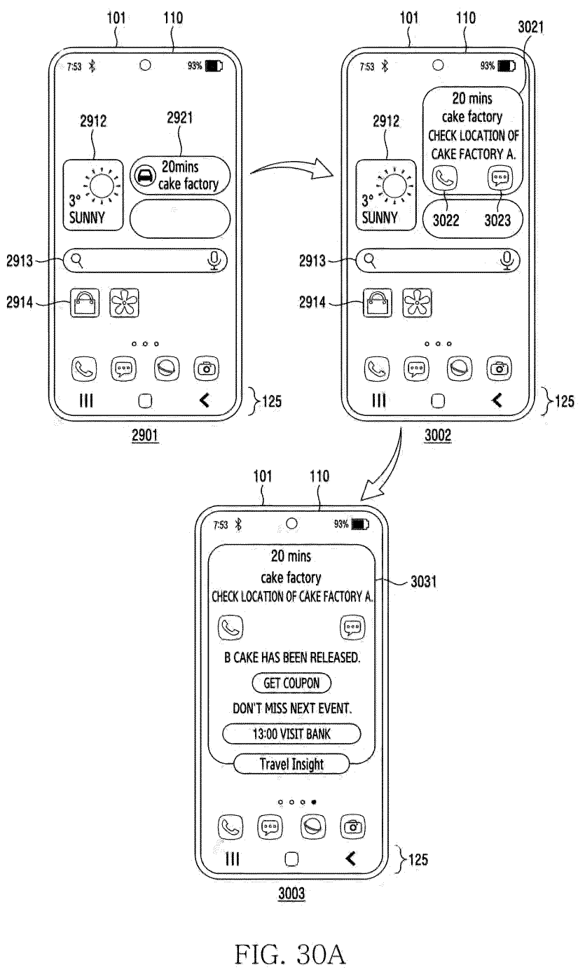

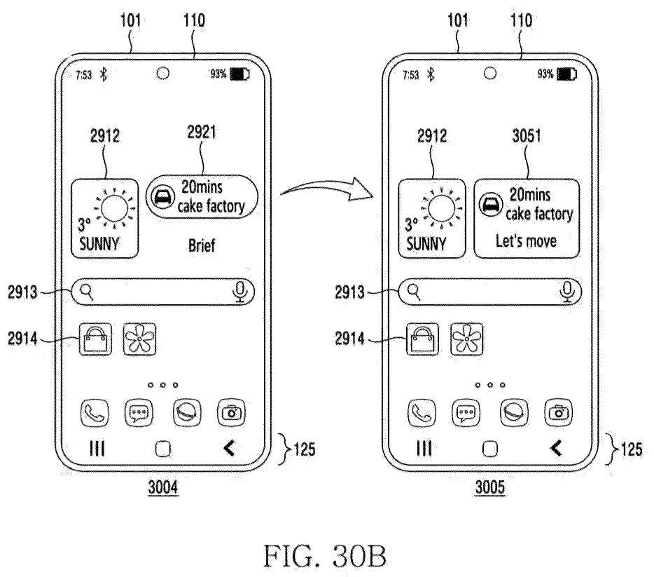

Hereinafter, an example operation of the electronic device 101 for changing the size of the widget object 2921 will be described in greater detail with reference to FIGS. 30A and/or 30B.

FIGS. 30A and 30B are diagrams illustrating example operations of the electronic device 101 displaying a widget object having a variable size according to various embodiments. The electronic device 101 of FIG. 2, the electronic device 101 of FIG. 17, the electronic device 101 of FIG. 27, and/or the processor 210 of FIG. 2 may perform operations of the electronic device 101 described with reference to FIGS. 30A and/or 30B. The operations of the electronic device 101 described with reference to FIGS. 30A and/or 30B may be associated with the operations of FIG. 28.

Referring to FIG. 30A, a state 2901 of the electronic device 101 displaying a home screen including a widget object 2921 is illustrated. The state 2901 of FIG. 30A may correspond to the state 2901 of FIG. 29. In the state 2901 displaying a first text representing summarization of a content indicating a moving schedule, the electronic device 101 may determine a size of the widget object 2921, according to a rank of the content. For example, in the state 2901 displaying the widget object 2921 having a first size (e.g., a width of 2×w and a height of h) with respect to a unit width w and a unit height h of the home screen, the electronic device 101 may determine whether to increase, maintain, or decrease the first size of the widget object 2921.

Referring to FIG. 30A, while displaying the home screen including the widget object 2921 of the first size, the electronic device 101 may change a size of the widget object 2921 to a second size larger than the first size, according to the rank of the content corresponding to the first text. In a state 3002 of FIG. 30A, the electronic device 101 may display a widget object 3021 having a second size (e.g., a width of 2×w and a height of 2×h). For example, when the rank of the content indicating the moving schedule is increased according to a time interval of the moving schedule (e.g., a time interval when the user needs to depart), the electronic device 101 may change the widget object 2921 of the first size to the widget object 3021 of the second size. In the widget object 3021 of the second size, the electronic device 101 may display a text (e.g., “Check a location of cake factory A in 20 mins”) associated with the content.

Referring to FIG. 30A, in the state 3002 displaying the widget object 3021 of the second size, the electronic device 101 may display an UI object (e.g., icons 3022 and 3023) for executing a software application associated with the widget object 3021. Based on displaying the widget object 3021 larger than the widget object 2921, the electronic device 101 may add, to the widget object 3021, a second text (e.g., text further including a natural language sentence such as “Check a location of A”) longer than the first text, which was included in the widget object 2921. For example, the icon 3022 may be displayed to execute a call application. For example, the icon 3023 may be arranged at he widget object 3021 to execute a messenger application. In the state 3002, based on receiving a user input associated with the widget object 3021, the electronic device 101 may reduce a rank of content associated with the widget object 3021 or may display the widget object 2921 of the first size, as in the state 3901.

Referring to the states 2901 and 3002 of FIG. 30A, since the electronic device 101 arranges not only the widget object 2921 but also another object (e.g., widget objects 2912 and 2913 and/or icon 2914) within a home screen, the electronic device 101 may enlarge a size of the widget object 2921, according to a location relationship between the widget object 2921 and the other objects. In the example state 2901 of FIG. 30A, the electronic device 101 identifying an empty region of an upper portion of the widget object 2921 may display a widget object 3021 of a second size occupying the upper portion. In the home screen, the electronic device 101 may enlarge the widget object 2921 using information indicating a location relationship of objects including the widget object 2921 and may determine a location of the enlarged widget object 2921 (e.g., the widget object 3021).

In an embodiment, a home screen may include switchable pages (or regions referred to as page view and/or container). In the state 3002 displaying the widget object 3021 through a specific page view, in order to display a widget object having a size larger than the widget object 3021, the electronic device 101 may generate or add a page different from a page on which the widget object 3021 is arranged. The electronic device 101 may display the widget object 3031 having a size larger than the widget object 3021 on the generated page. A state 3003 of FIG. 30A 30 may be a state of displaying a home screen including the widget object 3031. For example, when a rank of a content corresponding to the widget object 3021 is increased, the electronic device 101 may display the widget object 3031 having a size larger than the widget object 3021, by switching to the state 3003. Although an example case in which a size of the widget object 2921 is sequentially increased based on states 2901, 3002, and 3003 is illustrated, the disclosure is not limited thereto, and the electronic device 101 may directly switch from the state 2901 displaying the widget object 2921 of the first size to the state 3003 displaying the widget object 3031.

Referring to FIG. 30A, in a state (e.g., states 2901, 3002, and 3003) of displaying a widget object (e.g., widget objects 2921, 3021, and 3031) including a text representing summarization of a specific content, the electronic device 101 may determine a rank of the content and/or a reference time length (e.g., the reference time length of FIG. 28) used to display the text, using a time and/or a size in which the widget object is displayed through the display 110. For example, as a size of the widget object increases, since a possibility that the widget object is recognized by a user increases, the electronic device 101 may reduce the reference time length and/or increase a speed (e.g., a rate of change) of decreasing the rank according to a time length in which the widget object is displayed. The disclosure is not limited thereto, and the electronic device 101 may visually emphasize the widget object, by changing a color of the widget object and/or applying a visual effect (e.g., a blinking effect based on a periodic change of the color) to the widget object.

Referring to FIG. 30B, an example state 3004 of the electronic device 101 displaying a home screen including the widget object 2921 is illustrated. In the state 3004, the electronic device 101 may display the widget object 2921 and a text (e.g., “Brief”) indicating a name of the widget object 2921 on the home screen. In the state 3004 displaying the widget object 2921 of the first size, the electronic device 101 may determine whether to change a size of the widget object 2921 to a second size greater than the first size, according to a rank of content. The electronic device 101 determining to change the size of the widget object 2921 to the second size may switch to the state 3005 of FIG. 30B.

Referring to a state 3005 of FIG. 30B, the electronic device 101 may display a widget object 3051 enlarged up to a location where a text indicating a name of the widget object 2921 was displayed. Through the widget object 3051 having a second size larger than the first size of the widget object 2921, the electronic device 101 may provide summarization of a content(s). For example, the electronic device 101 identifying summarization longer than summarization displayed in the widget object 2921 may display a text and/or an image representing the identified summarization using the widget object 3051.

In an embodiment, the electronic device 101 may change a corner radius of the widget object 2921. Referring to FIG. 30B, in a state 3004 displaying the widget object 2921 having a first corner radius, the electronic device 101 may display a first text. In the state 3004 of FIG. 30B, the electronic device 101 identifying a second text longer than the first text may display a widget object 3051 having a second corner radius smaller than the first corner radius. The electronic device 101 may display the second text in the widget object 3051. By changing the corner radius, the electronic device 101 may further display a longer text (or shorter text) or a graphical object while maintaining a width and a height of a widget object (e.g., widget objects 2921 and 3051).

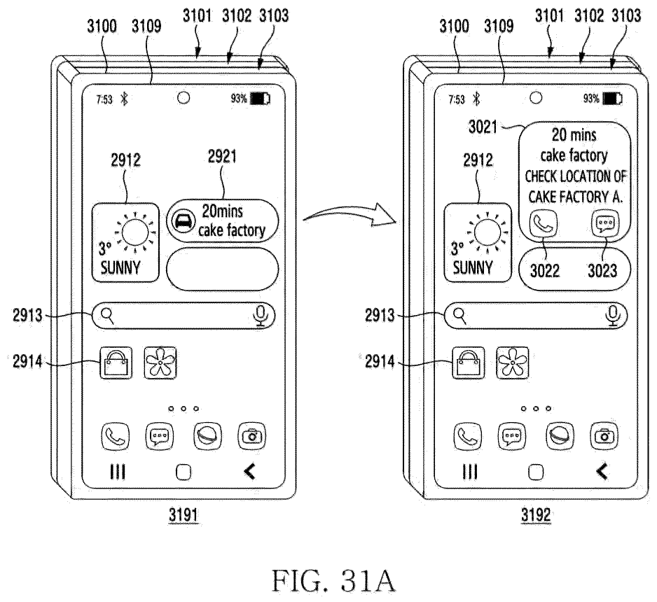

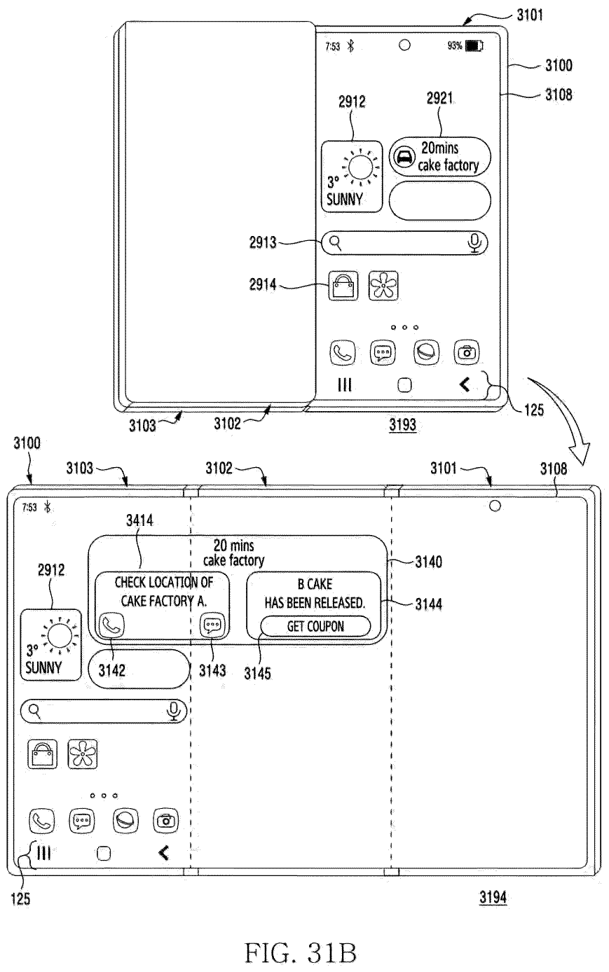

Hereinafter, example operations of the electronic device 101 having a form factor different from a bar-type smartphone will be described in greater detail with reference to FIGS. 31A, 31B, and/or 32.

FIGS. 31A and 31B are diagrams illustrating example states 3191 and 3192 of a multi-foldable electronic device 3100 displaying a widget object 2921 according to various embodiments. The electronic device 101 of FIG. 2, the electronic device 101 of FIG. 17, the electronic device 101 of FIG. 27, and/or the processor 210 of FIG. 2 may perform operations of the multi-foldable electronic device 3100 described with reference to FIGS. 31A and/or 31B. The operations of the multi-foldable electronic device 3100 described with reference to FIGS. 31A and/or 31B may be associated with the operations of FIG. 28.

The multi-foldable electronic device 3100 described with reference to FIGS. 31A and/or 31B may include housing parts 3101, 3102, and 3103 connected through rotatable hinge assemblies. A first housing part 3101 may be rotatably coupled to a second housing part 3102. The second housing part 3102 may be rotatably coupled to a third housing part 3103. The multi-foldable electronic device 3100 may include a flexible display 3108 extending from the first housing part 3101 across the second housing part 3102 to the third housing part 3103. A state of the multi-foldable electronic device 3100 may be classified according to folding and/or unfolding of the housing parts 3101, 3102, and 3103.

Referring to FIG. 31A, states 3191 and 3192 of the multi-foldable electronic device 3100 included in a folded state (e.g., fully folded state) of the multi-foldable electronic device 3100 are illustrated. The folded state may include a state in which the flexible display 3108 is not visible according to folding of the housing parts 3101, 3102, and 3103. The multi-foldable electronic device 3100 may include a cover display 3109 located at a rear surface (e.g., a rear surface of the third housing part 3103) opposite to a front surface on which the flexible display 3108 is disposed. In the present disclosure, the flexible display 3108 and the cover display 3109 may be respectively referred to as a first display and a second display.

In the state 3191 of FIG. 31A, the multi-foldable electronic device 3100 may display a home screen through the cover display 3109. Referring to FIG. 31A, the example state 3191 displaying a home screen similar to the state 2901 of FIG. 29 and/or FIG. 30A is illustrated. In the state 3191, the multi-foldable electronic device 3100 may display the widget object 2921 including a text representing summarization of at least a content. The text may be generated based on operations described with reference to FIGS. 27 to 28.

In the state 3191 of FIG. 31A, the multi-foldable electronic device 3100 may change or maintain a size of the widget object 2921, using a rank (e.g., a rank based on a rank score of Equation 1) of the at least a content. For example, the multi-foldable electronic device 3100 identifying that the rank increases (e.g., increases by exceeding a threshold), the multi-foldable electronic device 3100 may display a widget object 3021 having a size larger than the widget object 2921 as in the state 3192. The widget object 3021 may include icons 3022 and 3023 described with reference to FIG. 30A. Although an example operation of increasing the size of the widget object 2921 at a specific page of the home screen is described, the disclosure is not limited thereto. For example, the multi-foldable electronic device 3100 may add a new page to the home screen. In the example, the multi-foldable electronic device 3100 may display, at the added page, the widget object 2921 or a widget object (e.g., the widget object 3031 of FIG. 30A) having a size larger than the widget object 2921.

According to an embodiment, the multi-foldable electronic device 3100 may identify a form of the multi-foldable electronic device 3100 that is changed according to a rotation of housing parts 3101, 3102, and 3103 (e.g., a rotation for folding and/or unfolding at least two of the housing parts 3101, 3102, and 3103). According to the form, the multi-foldable electronic device 3100 may switch from the folded state illustrated in FIG. 31A to another state.

Referring to FIG. 31B, a state 3193 included in a half-folded state of the multi-foldable electronic device 3100 and a state 3194 included in an unfolded state (or fully unfolded state) of the multi-foldable electronic device 3100 are illustrated.

In a half-folded state, an angle between the first housing part 3101 and the second housing part 3102 may be substantially 180°, and an angle between the second housing part 3102 and the third housing part 3103 may be substantially 0°. Referring to the example state 3193 of FIG. 31B, in the half-folded state, a portion of the flexible display 3108 disposed at the second housing part 3102 may face a portion of the flexible display 3108 disposed at the third housing part 3103. Referring to the example state 3193 of FIG. 31B, in the flexible display 3108 disposed at a front surface of the housing parts 3101, 3102, and 3103, a portion disposed on the first housing part 3101 may be visible. In other words, in the half-folded state, a remaining portion different from the portion of the flexible display 3108 disposed at the first housing part 3101 may be invisible. In the half-folded state, the multi-foldable electronic device 3100 may deactivate the cover display 3109 and may display a screen through the portion of the flexible display 3108 located on the first housing part 3101.

Referring to the example state 3194 of FIG. 31B, in the unfolded state, all angles between the housing parts 3101, 3102, and 3103 may be 180°. In the unfolded state, the entire flexible display 3108 may have a flat form. In the unfolded state, the multi-foldable electronic device 3100 may deactivate the cover display 3109 and may display a screen through an entire display region of the flexible display 3108.

Referring to FIG. 31B, in the state 3193 included in the half-folded state, the multi-foldable electronic device 3100 may display a home screen at a portion of the flexible display 3108 located on the first housing part 3101. Similar to the state 3191 of FIG. 31A, the multi-foldable electronic device 3100 may display a home screen including the widget object 2921. Referring to FIG. 31B, in the state 3194 included in the unfolded state, a size of the home screen may have a size larger than sizes in the other states 3191, 3192, and 3193.

In an embodiment, the multi-foldable electronic device 3100 may change or enlarge a size of the widget object 2921, according to a size of the home screen and/or a rank of the content. For example, based on switching from the state 3193 included in the half-folded state to the state 3194 included in the unfolded state, the multi-foldable electronic device 3100 may identify that the size of the home screen increases to a size of the entire display region of the flexible display 3108. The multi-foldable electronic device 3100 identifying that the size of the home screen increases may enlarge the widget object 2921 using a blank region in the home screen. For example, according to a rank of a content corresponding to a text displayed through the widget object 2921, the multi-foldable electronic device 3100 may determine whether to enlarge the widget object 2921 in the unfolded state.

The state 3194 of FIG. 31B may be an example state of the multi-foldable electronic device 3100 displaying a widget object 3140, which is an enlarged version of the widget object 2921 according to determining to enlarge the widget object 2921. The example state 3194 of the multi-foldable electronic device 3100 in which the widget object 3140 having a size larger than the widget object 2921 is displayed at a portion of the flexible display 3108 located on the second housing part 3102 and the third housing part 3103 is illustrated. The multi-foldable electronic device 3100 may display card objects 3414 and 3144 respectively corresponding to different contents in the widget object 3140. The card object 3414 may include icons 3142 and 3143 for executing a software application(s) associated with a content corresponding to the card object 3414. The card object 3144 may include an icon 3145 for executing a software application associated with a content corresponding to the card object 3144. In response to a touch input with respect to a portion of the widget object 3140 different from the icons 3142, 3143, and 3145, the multi-foldable electronic device 3100 may display a briefing screen (e.g., the briefing screen displayed in the state 1101 of FIG. 27). The multi-foldable electronic device 3100 may reduce or maintain a size of the widget object 3140, according to a rank of the content displayed through the widget object 3140 and/or a time interval set to display the content.

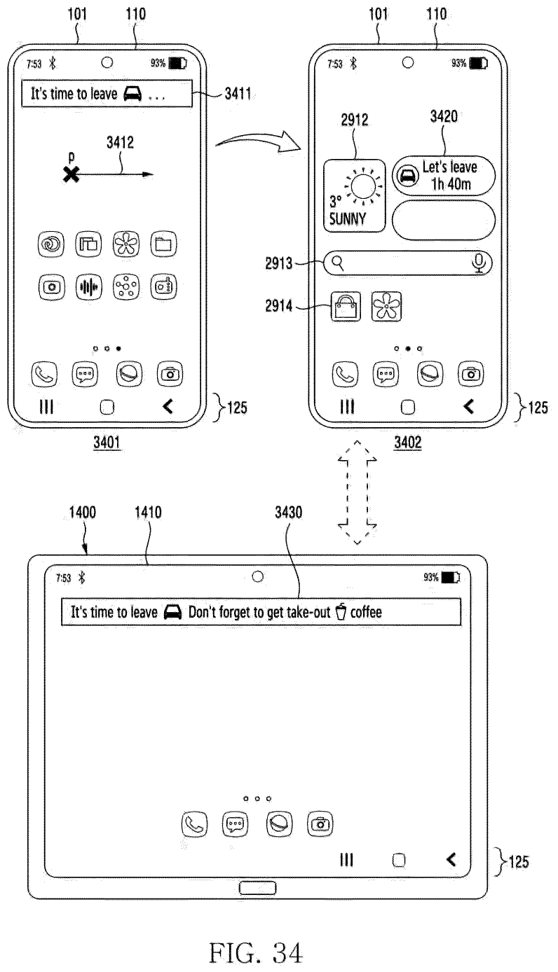

In a state where two displays (e.g., the flexible display 3108 and/or the cover display 3109) of the multi-foldable electronic device 3100 are visible as in the states 3193 and 3194 of FIG. 31B, the multi-foldable electronic device 3100 may activate all of the two displays. The widget object 2921 including a text representing summary of a content may be displayed on a specific display among the activated displays. For example, the multi-foldable electronic device 3100 displaying the widget object 2921 on the flexible display 3108 may display, based on identifying a content, a text describing the identified content on the cover display 3109, when changing the text of the widget object 2921 displayed through the flexible display 3108. In the example, the text displayed through the cover display 3109 may be displayed through a state bar and/or a pop-up window, similar to a visual object 3411 of FIG. 34.

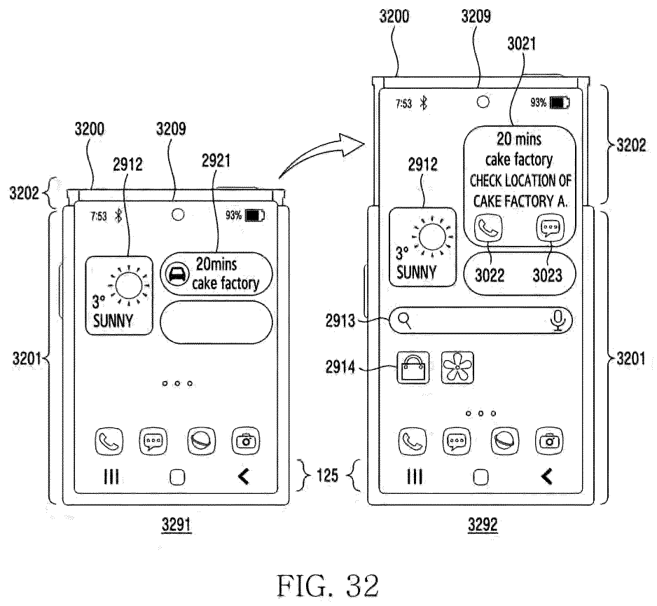

FIG. 32 is a diagram illustrating example states 3291 and 3292 of a rollable electronic device 3200 displaying a widget object 2921 according to various embodiments. The electronic device 101 of FIG. 2, the electronic device 101 of FIG. 17, the electronic device 101 of FIG. 27, and/or the processor 210 of FIG. 2 may perform an operation of the rollable electronic device 3200 described with reference to FIG. 32. The operation of the rollable electronic device 3200 described with reference to FIG. 32 may be associated with the operations of FIG. 28.

The rollable electronic device 3200 described with reference to FIG. 32 may include a first housing part 3201 and a second housing part 3202 capable of being inserted into the first housing part 3201 or extracted from the first housing part 3201. The rollable electronic device 3200 may include a flexible display 3209 extending from the first housing part 3201 to the second housing part 3202. When the second housing part 3202 is inserted into the first housing part 3201, at least a portion of the flexible display 3209 may be inserted into the first housing part 3201. When the second housing part 3202 is extracted from the first housing part 3201, at least a portion of the flexible display 3209 may be extracted from the first housing part 3201.

Referring to FIG. 32, a state 3291 included in a retracted state in which the second housing part 3202 is inserted into the first housing part 3201 is illustrated. The retracted state may be referred to as a rolled state and/or an inserted state. In the state 3291, the rollable electronic device 3200 may display a home screen including the widget object 2921 through a portion of the flexible display 3209 visible through the housing parts 3201 and 3202. The home screen may include another widget object 2912 different from the widget object 2921. Through the widget object 2921, the rollable electronic device 3200 may display a text representing summarization of at least one content.

In the example state 3291 of FIG. 32, the rollable electronic device 3200 may receive an input for changing a state of the rollable electronic device 3200 from a retracted state to an extended state. The input may include an input associated with a button of the rollable electronic device 3200, a user's utterance, and/or a visual object displayed through the flexible display 3209. Referring to FIG. 32, a state 3292, which is a state switched from the state 3291 based on the input, is illustrated. In the state 3292 included in the extended state, at least a portion of the second housing part 3202 that was inserted into the first housing part 3201 in the retracted state may be extracted outward the first housing part 3201. Since the second housing part 3202 is at least partially extracted from the first housing part 3201, a size of the visible flexible display 3209 may be larger than a size of the flexible display 3209 visible in the state 3291. The extended state of the rollable electronic device 3200 including the state 3292 may be referred to as an unrolled state and/or an extracted state.

Referring to FIG. 32, the rollable electronic device 3200 identifying switching from the state 3291 included in the inserted state to the state 3292 included in the extracted state may identify an increase in a size of a visible region (e.g., display region and/or active region) of the flexible display 3209 based on the switching. The rollable electronic device 3200 may display a home screen having an increased size, in the increased region. Referring to FIG. 32, in the state 3292 in which the home screen having the increased size is displayed, the rollable electronic device 3200 may display the widget object 3021 having a larger size than the widget object 2921. The widget object 3021 may be displayed according to a determination to increase the size of the widget object 2921. The rollable electronic device 3200 may determine whether to increase the size of the widget object 2921 using a rank of a content related to the widget object 2921 (e.g., related to the widget object 2921 to display a text included in the widget object 2921). The widget object 3021 may have a larger size than the widget object 2921 and, in the state 3292 included in the extracted state, may be located to occupy an empty region added to the flexible display 3209. Through the widget object 3021, the rollable electronic device 3200 may display icons 3022 and 3023 for executing a software application(s) associated with the content. Based on a user input with respect to the icon 3022, the rollable electronic device 3200 may execute a call application. Based on a user input with respect to the icon 3023, the rollable electronic device 3200 may execute a messenger application.

An example operation of the rollable electronic device 3200 increasing the size of the widget object 2921 using the size of the expanded flexible display 3209 when switching from the inserted state (e.g., the state 3291) to the extracted state (e.g., the state 3292) has been described, but the disclosure is not limited thereto. For example, when switching from the extracted state (e.g., the state 3292) to the inserted state (e.g., the state 3291), the rollable electronic device 3200 may reduce the size of the widget object 3021 occupying a portion of the flexible display 3209.

FIG. 33 is a diagram illustrating example widget objects 2720, 2740, 3311, 3331, and 3321 displayed at each of a home screen and a lock screen by an electronic device according to various embodiments. The electronic device 101 of FIG. 2, the electronic device 101 of FIG. 17, the electronic device 101 of FIG. 27, and/or the processor 210 of FIG. 2 may perform an operation of the electronic device 101 described with reference to FIG. 33. The operation of the electronic device 101 described with reference to FIG. 33 may be associated with the operations of FIG. 28.

Referring to FIG. 33, example widget objects 2720 and 2740 displayed based on at least one content are illustrated. The electronic device 101 may display one of the widget objects 2720 and 2740 at a home screen, according to a rank of the at least one content. For example, in an embodiment in which the widget object 2720 of a first size is displayed based on a first rank, the electronic device 101 may display the widget object 2740 of a second size larger than the first size, based on identifying a content of a second rank higher than the first rank. The widget objects 2720 and 2740 may include a text representing summarization of a corresponding content. The widget objects 2720 and 2740 may include a UI object (e.g., icon 2721 and/or UI object 2741) for executing a software application associated with the corresponding content.

The electronic device 101 displaying the widget object 2740 of a second size may retract a size of the widget object 2740, based on a user input associated with the widget object 2740 and/or a time interval set by a content associated with the widget object 2740. For example, based on receiving the user input and/or an expiration of the time interval, the electronic device 101 may change a size of the widget object 2740 from the second size to the first size. For example, the electronic device 101 may forgo displaying the widget object 2740 and may display the widget object 2720 of the first size.

Referring to FIG. 33, lock screens displayed by the electronic device 101 displaying each of the widget objects 2720 and 2740 are illustrated. For example, the electronic device 101 displaying the widget object 2740 of the second size may switch to a state 3301 displaying a lock screen including a widget object 3311, based on identifying that a state of the electronic device 101 is changed to a locked state. In the state 3301, the electronic device 101 may display the widget object 3311 including a text representing summarization of a content associated with the widget object 2740. The widget object 3311 may be referred to as a Now bar.

Referring to FIG. 33, in the state 3301 displaying the widget object 3311, the electronic device 101 may change the widget object 3311 using a time length during which the widget object 3311 is displayed and/or a rank of a content associated with the widget object 3311. For example, in the state 3301, when the widget object 3311 has been displayed for a time length exceeding a reference time length of the content and/or when the rank of the content has decreased (e.g., decreased below a threshold rank), the electronic device 101 may display a widget object 3321 having a retracted size, as in a state 3302. The widget object 3321 may include a text having a shorter length than a text included in the widget object 3311. The text included in the widget object 3321 may be a summarized version of texts included in the widget object 2740 and/or the widget object 3311, obtained based on execution of a language model.

Referring to FIG. 33, the electronic device 101 displaying the widget object 2720 may switch to a state 3303 displaying a lock screen including a widget object 3331, based on identifying that a state of the electronic device 101 is changed to a locked state. In the state 3303, the electronic device 101 may display, through the widget object 3331, a text (e.g., “Leave Now”) representing summarization of a content associated with the widget object 2720. A size of the widget object 3331 may be equal to a size of the widget object 3321 displayed through the display 110 in the state 3302.

As described above, a size of a widget object (e.g., widget objects 3311, 3321, and 3331) displayed at a lock screen may be associated with an importance level of a content associated with the widget object (e.g., in proportion). As summarization of a content having a high rank is displayed, the electronic device 101 may display a lock screen including a widget object having a large size. Since a rank is associated with a time length during which the widget object is displayed (e.g., in inverse proportion), the electronic device 101 may gradually reduce a size of a widget object in a lock screen, displayed to have a large size based on a high rank. For example, in the state 3301, when a time length during which the widget object 3311 is displayed is greater than a threshold time length, the electronic device 101 may display a widget object 3321, which is a retracted version with respect to the widget object 3311, by switching to the state 3302.

An operation of the electronic device 101 displaying a widget object (e.g., widget objects 3311, 3321, and 3331) at a lock screen may be similarly performed in relation to an AOD screen. For example, the electronic device 101 identifying a content having a high rank may display, not only a widget object including summarization of the content through a lock screen, but also a widget object including the summarization through the AOD screen. In the example, a rank may be decreased according to a time length during which the widget object is displayed. Based on the decreased rank, the electronic device 101 may forgo displaying the widget object on the AOD screen. After forgoing displaying the widget object on the AOD screen, the electronic device 101 may reduce a size of the widget object included in the lock screen and/or forgo displaying the widget object through the lock screen.

FIG. 34 is a diagram illustrating an example operation of an electronic device 101 and/or an external electronic device 1400 displaying a visual object related to a widget object 3420 according to various embodiments. The electronic device 101 of FIG. 2, the electronic device 101 of FIG. 17, the electronic device 101 of FIG. 27, and/or the processor 210 of FIG. 2 may perform an operation of the electronic device 101 described with reference to FIG. 34. The operation of the electronic device 101 described with reference to FIG. 34 may be associated with the operations of FIG. 28.

Referring to FIG. 34, exemplary states 3401 and 3402 of the electronic device 101 displaying a home screen including the widget object 3420 are illustrated. In the states 3401 and 3402, the electronic device 101 may obtain or generate text representing summarization of at least one content, based on identifying the at least one content. The electronic device 101 may display the widget object 3420 including the obtained text.

As described above, a home screen may include page views switchable by a user. When the home screen includes a plurality of page views, a widget object 3420 may be located at a specific page view. Referring to FIG. 34, an example state 3401 displaying a first page view of the home screen is illustrated. When the widget object 3420 is located at a second page view next to the first page view, the widget object 3420 may not be displayed through the display 110 in the state 3401. In the state 3401 displaying a first page view different from a second page view including the widget object 3420, the electronic device 101 obtaining a text to be included in the widget object 3420 may display a visual object 3411 associated with the text. For example, the visual object 3411 may be displayed in a portion (e.g., a portion adjacent to an upper edge of the display 110) of the display 110 referred to as a state bar. For example, the visual object 3411 may be included in the state bar, or may have a form of a pop-up window (or a toast notification) overlapped on the home screen. For example, the visual object 3411 may have a form such as a widget object (e.g., the widget objects 3311, 3321, and 3331 of FIG. 33) referred to as a Now bar.

In the state 3401 displaying a first page view different from a second page view including the widget object 3420, the electronic device 101 may (temporarily) display a visual object 3411 for a predetermined period (e.g., a period of about 1 second to about 10 seconds). Based on expiration of the predetermined period, the electronic device 101 may forgo displaying the visual object 3411. The electronic device 101 identifying a user input (e.g., a tap gesture on the visual object 3411) associated with the visual object 3411 may display, through the display 110, a screen (e.g., a briefing screen displayed in the state 1101 of FIG. 27) including a content associated with the widget object 3420.

Referring to FIG. 34, in the state 3401, the electronic device 101 may receive an input for switching a page view of a home screen displayed through the display 110. The input may include a drag gesture (or a swipe gesture) started at a point p on the home screen and performed along a horizontal direction 3412 of the display 110. The electronic device 101 identifying the input may display a second page view next to the first page view, as in the state 3402 of FIG. 34. In the state 3402 displaying the second page view, the electronic device 101 may display the widget object 3420 included in the second page view.

When a user is logged in to a plurality of electronic devices (e.g., the electronic device 101 and the electronic device 1400 having a form of a tablet PC), the electronic device 101 managing a widget object 3420 for displaying a text representing summarization of at least one content may transmit, to the electronic device 1400, a signal for displaying a notification with respect to the text. For example, when a content associated with the widget object 3420 is changed or a text included in the widget object 3420 is changed, the electronic device 101 may transmit, to the electronic device 1400, a text representing summarization of the content. The electronic device 1400 receiving the text may display a visual object 3430 including the text on the display 1410. Similar to the visual object 3411, the visual object 3430 may be included in a state bar or may have a form of a pop-up window overlapped on a screen displayed through the display 1410. Based on a user input associated with the visual object 3430, the electronic device 1400 may display a screen (e.g., a briefing screen) including a content associated with the text. Based on identifying a user input associated with the visual object 3430, the electronic device 1400 may transmit a signal notifying the user input to the electronic device 101. The electronic device 101 receiving the signal may change (e.g., decrease) a rank of a content corresponding to the widget object 3420.

As described above, according to an embodiment, the electronic device 101 may display a widget object including a text representing summarization of at least one content. The widget object may be disposed at a home screen, a lock screen, and/or an AOD screen of the electronic device 101. The electronic device 101 may maintain or change a text included in the widget object according to a rank of the at least one content. The rank of the at least one content may be changed according to a time length of displaying the widget object and/or a user input with respect to the widget object. The electronic device 101 may enlarge, maintain, or retract a size of the widget object, according to the rank of the at least one content.

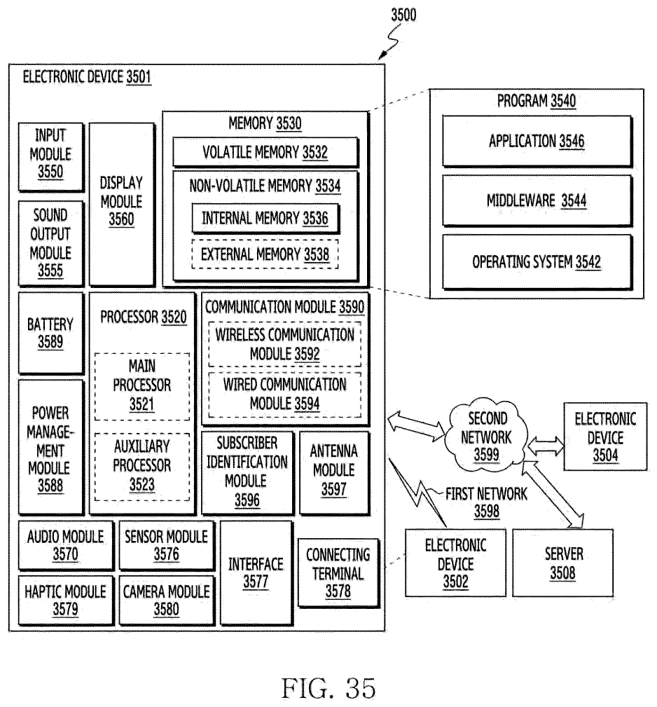

FIG. 35 is a block diagram illustrating an example electronic device 3501 in a network environment 3500 according to various embodiments. Referring to FIG. 35, the electronic device 3501 in the network environment 3500 may communicate with an electronic device 3502 via a first network 3598 (e.g., a short-range wireless communication network), or at least one of an electronic device 3504 or a server 3508 via a second network 3599 (e.g., a long-range wireless communication network). According to an embodiment, the electronic device 3501 may communicate with the electronic device 3504 via the server 3508. According to an embodiment, the electronic device 3501 may include a processor 3520, memory 3530, an input module 3550, a sound output module 3555, a display module 3560, an audio module 3570, a sensor module 3576, an interface 3577, a connecting terminal 3578, a haptic module 3579, a camera module 3580, a power management module 3588, a battery 3589, a communication module 3590, a subscriber identification module (SIM) 3596, or an antenna module 3597. In various embodiments, at least one of the components (e.g., the connecting terminal 3578) may be omitted from the electronic device 3501, or one or more other components may be added in the electronic device 3501. In various embodiments, some of the components (e.g., the sensor module 3576, the camera module 3580, or the antenna module 3597) may be implemented as a single component (e.g., the display module 3560).

The processor 3520 may execute, for example, software (e.g., a program 3540) to control at least one other component (e.g., a hardware or software component) of the electronic device 3501 coupled with the processor 3520, and may perform various data processing or computation. According to an embodiment, as at least part of the data processing or computation, the processor 3520 may store a command or data received from another component (e.g., the sensor module 3576 or the communication module 3590) in volatile memory 3532, process the command or the data stored in the volatile memory 3532, and store resulting data in non-volatile memory 3534. According to an embodiment, the processor 3520 may include a main processor 3521 (e.g., a central processing unit (CPU) or an application processor (AP)), or an auxiliary processor 3523 (e.g., a graphics processing unit (GPU), a neural processing unit (NPU), an image signal processor (ISP), a sensor hub processor, or a communication processor (CP)) that is operable independently from, or in conjunction with, the main processor 3521. For example, when the electronic device 3501 includes the main processor 3521 and the auxiliary processor 3523, the auxiliary processor 3523 may be adapted to consume less power than the main processor 3521, or to be specific to a specified function. The auxiliary processor 3523 may be implemented as separate from, or as part of the main processor 3521. Thus, the processor 3520 may processing circuitry, and/or may include multiple processors. For example, as used herein, including the claims, the term “processor” or “model” (e.g., a machine learning model) may include various processing circuitry, including at least one processor, wherein one or more of at least one processor, individually and/or collectively in a distributed manner, may be configured to perform various functions described herein. As used herein, when “a processor,” “at least one processor,” “a model,” “a machine learning model”, “at least one model,” and “one or more processors” are described as being configured to perform numerous functions, these terms cover various situations, for example and without limitation, in which one processor and/or model performs some of recited functions and another processor(s) and/or model(s) performs other of recited functions, and also situations in which a single processor and/or model may perform all recited functions. Additionally, the at least one processor may include a combination of processors performing various of the recited/disclosed functions, e.g., in a distributed manner. At least one processor may execute program instructions to achieve or perform various functions. Likewise, the at least one model may include a combination of circuitry and/or processors performing various of the recited/disclosed functions, e.g., in a distributed manner. At least one processor and/or model may execute program instructions to achieve or perform various functions.

The auxiliary processor 3523 may control at least some of functions or states related to at least one component (e.g., the display module 3560, the sensor module 3576, or the communication module 3590) among the components of the electronic device 3501, instead of the main processor 3521 while the main processor 3521 is in an inactive (e.g., sleep) state, or together with the main processor 3521 while the main processor 3521 is in an active state (e.g., executing an application). According to an embodiment, the auxiliary processor 3523 (e.g., an image signal processor or a communication processor) may be implemented as part of another component (e.g., the camera module 3580 or the communication module 3590) functionally related to the auxiliary processor 3523. According to an embodiment, the auxiliary processor 3523 (e.g., the neural processing unit) may include a hardware structure specified for artificial intelligence model processing. An artificial intelligence model may be generated by machine learning. Such learning may be performed, e.g., by the electronic device 3501 where the artificial intelligence is performed or via a separate server (e.g., the server 3508). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 3530 may store various data used by at least one component (e.g., the processor 3520 or the sensor module 3576) of the electronic device 3501. The various data may include, for example, software (e.g., the program 3540) and input data or output data for a command related thereto. The memory 3530 may include the volatile memory 3532 or the non-volatile memory 3534.

The program 3540 may be stored in the memory 3530 as software, and may include, for example, an operating system (OS) 3542, middleware 3544, or an application 3546.

The input module 3550 may receive a command or data to be used by another component (e.g., the processor 3520) of the electronic device 3501, from the outside (e.g., a user) of the electronic device 3501. The input module 3550 may include, for example, a microphone, a mouse, a keyboard, a key (e.g., a button), or a digital pen (e.g., a stylus pen).

The sound output module 3555 may output sound signals to the outside of the electronic device 3501. The sound output module 3555 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 3560 may visually provide information to the outside (e.g., a user) of the electronic device 3501. The display module 3560 may include, for example, a display, a hologram device, or a projector and control circuitry to control a corresponding one of the display, hologram device, and projector. According to an embodiment, the display module 3560 may include a touch sensor adapted to detect a touch, or a pressure sensor adapted to measure the intensity of force incurred by the touch.

The audio module 3570 may convert a sound into an electrical signal and vice versa. According to an embodiment, the audio module 3570 may obtain the sound via the input module 3550, or output the sound via the sound output module 3555 or a headphone of an external electronic device (e.g., an electronic device 3502) directly (e.g., wiredly) or wirelessly coupled with the electronic device 3501.

The sensor module 3576 may detect an operational state (e.g., power or temperature) of the electronic device 3501 or an environmental state (e.g., a state of a user) external to the electronic device 3501, and then generate an electrical signal or data value corresponding to the detected state. According to an embodiment, the sensor module 3576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 3577 may support one or more specified protocols to be used for the electronic device 3501 to be coupled with the external electronic device (e.g., the electronic device 3502) directly (e.g., wiredly) or wirelessly. According to an embodiment, the interface 3577 may include, for example, a high definition multimedia interface (HDMI), a universal serial bus (USB) interface, a secure digital (SD) card interface, or an audio interface.

A connecting terminal 3578 may include a connector via which the electronic device 3501 may be physically connected with the external electronic device (e.g., the electronic device 3502). According to an embodiment, the connecting terminal 3578 may include, for example, an HDMI connector, a USB connector, an SD card connector, or an audio connector (e.g., a headphone connector).

The haptic module 3579 may convert an electrical signal into a mechanical stimulus (e.g., a vibration or a movement) or electrical stimulus which may be recognized by a user via his tactile sensation or kinesthetic sensation. According to an embodiment, the haptic module 3579 may include, for example, a motor, a piezoelectric element, or an electric stimulator.

The camera module 3580 may capture a still image or moving images. According to an embodiment, the camera module 3580 may include one or more lenses, image sensors, image signal processors, or flashes.

The power management module 3588 may manage power supplied to the electronic device 3501. According to an embodiment, the power management module 3588 may be implemented as at least part of, for example, a power management integrated circuit (PMIC).

The battery 3589 may supply power to at least one component of the electronic device 3501. According to an embodiment, the battery 3589 may include, for example, a primary cell which is not rechargeable, a secondary cell which is rechargeable, or a fuel cell.

The communication module 3590 may support establishing a direct (e.g., wired) communication channel or a wireless communication channel between the electronic device 3501 and the external electronic device (e.g., the electronic device 3502, the electronic device 3504, or the server 3508) and performing communication via the established communication channel. The communication module 3590 may include one or more communication processors that are operable independently from the processor 3520 (e.g., the application processor (AP)) and supports a direct (e.g., wired) communication or a wireless communication. According to an embodiment, the communication module 3590 may include a wireless communication module 3592 (e.g., a cellular communication module, a short-range wireless communication module, or a global navigation satellite system (GNSS) communication module) or a wired communication module 3594 (e.g., a local area network (LAN) communication module or a power line communication (PLC) module). A corresponding one of these communication modules may communicate with the external electronic device via the first network 3598 (e.g., a short-range communication network, such as Bluetooth™, wireless-fidelity (Wi-Fi) direct, or infrared data association (IrDA)) or the second network 3599 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 3592 may identify and authenticate the electronic device 3501 in a communication network, such as the first network 3598 or the second network 3599, using subscriber information (e.g., international mobile subscriber identity (IMSI)) stored in the subscriber identification module 3596.

The wireless communication module 3592 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 3592 may support a high-frequency band (e.g., the mmWave band) to achieve, e.g., a high data transmission rate. The wireless communication module 3592 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 3592 may support various requirements specified in the electronic device 3501, an external electronic device (e.g., the electronic device 3504), or a network system (e.g., the second network 3599). According to an embodiment, the wireless communication module 3592 may support a peak data rate (e.g., 20 Gbps or more) for implementing eMBB, loss coverage (e.g., 3564 dB or less) for implementing mMTC, or U-plane latency (e.g., 0.5 ms or less for each of downlink (DL) and uplink (UL), or a round trip of 35 ms or less) for implementing URLLC.

The antenna module 3597 may transmit or receive a signal or power to or from the outside (e.g., the external electronic device) of the electronic device 3501. According to an embodiment, the antenna module 3597 may include an antenna including a radiating element including a conductive material or a conductive pattern formed in or on a substrate (e.g., a printed circuit board (PCB)). According to an embodiment, the antenna module 3597 may include a plurality of antennas (e.g., array antennas). In such a case, at least one antenna appropriate for a communication scheme used in the communication network, such as the first network 3598 or the second network 3599, may be selected, for example, by the communication module 3590 (e.g., the wireless communication module 3592) from the plurality of antennas. The signal or the power may then be transmitted or received between the communication module 3590 and the external electronic device via the selected at least one antenna. According to an embodiment, another component (e.g., a radio frequency integrated circuit (RFIC)) other than the radiating element may be additionally formed as part of the antenna module 3597.

According to various embodiments, the antenna module 3597 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 3501 and the external electronic device 3504 via the server 3508 coupled with the second network 3599. Each of the electronic devices 3502 or 3504 may be a device of a same type as, or a different type, from the electronic device 3501. According to an embodiment, all or some of operations to be executed at the electronic device 3501 may be executed at one or more of the external electronic devices 3502, 3504, or 3508. For example, if the electronic device 3501 should perform a function or a service automatically, or in response to a request from a user or another device, the electronic device 3501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 3501. The electronic device 3501 may provide the outcome, with or without further processing of the outcome, as at least part of a reply to the request. To that end, a cloud computing, distributed computing, mobile edge computing (QEC), or client-server computing technology may be used, for example. The electronic device 3501 may provide ultra low-latency services using, e.g., distributed computing or mobile edge computing. In an embodiment, the external electronic device 3504 may include an internet-of-things (IoT) device. The server 3508 may be an intelligent server using machine learning and/or a neural network. According to an embodiment, the external electronic device 3504 or the server 3508 may be included in the second network 3599. The electronic device 3501 may be applied to intelligent services (e.g., smart home, smart city, smart car, or healthcare) based on 5G communication technology or IoT-related technology.

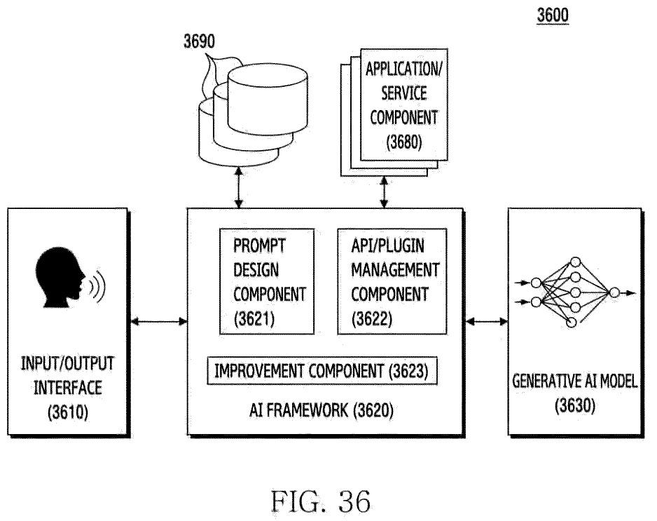

Some of the operations described above may be executed (or performed) through an artificial intelligence (AI) system described in greater detail below with reference to FIG. 36.

FIG. 36 is a diagram illustrating an example configuration of an AI system according to various embodiments. Referring to FIG. 36, an AI system 3600 may include an input/output interface (e.g., including circuitry) 3610, an AI framework 3620, a Generative AI model (e.g., including various circuitry and/or executable program instructions) 3630, and/or a knowledge storage (e.g., a memory) 3690.

The input/output interface 3610 may include various circuitry and receive an input. The input may include a user input and/or data obtained or generated by an electronic device (e.g., the above-described electronic device 101 and/or electronic device 3501). The data may include an image, a video, and/or sensor data (e.g., illuminance data around the electronic device obtained from a sensor or a sensor hub (e.g., the auxiliary processor 3523), posture data (or orientation data) of the electronic device, a temperature inside the electronic device (e.g., a temperature of the display 110 and/or the processor 210), size information of a display region of the display 110, and/or an image obtained through an image sensor (e.g., included in the camera module 3580) of the electronic device) generated by at least one processor (e.g., at least one processor 210 or a processor 3520) of the electronic device. The user input may include natural language, touch data obtained through touch circuitry included in the display 110 (e.g., used to identify an input from a finger and/or a stylus), an image displayed (and/or to be displayed) on the display 110, and/or a video. As a non-limiting example, the user input may be received by the input/output interface 3610 together with context information. The context information may be described as additional information obtained in relation to the user input. The context information may be associated with a state when the user input is received (e.g., including a state of the electronic device and/or a state around the electronic device (e.g., a user state)). For example, the context information may include information about one or more software applications executed in the electronic device when the user input is received. For example, the context information may include information on a location of the electronic device (or a location of a user of the electronic device) when the user input is received. For example, the user input may be integrated with the context information. For example, the input in which the context information is integrated may be received by the input/output interface 3610.

The input/output interface 3610 may transmit (or provide) output. The output may include a result (or result information) generated or obtained by the AI system 3600 based at least in part on the input. A format of the output may vary. For example, the output may include natural language. For example, the output may include a content (e.g., including media content and/or multimedia content). For example, the output may include an action associated with a user of the electronic device. For example, the output may have a format according to user settings of the electronic device.

The input/output interface 3610 may be described as a user query/response interface 3610.

The AI framework 3620 may obtain information (or data) on the input from the input/output interface 3610 and may be used to control one or more components associated with the AI system 3600 using the obtained information.

For example, a prompt design component (e.g., including various circuitry and/or executable program instructions) 3621 in the AI framework 3620 may generate or obtain a prompt for the generative AI model 3630 (e.g., including a large language model (LLM) or a large multimodal model (LMM)), using the obtained information. For example, the prompt design component 3621 may be described as an AI component using a learning algorithm and/or a neural network to provide an enhanced prompt over time. For example, the prompt design component 3621 may generate or obtain a prompt by accessing a knowledge component (e.g., the knowledge storage 3690) including user preference data, prompt library, and/or prompt example using the obtained information. The generated prompt may be provided to the generative AI model 3630 (e.g., including the LLM or the LMM).

For example, an API/plugin management component (e.g., including various circuitry and/or executable program instructions) 3622 in the AI framework 3620 may be used to support communication for additional information requested (or caused) in relation to the prompt provided (or to be provided) to the generative AI model 3630. For example, the API/plugin management component 3622 may be used to generate or establish a channel for communication with various data sources (e.g., the knowledge storage 3690). For example, the API/plugin management component 3622 may support access to at least a portion of the data sources. For example, the API/plugin management component 3622 may be used to request another component (e.g., an application/service component 3680) that performs feedback (or response) according to the prompt. As a non-limiting example, information obtained (or generated) through the API/plugin management component 3622 may be provided to the prompt design component 3621 for generation of a prompt. As a non-limiting example, information obtained (or generated) through the API/plugin management component 3622 may be provided to the generative AI model 3630.

For example, an improvement component 3623 in the AI framework 3620 may at least partially tune (or adjust) (or change) a result (e.g., content) obtained (or output) from the generative AI model 3630. For example, the improvement component 3623 may determine or verify whether a content obtained from the generative AI model 3630 is associated with the input. For example, the improvement component 3623 may determine or verify whether the content obtained from the generative AI model 3630 includes biased information. For example, the improvement component 3623 may determine or verify whether the content obtained from the generative AI model 3630 includes harmful content. For example, the improvement component 3623 may support or assist performing additional processing to improve the content obtained from the generative AI model 3630. For example, the improvement component 3623 may support providing a hint to a user to improve the content.

The generative AI model 3630 may be described as an artificial intelligence neural network that generates feedback, in response to a prompt. For example, the feedback may be associated with the prompt but may further include additional data and/or information relative to the prompt. For example, the feedback may include a new content relative to the prompt. For example, the generative AI model 3630 may include a model generating an image and/or a model generating a language. For example, the model generating an image may include a generative adversarial network (GAN) and/or a variational auto encoder (VAE). For example, the model generating an image may include a diffusion-based generative model (e.g., a transformer VAE). For example, the model generating a language may include CHAT-GPT 3 and/or CHAT-GPT 4. For example, the generative AI model 3630 may include an LMM that generates the feedback by recognizing characters, images, and/or voice.

As a non-limiting example, the AI framework 3620 and/or the generative AI model 3630 may be included in an AI module (e.g., including processing circuitry) in the electronic device. For example, the AI module may be operably coupled with at least one processor (e.g., the at least one processor 210 or the processor 3520) of the electronic device. For example, the AI module may be operably coupled with display driving circuitry of the electronic device. For example, the AI module may be operably coupled with a sensor hub of the electronic device for one or more sensors in the electronic device.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 3540) including one or more instructions that are stored in a storage medium (e.g., internal memory 3536 or external memory 3538) that is readable by a machine (e.g., the electronic device 3501). For example, a processor (e.g., the processor 3520) of the machine (e.g., the electronic device 3501) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

In an example embodiment, a method of displaying and/or arranging contents using ranks of the contents may be required. In an example embodiment, a method of displaying contents respectively provided from a plurality of software applications through one screen may be required. As described above, according to an example embodiment, an electronic device may comprise a touchscreen display, memory comprising one or more storage media storing instructions, and at least one processor comprising processing circuitry. The instructions, when executed by the at least one processor individually or collectively, may cause the electronic device to, based at least in part on a determination that time information of the electronic device corresponds to a predetermined time, identify first information of a first application and second information of a second application among a plurality of applications. The first information and the second information may be respectively obtained in a predetermined period corresponding to the time information. The instructions, when executed by the at least one processor individually or collectively, may cause the electronic device to generate, via a machine learning model, a first content including a first image and a first text using the first information, and a second content including a second image and a second text using the second information. The instructions, when executed by the at least one processor individually or collectively, may cause the electronic device to determine a rank of the first content and the second content based on the time information. The instructions, when executed by the at least one processor individually or collectively, may cause the electronic device to, based on the rank, display, via the touchscreen display, the first content and the second content concurrently. According to an embodiment, the electronic device may display or arrange contents using ranks of the content. According to an embodiment, the electronic device may display content provided from each of a plurality of software applications through one screen.

For example, the instructions, when executed by the at least one processor individually or collectively, may cause the electronic device to generate summarization texts using the first content. A first rank of the first content may be higher than a second rank of the second content. The instructions, when executed by the at least one processor individually or collectively, may cause the electronic device to display, via the touchscreen display, the summarization texts in a first portion and the second content aligned according to the rank in a second portion below the first portion.

For example, the instructions, when executed by the at least one processor individually or collectively, may the electronic device to identify location information of the electronic device. The instructions, when executed by the at least one processor individually or collectively, may cause the electronic device to, based at least in part on a determination that the time information corresponds to another predetermined time and the location information corresponds to a predetermined location, refrain from identifying the first information of the first application among the plurality of applications, and identify third information of a third application. The instructions, when executed by the at least one processor individually or collectively, may cause the electronic device to generate the first content using the third information. The instructions, when executed by the at least one processor individually or collectively, may cause the electronic device to determine, based on the time information and the location information, the rank of the first content and the second content.

For example, the instructions, when executed by the at least one processor individually or collectively, may cause the electronic device to generate, using the machine learning model, at least one message based on the first information, the second information and the time information. The instructions, when executed by the at least one processor individually or collectively, may cause the electronic device to display, via the touchscreen display, the at least one message at an upper portion of the first content and the second content.

For example, the instructions, when executed by the at least one processor individually or collectively, may cause the electronic device to, based at least in part on a determination that a state of the electronic device corresponds to a lock screen state, display, via the touchscreen display, a first graphical object including a portion of the at least one message or texts associated with a content having a higher rank among the first content and the second content, at a first location on the lock screen. The instructions, when executed by the at least one processor individually or collectively, may cause the electronic device to, based at least in part on a determination that the state of the electronic device corresponds to a home screen state, display, via the touchscreen display, a second graphical object including a portion of the at least one message or other texts associated with the content having the higher rank, at a second location on the home screen. A size of the second graphical object may be different from a size of the first graphical object.

For example, the instructions, when executed by the at least one processor individually or collectively, may cause the electronic device to receive, via the touchscreen display, a user input associated with the first graphical object or the second graphical object. The instructions, when executed by the at least one processor individually or collectively, may cause the electronic device to, in response to the user input, display, via the touchscreen display, the first content and the second content according to the rank.

For example, the instructions, when executed by the at least one processor individually or collectively, may cause the electronic device to receive another user input to enter the lock screen state. The instructions, when executed by the at least one processor individually or collectively, may cause the electronic device to, in response to the other user input, display, via the touchscreen display, the home screen including a third graphical object corresponding to a fourth application executed in a background of the electronic device.

For example, the instructions, when executed by the at least one processor individually or collectively, may cause the electronic device to receive, while displaying the first content and the second content, a feedback user input with respect to the first content. The instructions, when executed by the at least one processor individually or collectively, may cause the electronic device to perform the determining of the rank based on the feedback user input.

For example, the instructions, when executed by the at least one processor individually or collectively, may cause the electronic device to generate, using the machine learning model, personalized information based on an image and texts stored in the memory. The instructions, when executed by the at least one processor individually or collectively, may cause the electronic device to, based at least in part on the personalized information, determine context information using the first information and the second information. The instructions, when executed by the at least one processor individually or collectively, may cause the electronic device to perform the generating of the first content and the second content based on the context information. The instructions, when executed by the at least one processor individually or collectively, may cause the electronic device to, based on the context information and the time information, perform the determining of the rank of the first content and the second content.

For example, the instructions, when executed by the at least one processor individually or collectively, may cause the electronic device to receive, via the touchscreen display, a user input with respect to the first content. The instructions, when executed by the at least one processor individually or collectively, may cause the electronic device to, in response to the user input, display, via the touchscreen display, a user interface (UI) of the first application corresponding to the first content.

As described above, according to an example embodiment, an electronic device may comprise a display, memory comprising one or more storage media storing instructions, and at least one processor comprising processing circuitry. The instructions, when executed by the at least one processor individually or collectively, may cause the electronic device to identify messages generated by execution of software applications. The instructions, when executed by the at least one processor individually or collectively, may cause the electronic device to determine ranks respectively corresponding to the messages. The instructions, when executed by the at least one processor individually or collectively, may cause the electronic device to obtain texts representing summarization of at least one of the messages, using the determined ranks. The instructions, when executed by the at least one processor individually or collectively, may cause the electronic device to display, together with the obtained texts, visual objects respectively including the messages which are arranged by the determined ranks.

For example, the messages may be first messages. The instructions, when executed by the at least one processor individually or collectively, may cause the electronic device to generate a second message using information with respect to a user of the electronic device. The instructions, when executed by the at least one processor individually or collectively, may cause the electronic device to determine ranks respectively corresponding to the first messages and the second message.

For example, the instructions, when executed by the at least one processor individually or collectively, may cause the electronic device to receive a user input associated with one of the visual objects. The instructions, when executed by the at least one processor individually or collectively, may cause the electronic device to display, based on the user input, a screen provided by a software application corresponding to a visual object associated with the user input.

For example, the instructions, when executed by the at least one processor individually or collectively, may cause the electronic device to, based on obtaining the texts with a first length, display, in a lock screen, a widget object including texts with a second length shorter than the first length, the texts with the second length representing summarization of the texts with the first length. The instructions, when executed by the at least one processor individually or collectively, may cause the electronic device to display, based on a user input associated with the widget object, the visual objects respectively including the messages which are arranged by the determined ranks, together with the texts with the first length.

For example, the instructions, when executed by the at least one processor individually or collectively, may cause the electronic device to perform, based on the user input, authorization with respect to a user of the electronic device. The instructions, when executed by the at least one processor individually or collectively, may cause the electronic device to display, based on the authorization, a screen including the texts and the visual objects.

For example, the instructions, when executed by the at least one processor individually or collectively, may cause the electronic device to determine, using a time, a location, a state of charge (SOC) of a battery of the electronic device, or schedule information stored in the memory, the ranks.

For example, the instructions, when executed by the at least one processor individually or collectively, may cause the electronic device to generate, using the determined ranks, layout information with respect to an execution screen including the obtained texts and the visual objects. The instructions, when executed by the at least one processor individually or collectively, may cause the electronic device to display, based on a user input associated with an icon related to the execution screen, the execution screen through the display.

For example, the instructions, when executed by the at least one processor individually or collectively, may cause the electronic device to obtain a prompt including the messages arranged by the ranks. The instructions, when executed by the at least one processor individually or collectively, may cause the electronic device to obtain, by executing a trained model using the obtained prompt, the texts.

As described above, in an example embodiment, a method of an electronic device including a touchscreen display is provided. The method may comprise, based at least in part on a determination that time information of the electronic device corresponds to a predetermined time, identifying first information of a first application and second information of a second application among a plurality of applications. The first information and the second information may be respectively obtained in a predetermined period corresponding to the time information. The method may comprise generating, via a machine learning model, a first content including a first image and a first text using the first information, and a second content including a second image and a second text using the second information. The method may comprise determining a rank of the first content and the second content based on the time information. The method may comprise, based on the rank, displaying, via the touchscreen display, the first content and the second content concurrently.

For example, the determining may comprise determining, based on generating a plurality of contents including the first content and the second content, ranks of the plurality of contents. The determining may comprise generating summarization texts with respect to a portion of the plurality of contents. A rank of the portion of the plurality of contents may be higher than a rank of remaining contents. The displaying may comprise displaying, using the touchscreen display, the summarization texts and the plurality of contents aligned according to the rank below the summarization texts.

For example, the method may comprise generating, using the machine learning model, at least one message based on the time information, the first information, and the second information. The method may comprise displaying the at least one message at an upper portion of the first content and the second content.

For example, the method may comprise displaying, based on displaying a lock screen through the touchscreen display, a first graphical object including at least one message or texts associated with a content having a higher rank among the first content and the second content, at a first location on the lock screen.

The method may comprise displaying, based on displaying a home screen through the touchscreen display, a second graphical object including the at least one message and other texts associated with the content having the higher rank, at a second location on the home screen. A size of the second graphical object may be different from a size of the first graphical object.

For example, the method may comprise receiving a user input associated with the first graphical object or the second graphical object. The method may comprise displaying, based on the user input, the first content and the second content according to the rank.

As described above, in an example embodiment, a non-transitory computer-readable storage medium storing instructions is provided. The instructions, when executed by an electronic device including a display, may cause the electronic device to identify messages generated by execution of software applications. The instructions, when executed by the electronic device, may cause the electronic device to determine ranks respectively corresponding to the messages. The instructions, when executed by the electronic device, may cause the electronic device to obtain texts representing summarization of at least one of the messages, using the determined ranks. The instructions, when executed by the electronic device, may cause the electronic device to display, together with the obtained texts, visual objects respectively including the messages which are arranged by the determined ranks.

For example, the messages may be first messages. The instructions, when executed by the electronic device, may cause the electronic device to generate a second message using information with respect to a user of the electronic device. The instructions, when executed by the electronic device, may cause the electronic device to determine ranks respectively corresponding to the first messages and the second message.

For example, the instructions, when executed by the electronic device, may cause the electronic device to receive a user input associated with one of the visual objects. The instructions, when executed by the electronic device, may cause the electronic device to display, based on the user input, a screen provided by a software application corresponding to a visual object associated with the user input.

For example, the instructions, when executed by the electronic device, may cause the electronic device to, based on obtaining the texts with a first length, display, in a lock screen, a widget object including texts with a second length shorter than the first length, the texts with the second length representing summarization of the texts with the first length. The instructions, when executed by the electronic device, may cause the electronic device to display, based on a user input associated with the widget object, the visual objects respectively including the messages which are arranged by the determined ranks, together with the texts with the first length.

For example, the instructions, when executed by the electronic device, may cause the electronic device to perform, based on the user input, authorization with respect to a user of the electronic device. The instructions, when executed by the electronic device, may cause the electronic device to display, based on the authorization, a screen including the texts and the visual objects.

For example, the instructions, when executed by the electronic device, may cause the electronic device to determine, using a time, a location, a state of charge (SOC) of a battery of the electronic device, or schedule information stored in the memory, the ranks.

For example, the instructions, when executed by the electronic device, may cause the electronic device to generate, using the determined ranks, layout information with respect to an execution screen including the obtained texts and the visual objects. The instructions, when executed by the electronic device, may cause the electronic device to display, based on a user input associated with an icon related to the execution screen, the execution screen through the display.

For example, the instructions, when executed by the electronic device, may cause the electronic device to obtain a prompt including the messages arranged by the ranks. The instructions, when executed by the electronic device, may cause the electronic device to obtain, by executing a trained model using the obtained prompt, the texts.

In an example embodiment, a method of providing images together with texts representing summarization of the images may be required. In an example embodiment, a method of generating summarization of images captured by a user may be required. According to an example embodiment, an electronic device may comprise a display, memory comprising one or more storage media storing instructions, and at least one processor comprising processing circuitry. The instructions, when executed by the at least one processor individually or collectively, may cause the electronic device to identify at least one cluster of a plurality of images. The instructions, when executed by the at least one processor individually or collectively, may cause the electronic device to, based on identifying a cluster including a plurality of images, identify a first portion of images having a time difference greater than a reference time difference among the plurality of images included in the cluster. The instructions, when executed by the at least one processor individually or collectively, may cause the electronic device to identify a second portion of images included in the first portion using timings of images of the first portion. The instructions, when executed by the at least one processor individually or collectively, may cause the electronic device to obtain texts representing summarization of the images of the second portion. The instructions, when executed by the at least one processor individually or collectively, may cause the electronic device to display the obtained texts in relation to the cluster. According to an embodiment, the electronic device may provide images together with texts representing summarization of the images. According to an embodiment, the electronic device may generate summarization of images captured by a user.

For example, the instructions, when executed by the at least one processor individually or collectively, may cause the electronic device to display the text indicating a user action associated with the plurality of images included in the cluster, together with a portion of the plurality of images included in the cluster.

For example, the instructions, when executed by the at least one processor individually or collectively, may cause the electronic device to generate a briefing content including the obtained text and at least one of the plurality of images included in the cluster. The instructions, when executed by the at least one processor individually or collectively, may cause the electronic device to store the briefing content in the memory.

For example, the instructions, when executed by the at least one processor individually or collectively, may cause the electronic device to display a widget object based at least in part on the briefing content while displaying a home screen through the display. The instructions, when executed by the at least one processor individually or collectively, may cause the electronic device to display the text and a portion of the plurality of images included in the cluster, through the display, based on a user input associated with the widget object.

For example, the instructions, when executed by the at least one processor individually or collectively, may cause the electronic device to receive another user input associated with an image displayed through the display, while displaying the text and the portion of the plurality of images included in the cluster through the display. The instructions, when executed by the at least one processor individually or collectively, may cause the electronic device to display a screen for searching the plurality of images included in the cluster through the display, based on the other user input.

For example, the instructions, when executed by the at least one processor individually or collectively, may cause the electronic device to, based on identifying the cluster including the plurality of images, remove at least one image obtained according to a time difference less than a threshold time difference among the plurality of images included in the cluster, from the cluster. The instructions, when executed by the at least one processor individually or collectively, may cause the electronic device to assign, to images included in the cluster from which the at least one image has been removed, scores according to time differences between the images. The instructions, when executed by the at least one processor individually or collectively, may cause the electronic device to identify the second portion of the images using the assigned scores.

For example, the instructions, when executed by the at least one processor individually or collectively, may cause the electronic device to assign a first score to images having a first time difference and assign a second score less than the first score to images having a second time difference longer than the first time difference.

For example, the instructions, when executed by the at least one processor individually or collectively, may cause the electronic device to change each of the scores, using a size of a region associated with a person within a corresponding image.

For example, the instructions, when executed by the at least one processor individually or collectively, may cause the electronic device to change each of the scores, using at least one tag corresponding to a corresponding image.

For example, the instructions, when executed by the at least one processor individually or collectively, may cause the electronic device to identify the at least one cluster of the plurality of images using at least one of a time or a location of each of the plurality of images stored in the memory.

As described above, according to an example embodiment, an electronic device may comprise a touchscreen display, memory comprising one or more storage media storing instructions, and at least one processor comprising processing circuitry. The instructions, when executed by the at least one processor individually or collectively, may cause the electronic device to identify time information and location information of the electronic device. The instructions, when executed by the at least one processor individually or collectively, may cause the electronic device to, based on first metadata of the first content and second metadata of the second content, identify a first content and a second content among a plurality of contents obtained within a predetermined period, according to identifying the time information and the location information satisfying a predetermined condition. The instructions, when executed by the at least one processor individually or collectively, may cause the electronic device to generate text information through a machine learning model stored in the memory, based at least in part on the first content, the second content, the first metadata, and the second metadata. The machine learning model may be trained to generate the text information, based on at least one content including an image, a video, a text, a sound, or a drawing. The instructions, when executed by the at least one processor individually or collectively, may cause the electronic device to display, through the touchscreen display, at least a portion of the first content and the second content in a first portion and display texts corresponding to the generated text information in a second portion different from the first portion.

For example, the instructions, when executed by the at least one processor individually or collectively, may cause the electronic device to perform identifying the first content and the second content, based at least in part on determining that the electronic device is located at a predetermined place during a predetermined time interval using the time information and the location information.

For example, the first metadata may include first time information and first location information. The second metadata may include second time information and second location information. The instructions, when executed by the at least one processor individually or collectively, may cause the electronic device to, using the first location information and the second location information, determine whether the first content and the second content are obtained at the same location. The first content and the second content may include one of an image or a video.

For example, the instructions, when executed by the at least one processor individually or collectively, may cause the electronic device to obtain a map image from a map application, using the first location information or the second location information. The instructions, when executed by the at least one processor individually or collectively, may cause the electronic device to display at least a portion of the map image together with the first content and the second content through the touchscreen display.

For example, the instructions, when executed by the at least one processor individually or collectively, may cause the electronic device to determine first weights for a first group of contents consecutively obtained within another predetermined period among the plurality of contents, based on metadata of the plurality of contents. The instructions, when executed by the at least one processor individually or collectively, may cause the electronic device to determine second weights for a second group of contents in which a face or food is represented, based on the metadata of the plurality of contents. The instructions, when executed by the at least one processor individually or collectively, may cause the electronic device to perform identifying the first content and the second content, based on the first weights and the second weights.

For example, the instructions, when executed by the at least one processor individually or collectively, may cause the electronic device to, before generating the at least one text information, identify whether the first content and the second content include information of a predetermined type, using the machine learning model. The instructions, when executed by the at least one processor individually or collectively, may cause the electronic device to generate, through the machine learning model, the text information without using the first content and the first metadata, based at least in part on determining that the first content includes the information of the predetermined type.

For example, the instructions, when executed by the at least one processor individually or collectively, may cause the electronic device to obtain other text information based on the first metadata and the second metadata, using the machine learning model. The instructions, when executed by the at least one processor individually or collectively, may cause the electronic device to display, through the touchscreen display, the other text information in a third portion below the first portion and the second portion.

For example, the instructions, when executed by the at least one processor individually or collectively, may cause the electronic device to receive a user input with respect to the at least a portion or the text. The instructions, when executed by the at least one processor individually or collectively, may cause the electronic device to generate other text information different from the text information, using the machine learning model, in response to the user input. The instructions, when executed by the at least one processor individually or collectively, may cause the electronic device to, through the touchscreen display, display the at least a portion in the first portion and concurrently display other texts corresponding to the other text information in the second portion.

For example, the instructions, when executed by the at least one processor individually or collectively, may cause the electronic device to display a graphical object through the touchscreen display. The instructions, when executed by the at least one processor individually or collectively, may cause the electronic device to receive another user input with respect to the graphical object, through the touchscreen display. The instructions, when executed by the at least one processor individually or collectively, may cause the electronic device to display a calendar object including at least a portion of the first content at a location corresponding to a date included in the first metadata, in response to the other user input.

As described above, in an example embodiment, a method of an electronic device comprising a display may be provided. The method may comprise identifying at least one cluster of a plurality of images. The method may comprise, based on identifying a cluster including a plurality of images, identifying a first portion of images having a time difference greater than a reference time difference among the plurality of images included in the cluster, using time differences among the plurality of images included in the cluster. The method may comprise, using timings of images of the first portion, identifying a second portion of images included in the first portion. The method may comprise obtaining texts representing summarization of the images of the second portion. The method may comprise displaying the obtained texts in relation to the cluster.

For example, the displaying may comprise displaying the text indicating a user action associated with the plurality of images included in the cluster, together with a portion of the plurality of images included in the cluster.

For example, the method may comprise generating a briefing content including the obtained text and at least one of the plurality of images included in the cluster. The method may comprise storing the briefing content in memory of the electronic device.

For example, the method may comprise displaying a widget object based at least in part on the briefing content, while displaying a home screen through the display. The method may comprise displaying, through the display, the text and a portion of the plurality of images included in the cluster, based on a user input associated with the widget object.

For example, the displaying may comprise receiving another user input associated with an image displayed through the display, while displaying the text and the portion of the plurality of images included in the cluster through the display. The displaying may comprise displaying a screen for searching the plurality of images included in the cluster through the display, based on the other user input.

For example, the identifying the portion of the plurality of images may comprise removing at least one image obtained according to a time difference less than a threshold time difference among the plurality of images included in the cluster, from the cluster, based on identifying the cluster including the plurality of images. The identifying the portion of the plurality of images may comprise assigning, to the images included in the cluster from which the at least one image has been removed, scores according to time differences between the images. The identifying the portion of the plurality of images may comprise identifying the second portion of the images using the assigned scores.

For example, the assigning may comprise assigning a first score to images having a first time difference and assigning a second score less than the first score to images having a second time difference longer than the first time difference.

For example, the method may further comprise changing each of the scores, using a size of a region associated with a person within a corresponding image.

For example, the method may further comprise changing each of the scores, using at least one tag corresponding to a corresponding image.

For example, the identifying the at least one cluster may comprise identifying the at least one cluster of the plurality of images using at least one of a time or a location of each of the plurality of images stored in the memory.

As described above, in an example embodiment, a non-transitory computer-readable storage medium storing instructions may be provided. The instructions, when executed by an electronic device including a touchscreen display, may cause the electronic device to identify time information and location information of the electronic device. The instructions, when executed by the electronic device, may cause the electronic device to, based at least in part on determining that the time information and the location information correspond to a predetermined condition, identify a first content and a second content among a plurality of contents obtained within a predetermined period, based on first metadata of the first content and second metadata of the second content. The instructions, when executed by the electronic device, may cause the electronic device to generate text information through a machine learning model, based at least in part on the first content, the second content, the first metadata, and the second metadata. The machine learning model may be trained to generate the text information based on at least one content including an image, a video, a text, a sound, or a drawing. The instructions, when executed by the electronic device, may cause the electronic device to, through the touchscreen display, display at least a portion of the first content and the second content in a first portion and to display texts corresponding to the text information in a second portion different from the first portion.

In an example embodiment, a method of changing, according to a content stored in an electronic device, summarization of the content displayed through a widget object may be required. According to an example embodiment, an electronic device may comprise a display, memory comprising one or more storage media storing instructions, and at least one processor comprising processing circuitry. The instructions, when executed by the at least one processor individually or collectively, may cause the electronic device to identify a first text representing summarization of at least one content. The instructions, when executed by the at least one processor individually or collectively, may cause the electronic device to generate a second text having a length smaller than a reference length of a widget object, based on the first text. The instructions, when executed by the at least one processor individually or collectively, may cause the electronic device to display, through the display, a widget object including the second text on a home screen. The instructions, when executed by the at least one processor individually or collectively, may cause the electronic device to determine a reference time length for maintaining the displaying of the widget object including the second text, based on a rank of the at least one content and a number of accesses with respect to the at least one content, while displaying the widget object including the second text. The instructions, when executed by the at least one processor individually or collectively, may cause the electronic device to identify a time length of displaying the widget object including the second text. The instructions, when executed by the at least one processor individually or collectively, may cause the electronic device to change a text within the widget object from the second text to a third text, based at least in part on determining that the time length is longer than the reference time length. According to an embodiment, the electronic device may change, according to a content stored in the electronic device, summarization of the content displayed through the widget object.

For example, the instructions, when executed by the at least one processor individually or collectively, may cause the electronic device to receive a first user input with respect to the widget object, while displaying the widget object including the second text. The instructions, when executed by the at least one processor individually or collectively, may cause the electronic device to display, through the display, a screen including the first text and the at least one content in response to the first user input.

For example, the instructions, when executed by the at least one processor individually or collectively, may cause the electronic device to receive a second user input with respect to the screen for displaying the home screen through the display. The instructions, when executed by the at least one processor individually or collectively, may cause the electronic device to display the widget object including the third text, in response to the second user input.

For example, the instructions, when executed by the at least one processor individually or collectively, may cause the electronic device to display, through the display, a graphical object for executing a software application associated with the at least one content within the widget object. The instructions, when executed by the at least one processor individually or collectively, may cause the electronic device to receive a third user input with respect to the graphical object through the display. The instructions, when executed by the at least one processor individually or collectively, may cause the electronic device to display a user interface (UI) corresponding to the software application through the display.

For example, the at least one content may be at least one first content. The instructions, when executed by the at least one processor individually or collectively, may cause the electronic device to generate other summarization of at least one other content, while displaying the widget object including the second text. The instructions, when executed by the at least one processor individually or collectively, may cause the electronic device to change the second text displayed in the widget object into a fourth text generated based on the third text representing the other summarization of the at least one other content, based at least in part on determining that a rank of the at least one other content is higher than a rank of the at least one content.

For example, the instructions, when executed by the at least one processor individually or collectively, may cause the electronic device to maintain displaying the second text in the widget object, based at least in part on determining that the rank of the at least one other content is lower than the rank of the at least one content.

For example, the instructions, when executed by the at least one processor individually or collectively, may cause the electronic device to perform displaying the widget object with a size corresponding to the rank of the at least one content.

For example, the instructions, when executed by the at least one processor individually or collectively, may cause the electronic device to display the third text indicating at least one of a time or a date within the widget object, based at least in part on identifying the time length longer than the reference time length.

As described above, in an example embodiment, a method of an electronic device comprising a display may be provided. The method may comprise identifying a first text representing summarization of at least one content. The method may comprise generating a second text having a length smaller than a reference length of a widget object, based on the first text. The method may comprise displaying, through the display, a widget object including the second text on a home screen. The method may comprise determining a reference time length for maintaining displaying of the widget object including the second text, based on a rank of the at least one content and a number of accesses with respect to the at least one content, while displaying the widget object including the second text. The method may comprise identifying a time length of displaying the widget object including the second text. The method may comprise changing a text in the widget object from the second text to a third text, based at least in part on determining that the time length is longer than the reference time length.

For example, the displaying may comprise receiving a first user input with respect to the widget object, while displaying the widget object including the second text. The displaying may comprise displaying, through the display, a screen including the first text and the at least one content, in response to the first user input.

For example, the method may comprise receiving a second user input with respect to the screen for displaying the home screen, through the display. The method may comprise displaying the widget object including the third text, in response to the second user input.

For example, the displaying may include displaying, through the display, a graphical object for executing a software application associated with the at least one content in the widget object. The displaying may comprise receiving, through the display, a third user input with respect to the graphical object. The displaying may comprise displaying, through the display, a user interface (UI) corresponding to the software application.

For example, the at least one content may be at least one first content. The displaying may comprise generating other summarization of at least one other content, while displaying the widget object including the second text. The displaying may comprise changing the second text displayed in the widget object to a fourth text generated based on the third text representing the other summarization of the at least one other content, based at least in part on determining that a rank of the at least one other content is higher than a rank of the at least one content.

For example, the displaying may comprise maintaining the displaying of the second text in the widget object, based at least in part on determining that the rank of the at least one other content is lower than the rank of the at least one content.

For example, the method may comprise performing the displaying of the widget object with a size corresponding to the rank of the at least one content.

For example, the changing may comprise the displaying of a third text indicating at least one of a time or a date in the widget object, based on identifying that the time length is longer than the reference time length.

As described above, according to an example embodiment, an electronic device may comprise a display, memory comprising one or more storage media storing instructions, and at least one processor comprising processing circuitry. The instructions, when executed by the at least one processor individually or collectively, may cause the electronic device to identify a first text representing summarization of at least one first content. The instructions, when executed by the at least one processor individually or collectively, may cause the electronic device to obtain a second text having a length smaller than a reference length of a widget object from the first text. The instructions, when executed by the at least one processor individually or collectively, may cause the electronic device to display the obtained second text in the widget object, based on displaying a home screen including the widget object. The instructions, when executed by the at least one processor individually or collectively, may cause the electronic device to, based on identifying a second content while displaying the obtained second text, identify a rank of the second content. The instructions, when executed by the at least one processor individually or collectively, may cause the electronic device to change a text in the widget object from the second text to a third text representing summarization of the second content, based on identifying that the rank of the second content is higher than a rank of the at least one first content.

For example, the instructions, when executed by the at least one processor individually or collectively, may cause the electronic device to maintain the displaying of the second text in the widget object, based on identifying the rank of the second content lower than the rank of the at least one first content.

For example, the instructions, when executed by the at least one processor individually or collectively, may cause the electronic device to, while displaying the widget object including the second text, receive a user input associated with the widget object. The instructions, when executed by the at least one processor individually or collectively, may cause the electronic device to display, through the display, a screen including the first text and the at least one first content, based on the user input.

For example, the instructions, when executed by the at least one processor individually or collectively, may cause the electronic device to receive a user input associated with the widget object while displaying the widget object including the third text. The instructions, when executed by the at least one processor individually or collectively, may cause the electronic device to display, through the display, a screen in which the second content is located above the at least one first content, based on the user input.

For example, the instructions, when executed by an electronic device including a display, may cause the electronic device to identify a first text representing summarization of at least one first content. The instructions, when executed by the at least one processor individually or collectively, may cause the electronic device to obtain a second text having a length smaller than a reference length of a widget object from the first text. The instructions, when executed by the at least one processor individually or collectively, may cause the electronic device to display the obtained second text in the widget object, based on displaying a home screen including the widget object. The instructions, when executed by the at least one processor individually or collectively, may cause the electronic device to, based on identifying a second content while displaying the obtained second text, identify a rank of the second content. The instructions, when executed by the at least one processor individually or collectively, may cause the electronic device to change a text in the widget object from the second text to a third text representing summarization of the second content, based on identifying the rank of the second content higher than a rank of the at least one first content.

For example, the instructions, when executed by the electronic device, may cause the electronic device to maintain the displaying of the second text in the widget object, based on identifying the rank of the second content lower than the rank of the at least one first content.

For example, the instructions, when executed by the electronic device, may cause the electronic device to, while displaying the widget object including the second text, receive a user input associated with the widget object. The instructions, when executed by the at least one processor individually or collectively, may cause the electronic device to display, through the display, a screen including the first text and the at least one first content, based on the user input.

For example, the instructions, when executed by the electronic device, may cause the electronic device to, while displaying the widget object including the third text, receive a user input associated with the widget object. The instructions, when executed by the at least one processor individually or collectively, may cause the electronic device to display, through the display, a screen in which the second content is located above the at least one first content, based on the user input.

As used herein, the term “if” is, optionally, construed to refer to “when” or “upon” or “in response to determining” or “in response to detecting,” depending on the context. Similarly, the phrase “if it is determined” or “if [a stated condition or event] is detected” is, optionally, construed to refer to “upon determining” or “in response to determining” or “upon detecting [the stated condition or event]” or “in response to detecting [the stated condition or event],” depending on the context.

The device described above may be implemented as a hardware component, a software component, and/or a combination of a hardware component and a software component. For example, the devices and components described in the various embodiments may be implemented using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to an example embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although various example embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the appended claims are in the scope of the disclosure. It will also be understood that any of the embodiment(s) described herein may be used in conjunction with any other embodiment(s) described herein.

What is claimed is:

1. An electronic device comprising:
a touchscreen display;
memory comprising one or more storage media storing instructions; and
at least one processor comprising processing circuitry,
wherein at least one processor, individually or collectively, is configured to execute the instructions and to cause the electronic device to:
based at least in part on a determination that time information of the electronic device corresponds to a specified time, identify first information of a first application and second information of a second application among a plurality of applications, the first information and the second information respectively obtained in a specified period corresponding to the time information;
generate, via a machine learning model, a first content including a first image and a first text using the first information, and a second content including a second image and a second text using the second information;
determine a rank of the first content and the second content based on the time information; and
based on the rank, display, via the touchscreen display, the first content and the second content concurrently.

2. The electronic device of claim 1, wherein at least one processor, individually or collectively, is configured to cause the electronic device to:
generate summarization texts using the first content, wherein a first rank of the first content is higher than a second rank of the second content; and
display, via the touchscreen display, the summarization texts in a first portion and the second content aligned according to the rank in a second portion below the first portion.

3. The electronic device of claim 1, wherein at least one processor, individually or collectively, is configured to cause the electronic device to:
identify location information of the electronic device;
based at least in part on a determination that the time information corresponds to another specified time and the location information corresponds to a specified location, refrain from identifying the first information of the first application among the plurality of applications, and identify third information of a third application;
generate the first content using the third information; and
determine, based on the time information and the location information, the rank of the first content and the second content.

4. The electronic device of claim 1, wherein at least one processor, individually or collectively, is configured to cause the electronic device to:
generate, using the machine learning model, at least one message based on the first information, the second information and the time information; and
display, via the touchscreen display, the at least one message at an upper portion of the first content and the second content.

5. The electronic device of claim 4, wherein at least one processor, individually or collectively, is configured to cause the electronic device to:
based at least in part on a determination that a state of the electronic device corresponds to a lock screen state, display, via the touchscreen display, a first graphical object including a portion of the at least one message or texts associated with a content having a higher rank among the first content and the second content, at a first location on the lock screen; and
based at least in part on a determination that the state of the electronic device corresponds to a home screen state, display, via the touchscreen display, a second graphical object including a portion of the at least one message or other texts associated with the content having the higher rank, at a second location on the home screen, and
wherein a size of the second graphical object is different from a size of the first graphical object.

6. The electronic device of claim 5, wherein at least one processor, individually or collectively, is configured to cause the electronic device to:
receive, via the touchscreen display, an input associated with the first graphical object or the second graphical object; and
in response to the input, display, via the touchscreen display, the first content and the second content according to the rank.

7. The electronic device of claim 6, wherein at least one processor, individually or collectively, is configured to cause the electronic device to:
receive another input to enter the lock screen state; and
in response to the other input, display, via the touchscreen display, the home screen including a third graphical object corresponding to a fourth application executed in a background of the electronic device.

8. The electronic device of claim 1, wherein at least one processor, individually or collectively, is configured to cause the electronic device to:
receive, while displaying the first content and the second content, a feedback input with respect to the first content; and
perform the determining of the rank based on the feedback input.

9. The electronic device of claim 1, wherein at least one processor, individually or collectively, is configured to cause the electronic device to:
generate, using the machine learning model, personalized information based on an image and texts stored in the memory;
based at least in part on the personalized information, determine context information using the first information and the second information;
perform the generating of the first content and the second content based on the context information; and
based on the context information and the time information, perform the determining of the rank of the first content and the second content.

10. The electronic device of claim 1, wherein at least one processor, individually or collectively, is configured to cause the electronic device to:
receive, via the touchscreen display, an input with respect to the first content; and
in response to the input, display, via the touchscreen display, a user interface (UI) of the first application corresponding to the first content.

11. An electronic device comprising:
a display;
memory comprising one or more storage media storing instructions; and
at least one processor comprising processing circuitry,
wherein at least one processor, individually or collectively, is configured to execute the instructions and to cause the electronic device to:
identify at least one message generated by execution of at least one software application;
determine ranks respectively corresponding to the at least one message;
obtain texts representing summarization of at least one message, using the determined ranks; and
display, together with the obtained texts, visual objects respectively including the at least one message arranged by the determined ranks.

12. The electronic device of claim 11, wherein at least one message includes first messages,
wherein at least one processor, individually or collectively, is configured to cause the electronic device to:
generate a second message using information with respect to a user of the electronic device; and
determine ranks respectively corresponding to the first messages and the second message.

13. The electronic device of claim 11, wherein at least one processor, individually or collectively, is configured to cause the electronic device to:
receive an input associated with one of the visual objects; and
display, based on the input, a screen provided by a software application corresponding to a visual object associated with the input.

14. The electronic device of claim 11, wherein at least one processor, individually or collectively, is configured to cause the electronic device to:
based on obtaining the texts with a first length, display, in a lock screen, a widget object including texts with a second length shorter than the first length, wherein the texts with the second length represent summarization of the texts with the first length; and
display, based on an input associated with the widget object, the visual objects respectively including the messages which are arranged by the determined ranks, together with the texts with the first length.

15. The electronic device of claim 14, wherein at least one processor, individually or collectively, is configured to cause the electronic device to:
perform, based on the input, authorization with respect to a user of the electronic device; and
display, based on the authorization, a screen including the texts and the visual objects.

16. The electronic device of claim 11, wherein at least one processor, individually or collectively, is configured to cause the electronic device to:
determine, using a time, a location, a state of charge (SOC) of a battery of the electronic device, or schedule information stored in the memory, the ranks.

17. The electronic device of claim 11, wherein at least one processor, individually or collectively, is configured to cause the electronic device to:
generate, using the determined ranks, layout information with respect to an execution screen including the obtained texts and the visual objects; and
display, based on an input associated with an icon related to the execution screen, the execution screen through the display.

18. The electronic device of claim 11, wherein at least one processor, individually or collectively, is configured to cause the electronic device to:
obtain a prompt including the messages arranged by the ranks; and
obtain, by executing a trained model using the obtained prompt, the texts.

19. A method of operating an electronic device including a touchscreen display, comprising:
based at least in part on a determination that time information of the electronic device corresponds to a specified time, identifying first information of a first application and second information of a second application among a plurality of applications, the first information and the second information respectively obtained in a specified period corresponding to the time information;
generating, via a machine learning model, a first content including a first image and a first text using the first information, and a second content including a second image and a second text using the second information;
determining a rank of the first content and the second content based on the time information; and
based on the rank, displaying, via the touchscreen display, the first content and the second content concurrently.

20. The method of claim 19, wherein the determining comprises,
determining, based on generating a plurality of contents including the first content and the second content, ranks of the plurality of contents;
generating summarization texts with respect to a portion of the plurality of contents, wherein a rank of the portion of the plurality of contents is higher than a rank of remaining contents; and
wherein the displaying comprises,
displaying, using the touchscreen display, the summarization texts and the plurality of contents aligned according to the rank below the summarization texts.
